(19) United States
(12) Patent Application Publication
(10) Pub. No.: US 2005/0067529 A1
(43) Pub. Date: Mar. 31, 2005

(54) Program to be executed on a computer to determine arrangement of a plurality of objects and program to be executed on a computer to determine cargo arrangement for transporting cargo to cosmic space

(75) Inventors: Keiki Takadama, Soraku-gun (JP); Katsunori Shimohara, Soraku-gun (JP)

Correspondence Address: McDermott, Will & Emery, 600 13th Street, N.W., Washington, DC, 20005-3096, US

(73) Assignee: Advanced Telecommunications Research Institute International

(21) Appl. No.: 10/859,295

(22) Filed: Jun. 3, 2004

(30) Foreign Application Priority Data
Sep. 14, 2001 (JP) 2001-279320
Nov. 6, 2001 (JP) 2001-340270
Oct. 21, 2003 (JP) 2003-360552

(51) Int. Cl. B64C 1/20

(52) U.S. Cl. 244/118.1

(57) ABSTRACT

A program includes step S1 of inputting types of cargo transfer bags as objects of determining arrangement, step S2 of determining arrangement of triple-size cargo transfer bags, step S3 of determining arrangement of double-size cargo transfer bags, step S4 of determining arrangement of single-size cargo transfer bags, and step S5 of determining arrangement of half-size cargo transfer bags. Arrangement of triple-size cargo transfer bags is determined through the same mechanism as that for the double-size cargo transfer bags, and arrangement of single-size cargo transfer bags is determined through the same mechanism as that for the half-size cargo transfer bags.

### BACKGROUND OF THE INVENTION

1. Field of the Invention

The present invention relates to a program to cause a computer to execute determination of suitable arrangement of a plurality of objects when the plurality of objects are to be arranged to satisfy requirements imposed by a user, and to a program to cause a computer to execute determination of cargo arrangement when the cargo is to be transported to the cosmic space.

2. Description of the Background Art

Recently, along with vigorous exploitation of the cosmic space, various and many commodities to be used in the cosmic space have come to be loaded in a transport to be delivered to a spacecraft. Here, the commodities are loaded to a cargo compartment of the transport such that the center of gravity of the transport is as close as possible to the optimal center of gravity. An astronaut brings in the commodities from the transport to the spacecraft, uses these in the spacecraft, and thereafter, reloads used commodities to the transport. The transport with the used commodities is separated from the spacecraft and burned up in the cosmic space or reenter the atmosphere and lands on a prescribed landing site.

FIG. 54 is a perspective view of the transport delivering the commodities to the spacecraft. The transport 100 has a columnar shape and includes a transporting portion 110 and a thrusting portion 120. Transporting portion 110 has a cargo bay 111, a docking portion 112 and a hatch 113. A plurality of commodities are loaded to cargo bay 111.

Transport 100 launched from the earth is driven by thrusting portion 120 to reach the spacecraft. Transport 100 docks to the spacecraft at docking portion 120, an astronaut enters through hatch 113 to cargo bay 111 of transport 100, and brings in the commodities loaded therein to the spacecraft.

Further, the astronaut loads used commodities to cargo bay 111 through hatch 113, and transport 100 is separated from the spacecraft. Transport 100 separated from the spacecraft may be burned up in the cosmic space or reenter the atmosphere and land on a prescribed landing site.

Here, in order to have transport 100 loaded with the used commodities burn up in the cosmic space or reach the prescribed landing site on the earth, it is necessary to load the commodities to transport 100 such that the center of gravity of the loaded transport is as close as possible to the center of gravity of transport 100 by itself, with deviation therebetween being a few centimeters at the largest. When the center of gravity of the loaded transport 100 deviates much from the center of gravity of transport 100 by itself, control of transport 100 separated from the spacecraft becomes difficult, so that transport 100 might go off from the regular orbit and hits a position outside the target zone.

When transport 100 having used commodities loaded therein is to be fully burned up in the cosmic space, it is also necessary to have the commodities loaded such that the deviation in the center of gravity with the load is at most a few centimeters.

As described above, when commodities are to be loaded to transport 100, it is necessary that the center of gravity of transport 100 after loading the commodities is not much deviated from the center of gravity of transport 100 by itself.

When commodities having different sizes and weights are to be loaded to the transport with the center of gravity being not much deviated, the following problems arise.

First, manual loading of the commodities to the transport by an operator on the ground is error-prone and costly.

Further, the commodities are carried into and out from the spacecraft by an astronaut, and therefore, when arrangement is frequently changed because of change in the commodities, operations of carrying in and out the commodities would pose excessive burden on the astronaut.

In a cosmic space system including a spacecraft and a transport, it is necessary to quickly find a solution that satisfies conditions set by the user. Particularly, when some of the commodities to be loaded to the transport are changed, it is necessary to immediately reflect the change and determine the arrangement of the commodities such that the center of gravity of the transport is not much deviated. It is difficult by human determination of the arrangement to cope with the change in the commodities to be loaded to the transport, and quick determination of the arrangement of commodities with as small a deviation as possible of the center of gravity of the transport is almost impossible.

The above described problem is also encountered in determining time schedule of medical practitioners and nurses at a medical institution, determining furniture arrangement in a private housing, determining arrangement of components on a printed board, determining arrangement of packs for delivery or pieces of furniture for moving in a truck, or determining arrangement of cargoes in a airplane.

### SUMMARY OF THE INVENTION

According to the present invention, a program is provided to cause a computer to execute a determination of an appropriate arrangement of a plurality of objects where the plurality of objects classified into a plurality of types are to be arranged in a prescribed area to set an evaluation value to a target value, including: the first step of receiving the target value; the second step of receiving the plurality of types and number of objects belonging to each of the plurality of types; and the third step of determining, type by type, arrangement of the objects belonging to respective types such that the evaluation value comes closer to the target value, in an order starting from the type that has largest influence on bringing the evaluation value to the target value.

Preferably, the program further causes a computer to execute the fourth step of stopping determination of the appropriate arrangement when deviation between the appropriate arrangement and an optimal arrangement of the plurality of objects comes within a prescribed range.

Preferably, the program is to cause a computer to execute a cargo arrangement for transporting the cargo to cosmic space. Each object is a cargo transfer bag having a prescribed weight and a prescribed size for transporting commodities to the cosmic space. The plurality of objects classified into a plurality of types are a plurality of cargo transfer bags having different weights and different sizes. The prescribed area is a spacecraft to which the plurality of cargo transfer bags are loaded. The evaluation value is center of gravity of the spacecraft with loaded cargo when the plurality of cargo transfer bags are loaded to the spacecraft. The target value is an appropriate center of gravity with loaded cargo at which distance between the center of gravity with loaded cargo and an optimal center of gravity of the spacecraft is within a prescribed range. The type that has the largest influence on bringing the evaluation value to the target value is the cargo transfer bag having the largest size.

Preferably, a method of changing location of a cargo transfer bag of which arrangement is to be determined when total free area in the prescribed area is larger than a prescribed value is different from a method of changing location of a cargo transfer bag of which arrangement is to be determined when total free area in the prescribed area is not larger than the prescribed value.

Preferably, the plurality of cargo transfer bags are classified into bags of a first size, second size, third size and fourth size, from the larger ones. A method of changing location of a cargo transfer bag belonging to the first or second size is different from a method of changing location of a cargo transfer bag belonging to the third or fourth size.

Preferably, location of a cargo transfer bag belonging to the first size or the second size is changed by moving the cargo transfer bag to a neighboring free area. Location of a cargo transfer bag belonging to the third or fourth size is changed by switching with a cargo transfer bag belonging to the same size positioned at a random location.

Preferably, location of a cargo transfer bag belonging to the first size or the second size is changed by moving the cargo transfer bag to a neighboring free area. Location of a cargo transfer bag belonging to the third size is changed by switching with a cargo transfer bag of the same type located with a cargo transfer bag of the first and/or second size interposed. Location of a cargo transfer bag belonging to the fourth size is changed by switching with a cargo transfer bag of the same type at a neighboring location.

Preferably, location of a cargo transfer bag belonging to the first size or the second size is changed by moving the cargo transfer bag to a neighboring free area and by switching with a cargo transfer bag belonging to the same size positioned at a random location. Location of a cargo transfer bag belonging to the third size is changed by switching with a cargo transfer bag belonging to the same size positioned at a location with a cargo transfer bag of the first and/or second size interposed and by switching with a cargo transfer bag of the same size positioned at a random location. Location of a cargo transfer bag belonging to the fourth size is changed by switching with a cargo transfer bag of the same type at a neighboring location and with a cargo transfer bag of the same type at a random location.

Preferably, the plurality of cargo transfer bags are classified into bags of a first size, second size, third size and fourth size, from the larger ones. Location of a cargo transfer bag belonging to the first size or the second size is changed by switching with a cargo transfer bag belonging to the same size positioned at a random location. Location of a cargo transfer bag belonging to the third or fourth size is changed by switching with a cargo transfer bag belonging to the same size positioned at a random location.

Preferably, in the third step, the appropriate arrangement for objects belonging to each of the types is determined by changing location object by object and by changing location by a block unit, with each block including a prescribed number of objects of a prescribed type.

Preferably, the program is to cause a computer to execute a cargo arrangement for transporting the cargo to cosmic space. Each object is a cargo transfer bag having a prescribed weight and a prescribed size for transporting commodities to the cosmic space. The plurality of objects classified into a plurality of types are a plurality of cargo transfer bags having different weights and different sizes. The prescribed area is a spacecraft to which the plurality of cargo transfer bags are loaded. The evaluation value is center of gravity of the spacecraft with loaded cargo when the plurality of cargo transfer bags are loaded to the spacecraft. The target value is an appropriate center of gravity with loaded cargo at which deviation from an optimal center of gravity for the spacecraft to navigate along a desired orbit is within a prescribed range. The type that has the largest influence on bringing the evaluation value to the target value is the cargo transfer bag having the largest size.

Preferably, the spacecraft includes a cargo bay for loading the plurality of cargo transfer bags, and a thrust portion for thrusting the spacecraft. The cargo bay includes a plurality of cargo compartments each being capable of loading the plurality of cargo transfer bags. Each of the plurality of cargo compartments is constituted by a cargo rack or a pack rack selected arbitrarily from a plurality of different types of cargo racks in which the plurality of cargo transfer bags are arranged and a pack rack on which a pack other than the plurality of cargo transfer bags is arranged. The plurality of cargo transfer bags are arranged in at least one cargo rack arranged in at least one cargo compartment. The program causes a computer to further execute the fifth step of calculating an initial center of gravity using weights of the thrusting portion, the cargo racks and the pack rack. The third step is executed after the fifth step.

Preferably, the cargo rack is partitioned into a plurality of cargo areas. The third step is realized by at least one of the first sub-step in which the cargo transfer bag moves to a free area so that the center of gravity with loaded cargo comes closer to the optimal center of gravity, the second sub-step in which the cargo transfer bag switches location with a cargo transfer bag of the same type so that the center of gravity with loaded cargo comes closer to the optimal center of gravity, and the third sub-step in which location of the cargo transfer bags is switched in the block unit so that the center of gravity with loaded cargo comes closer to the optimal center of gravity. The block unit represents a unit including a plurality of cargo transfer bags that can be arranged in plurality in each of the plurality of cargo areas, among the plurality of different types of cargo transfer bags.

Preferably, the plurality of cargo transfer bags are classified into bags of the first size, second size, third size, fourth size, fifth size and sixth size, from the larger ones. The cargo rack includes a first cargo rack capable of containing cargo transfer bags belonging to the second to sixth sizes, and a second cargo rack capable of containing cargo transfer bags belonging to the second to sixth sizes and allowing placement of cargo transfer bags belonging to the first to sixth sizes on a front side. Location of a cargo transfer bag belonging to the first size is changed among the front sides of a plurality of the second cargo racks. Location of a cargo transfer bag belonging to any of the second to sixth sizes is changed at the front side of the second cargo rack, inside the first and second cargo racks, among the front sides of a plurality of second cargo racks, between the front side of the second cargo rack and inside of the first and second cargo racks, among insides of a plurality of first cargo racks, among insides of a plurality of second cargo racks, and between the inside of the first cargo rack and the inside of the second cargo rack.

Preferably, when each of the plurality of cargo compartments consists of the first cargo rack, in the first sub-step, cargo transfer bags belonging to the first to sixth sizes are moved to the free area, in the second sub-step, locations of cargo transfer bags belonging to the first to sixth sizes are switched, type by type, with cargo transfer bags of the same type, and in the third sub-step, locations of cargo transfer bags belonging to the first to sixth sizes are switched with cargo transfer bags of the same type or different type.

Preferably, the second size corresponds to i times (i is a natural number not smaller than 4) the fifth size. The third size corresponds to j times (j is a natural number satisfying 3≦j<i) the fifth size. The fourth size corresponds to k times (k is a natural number satisfying 2≦k<j) the fifth size. The fifth size corresponds to k times the sixth size. The third sub-step of the program includes step A of switching location of cargo transfer bags belonging to the fourth to sixth sizes with cargo transfer bags of the same type or different type by a first block unit of the fourth size, so that the center of gravity with loaded cargo comes closer to the optimal center of gravity, step B of switching location of cargo transfer bags belonging to the third to sixth sizes with cargo transfer bags of the same type or different type by a second block unit of the third size, so that the center of gravity with loaded cargo comes closer to the optimal center of gravity, and step C of switching location of cargo transfer bags belonging to the second to sixth sizes with cargo transfer bags of the same type or different type by a third block unit of the second size, so that the center of gravity with loaded cargo comes closer to the optimal center of gravity. At least one of step A, step B and step C is executed.

Preferably, step A is executed when the first block is filled with the cargo transfer bags. Step B is executed when the second block is filled with the cargo transfer bags. Step C is executed when the third block is filled with the cargo transfer bags.

Preferably, when the plurality of cargo compartments includes the first and second cargo racks, in the first sub-step, cargo transfer bags belonging to the first to sixth sizes are moved to the free area, in the second sub-step, locations of cargo transfer bags belonging to the first to sixth sizes are switched, type by type, with cargo transfer bags of the same type, and in the third sub-step, locations of cargo transfer bags belonging to the first to sixth sizes are switched with cargo transfer bags of the same type or different type.

Preferably, the first size corresponds to h times (h is a natural number not smaller than 6) the fifth size. The second size corresponds to i times (i is a natural number not smaller than 4) the fifth size. The third size corresponds to j times (is a natural number satisfying 3≦j<i) the fifth size. The fourth size corresponds to k times (k is a natural number satisfying 2≦k<j) the fifth size. The fifth size corresponds to k times the sixth size. The third sub-step of the program includes step A of switching location of cargo transfer bags belonging to the fourth to sixth sizes with cargo transfer bags of the same type or different type by a first block unit of the fourth size, so that the center of gravity with loaded cargo comes closer to the optimal center of gravity, step B of switching location of cargo transfer bags belonging to the third to sixth sizes with cargo transfer bags of the same type or different type by a second block unit of the third size, so that the center of gravity with loaded cargo comes closer to the optimal center of gravity, step C of switching location of cargo transfer bags belonging to the second to sixth sizes with cargo transfer bags of the same type or different type by a third block unit of the second size, so that the center of gravity with loaded cargo comes closer to the optimal center of gravity, and step D of switching location of cargo transfer bags belonging to the first to sixth sizes with cargo transfer bags of the same type or different type by a fourth block unit of the first size, so that the center of gravity with loaded cargo comes closer to the optimal center of gravity. At least one of the step A, step B, step C and step D is executed.

Preferably, step A is executed when the first block is filled with the cargo transfer bags. Step B is executed when the second block is filled with the cargo transfer bags. Step C is executed when the third block is filled with the cargo transfer bags. Step D is executed when the fourth block is filled with the cargo transfer bags.

According to the present invention, suitable arrangements of a plurality of objects are determined type by type of the objects, such that the evaluation value in a prescribed area comes close to a target value by arranging objects of different types in the prescribed area type by type. Here, the suitable arrangements of the different types of objects are determined in order, starting from that type which has the largest influence on bringing the evaluation value closer to the target value. The suitable arrangement of objects belonging to each type is determined by changing the position of objects one by one. Further, the suitable arrangement of objects belonging to each type may be determined by changing the position of objects one by one and by changing position block by block with each block including a prescribed number of objects of a prescribed type.

Therefore, according to the present invention, arrangement of the objects can quickly be determined such that the evaluation value is close to the target value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a transport having a plurality of cargo transfer bags, docked to a spacecraft.

FIG. 2 is a perspective view showing in detail the cargo bay of the transport shown in FIG. 1.

FIGS. 3A to 3D show types and sizes of cargo transfer bags to be loaded to the cargo compartment shown in FIG. 2.

FIG. 4 shows an exemplary arrangement of two types of cargo transfer bags in the cargo compartment.

FIG. 5 is a flow chart of a program in accordance with the first to third embodiments.

FIG. 6 is a flow chart representing details of steps S2 and S3 of the flow chart shown in FIG. 5, in accordance with the first embodiment.

FIG. 7 is a flow chart representing details of step S14 of the flow chart shown in FIG. 6.

FIG. 8 is a flow chart representing details of step S15 of the flow chart shown in FIG. 6.

FIG. 9 is a flow chart representing details of step S16 of the flow chart shown in FIG. 6.

FIG. 10 is a schematic illustration showing triple-size cargo transfer bags arranged in four cargo compartments.

FIG. 11 is a schematic illustration showing triple-size and double-size cargo transfer bags arranged in four cargo compartments.

FIG. 12 is a flow chart representing details of steps S4 and S5 of the flow chart shown in FIG. 5, in accordance with the first embodiment.

FIG. 13 is a flow chart representing details of step S24 of the flow chart shown in FIG. 12.

FIGS. 14A to 14D are schematic illustrations showing movement of single-size cargo transfer bags.

FIG. 15 is a schematic illustration showing triple-size, double-size and single-size cargo transfer bags arranged in four cargo compartments.

FIG. 16 is a schematic illustration showing triple-size, double-size, single-size and half-size cargo transfer bags arranged in four cargo compartments.

FIGS. 17A and 17B are schematic illustrations showing movement/switching of double-size cargo transfer bags.

FIG. 18 is a functional block diagram of the program in accordance with the present invention.

FIG. 19 represents relation between the functional block of FIG. 18 and the flow chart.

FIG. 20 is another functional block diagram of the program in accordance with the present invention.

FIG. 21 is a still another functional block diagram of the program in accordance with the present invention.

FIG. 22 is a further functional block diagram of the program in accordance with the present invention.

FIG. 23 is a functional block diagram of a personal computer.

FIG. 24 is a flow chart representing details of steps S2 and S3 of the flow chart shown in FIG. 5, in accordance with the second embodiment.

FIG. 25 is a flow chart representing details of steps S4 and S5 of the flow chart shown in FIG. 5, in accordance with the second embodiment.

FIG. 26 is a flow chart representing details of steps S2 and S3 of the flow chart shown in FIG. 5 in accordance with the third embodiment.

FIG. 27 is a flow chart representing details of steps S4 and S5 of the flow chart shown in FIG. 5, in accordance with the third embodiment.

FIG. 28 is a perspective view representing the transport and the cargo bay of the transport in accordance with the fourth embodiment.

FIGS. 29A to 29F show types and sizes of cargo transfer bags to be loaded to the cargo compartment in accordance with the fourth embodiment.

FIGS. 30A to 30C are perspective views of racks constituting the cargo compartments.

FIG. 31 is a flow chart of the program in accordance with the fourth embodiment.

FIG. 32 is a flow chart representing an operation by a means B shown in FIG. 31.

FIG. 33 is a flow chart representing details of the operation in step S55 of the flow chart shown in FIG. 32.

FIG. 34 is a flow chart representing details of the operation in step S56 of the flow chart shown in FIG. 32.

FIG. 35 is a flow chart representing a block switching operation in step S57 of the flow chart shown in FIG. 32.

FIG. 36 is another flow chart representing a block switching operation in step S57 of the flow chart shown in FIG. 32.

FIG. 37 is a still another flow chart representing a block switching operation in step S57 of the flow chart shown in FIG. 32.

FIG. 38 is a schematic illustration of block switching in steps S571 and S572 of the flow chart shown in FIGS. 35 to 37.

FIGS. 39A and 39B are schematic illustrations of block switching in step S573 of the flow chart shown in FIGS. 36 and 37.

FIGS. 40A and 40B are schematic illustrations of block switching in step S574 of the flow chart shown in FIG. 37.

FIG. 41 is a flow chart representing a detailed operation in step S571 of the flow chart shown in FIGS. 35 to 37.

FIG. 42 is a flow chart representing a detailed operation in step S572 of the flow chart shown in FIGS. 35 to 37.

FIG. 43 is a flow chart representing a detailed operation in step S573 of the flow chart shown in FIGS. 36 and 37.

FIG. 44 is a flow chart representing a detailed operation in step S574 of the flow chart shown in FIG. 37.

FIG. 45 is a flow chart representing an operation by a means C shown in FIG. 31.

FIG. 46 is a first exemplary arrangement of cargo transfer bags determined by using a program in accordance with the fourth embodiment.

FIG. 47 is a second exemplary arrangement of cargo transfer bags determined by using the program in accordance with the fourth embodiment.

FIG. 48 is a third exemplary arrangement of cargo transfer bags determined by using the program in accordance with the fourth embodiment.

FIG. 49 is fourth exemplary arrangement of cargo transfer bags determined by using the program in accordance with the fourth embodiment.

FIG. 50 is a fifth exemplary arrangement of cargo transfer bags determined by using the program in accordance with the fourth embodiment.

FIG. 51 is a sixth exemplary arrangement of cargo transfer bags determined by using the program in accordance with the fourth embodiment.

FIG. 52 is a seventh exemplary arrangement of cargo transfer bags determined by using the program in accordance with the fourth embodiment.

FIG. 53 represents centers of gravity of the cargo arrangements shown in FIGS. 46 to 52.

FIG. 54 is a perspective view of a transport illustrating the conventional problem.

### DESCRIPTION OF THE PREFERRED EMBODIMENTS

Embodiments of the present invention will be described in detail with reference to the figures. In the figures, the same or corresponding portions are denoted by the same reference characters and description thereof will not be repeated.

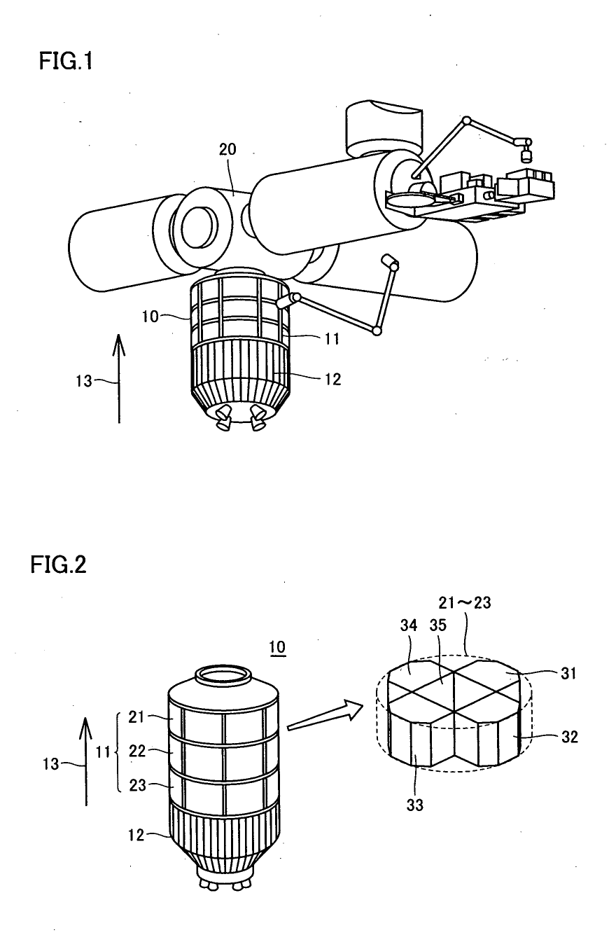

Transportation of cargo transfer bags to the cosmic space, of which arrangement is determined by the program of the present invention, will be described. FIG. 1 is a perspective view of a transport having a plurality of cargo transfer bags loaded therein, docked to a spacecraft. Details of spacecraft 20 are not related to the present invention, and therefore, description will not be given here. It is noted that spacecraft 20 performs various observations and the like in the cosmic space.

A transport 10 has a columnar shape and includes a cargo bay 11 and a thrusting portion 12. Cargo bay 11 has a bottom surface with the diameter of 4.5 m, and its length along the height direction (direction of the arrow 13) is 2.3 m. Thrusting portion 12 thrusts transport 10 from the launch to reach spacecraft 20.

By arranging cargo transfer bags at locations determined by the program of the present invention, the plurality of cargo transfer bags are loaded to cargo bay 11. Transport 10 with the plurality of cargo transfer bags loaded is launched from the earth, driven by thrusting portion 12 and docked to spacecraft 20.

An astronaut working on board the spacecraft 20 brings the number of cargo transfer bags loaded to cargo bay 11 of transport 10 into spacecraft 20 for use. Further, the astronaut reloads transport 10 with used cargo transfer bags, by returning the cargo transfer bags to locations determined by the program in accordance with the present invention. Transport 10 loaded with used cargo transfer bags is separated from spacecraft 20 and burned up in the cosmic space or lands at a prescribed landing site on the earth.

FIG. 2 is a perspective view showing in detail the cargo bay 11 of transport 10. Cargo bay 11 has three cargo bay sections 21 to 23. Each of the cargo bay sections 21 to 23 has a space 35 at the center and cargo compartments 31 to 34 arranged surrounding the space 35. The arrangement of central space 35 allows the astronaut to easily carry in and out the cargo transfer bags to and from cargo compartments 31 to 34. In each of cargo compartments 31 to 34, a plurality of cargo transfer bags are arranged at locations determined by the method that will be described later.

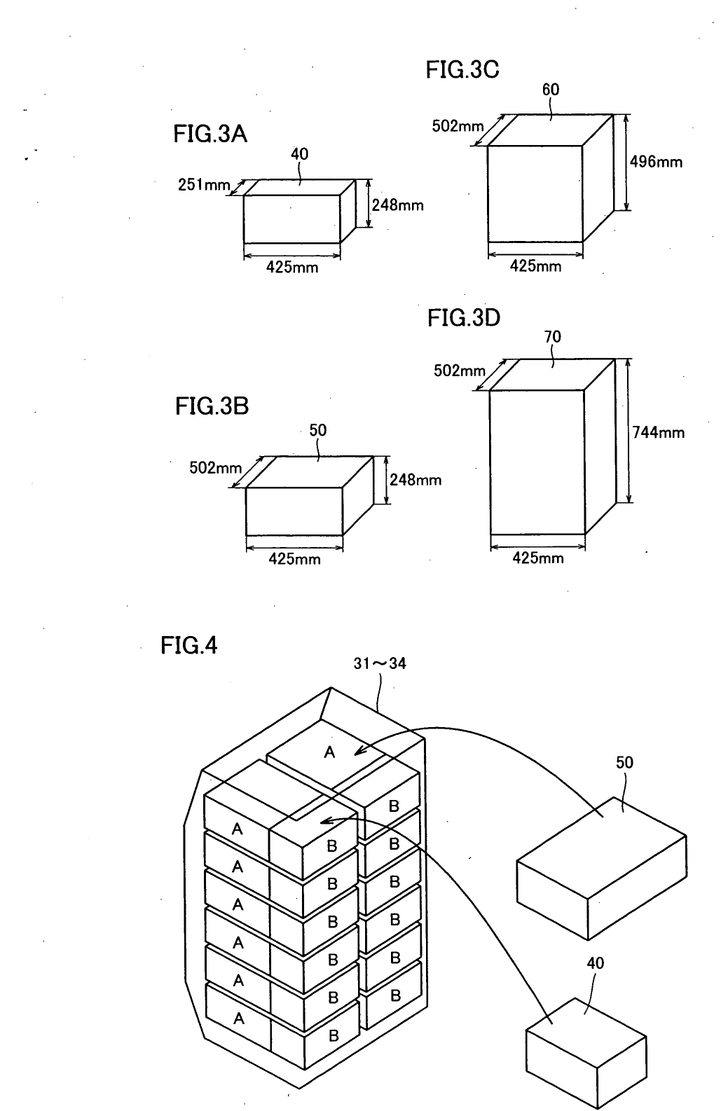

FIGS. 3A to 3D show types and sizes of cargo transfer bags to be loaded to cargo compartments 31 to 34. Cargo transfer bags to be loaded to cargo compartments 31 to 34 include cargo transfer bags 40, 50, 60 and 70. Cargo transfer bag 40 has the width, height and depth of 425 mm, 248 mm and 251 mm, respectively (see FIG. 3A). Cargo transfer bag 50 has the width, height and depth of 425 mm, 248 mm and 502 mm, respectively. Cargo transfer bag 50 has double the depth of cargo transfer bag 40 (see FIG. 3B).

Cargo transfer bag 60 has the width, height and depth of 425 mm, 496 mm and 502 mm, respectively. Cargo transfer bag 60 has double the height of cargo transfer bag 50, and double the height and depth of cargo transfer bag 40 (see FIG. 3C). Cargo transfer bag 70 has the width, height and depth of 425 mm, 744 mm and 502 mm, respectively. Cargo transfer bag 70 has three times the height and double the depth of cargo transfer bag 40, three times the height of cargo transfer bag 50 and 1.5 times the height of cargo transfer bag 60 (see FIG. 3D).

Cargo transfer bag 40 has the weight of 6 kg (tolerance: 3˜13 kg). Cargo transfer bag 50 has the weight of 12 kg (tolerance: 6˜27 kg). Cargo transfer bag 60 has the weight of 24 kg (tolerance: 9˜54 kg). Cargo transfer bag 70 has the weight of 36 kg (tolerance: 15˜81 kg).

As described above, cargo transfer bags 40, 50, 60 and 70 have the same width and different height, depth and weight. In the following, cargo transfer bags 40, 50, 60 and 70 will be referred to as “half-size cargo transfer bag,” “single-size cargo transfer bag,” “double-size cargo transfer bag,” and “triple-size cargo transfer bag,” respectively.

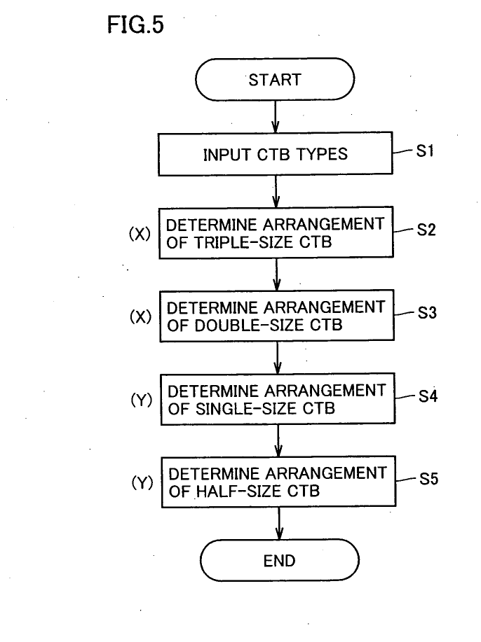

FIG. 4 shows an exemplary arrangement of cargo transfer bags 40 and 50 in cargo compartments 31 to 34. Each of the cargo compartments 31 to 34 is capable of loading 12 cargo transfer bags 50 (denoted by “A” in the compartment) and 12 cargo transfer bags 40 (denoted by “B” in the compartment).

The program in accordance with the present invention determines arrangement of cargo transfer bags 40, 50, 60 and 70 when these four different types of cargo transfer bags 40, 50, 60 and 70 having different sizes and weights are to be loaded to cargo compartments 31 to 34 such that deviation between the center of gravity of transport 10 with the cargo loaded and the transport 10 by itself would be at most 12.6 mm.

In the following, the program for determining the arrangement of cargo transfer bags 40, 50, 60 and 70 when cargo transfer bags 40, 50, 60 and 70 are to be loaded to cargo compartments 31 to 34 with the deviation in center of gravity of transport 10 kept within 12.6 mm will be described.

[First Embodiment]

FIG. 5 is a flow chart of the program in accordance with the first embodiment. When an operation for determining the arrangement of cargo transfer bags 40, 50, 60 and 70 starts, types of the cargo transfer bags (CTBs) to be loaded to cargo compartments 31 to 34 are set as an input (step S1). Specifically, sizes and weights of four different types of cargo transfer bags 40, 50, 60 and 70 are input.

Thereafter, arrangement of triple-size cargo transfer bags 70 that have the largest size among the input types of cargo transfer bags is determined (step S2). Next, arrangement of double-size cargo transfer bags 60 that have the second largest size among the input types of cargo transfer bags is determined (step S3). Then, arrangements of single-size cargo transfer bags 50 and half-size cargo transfer bags 40 are determined in order (steps S4, S5). Thus, the operation of determining the arrangements of cargo transfer bags 40, 50, 60 and 70 in cargo compartments 31 to 34 is completed.

In this manner, in the operation of determining the arrangements of cargo transfer bags, arrangements in cargo compartments 31 to 34 are determined in order, starting from the bags of larger size, from the following reason.

When four different types of cargo transfer bags 40, 50, 60 and 70 having different sizes (weights) are to be arranged in cargo compartments 31 to 34 while keeping deviation of the center of gravity of transport 10 within 12.6 mm, triple-size cargo transfer bag 70, double-size cargo transfer bag 60, single-size cargo transfer bag 50 and half-size cargo transfer bag 40 have influence larger in this order on the user's requirement of “keeping the deviation in center of gravity within-12.6 mm.” Therefore, when the arrangement is determined starting from the bags having smaller influence on the user's requirement, the degree of freedom in arranging the triple-size cargo transfer bags 70 would be small, and when the arrangement of triple-size cargo transfer bags 70 is to be determined, it becomes necessary to change already determined arrangements of half-size cargo transfer bags 40, single-size cargo transfer bags 50 and double-size cargo transfer bags 60. Namely, it becomes necessary to start arrangement of four different types of cargo transfer bags 40, 50, 60 and 70 again from the beginning.

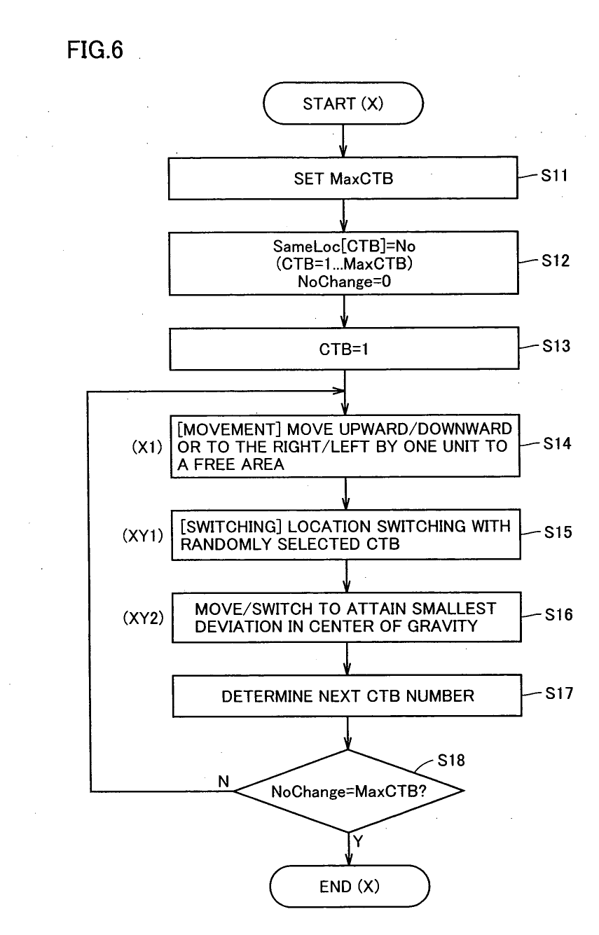

FIG. 6 is a flow chart representing an operation of determining arrangements of triple-size cargo transfer bags 70 and double-size cargo transfer bags 60 in steps S2 and S3 of the flow chart shown in FIG. 5. Specifically, in accordance with the first embodiment of the present invention, the arrangement of triple-size cargo transfer bags 70 is determined in the similar manner as that of double-size cargo transfer bags 60. In the following, arrangement of triple-size cargo transfer bags 70 will be described as an example.

When the operation of determining the arrangement of triple-size cargo transfer bags 70 starts, the total number MaxCTB of the triple-size cargo transfer bags 70 is input (step S11). For all cargo transfer bags 70 as the object of determining arrangement (cargo transfer bags 70 having the number 1 to MaxCTB), a same location flag SameLoc[CTB] is set to “No”, and the number NoChange of cargo transfer bags 70 of which location is not moved/switched is set to “0” (step S12).

The same location flag SameLoc [CTB] being set to “No” means that the location of the cargo transfer bag 70 as the object of determining arrangement is not at the same location as before (namely, it means that the bag has been moved), and the same location flag SameLoc [CTB] being set to “Yes” means that the location of the cargo transfer bag 70 as the object of determining arrangement is the same as before (namely, it means that the bag has not been moved). In step S12, the same location flag SameLoc [CTB] is set to “No” for every cargo transfer bag 70, to assume that, at the start of the operation of determining the arrangement, locations of cargo transfer bags 70 as the objects have been moved from previous locations, namely the cargo transfer bags 70 are in movable states. Further, the number bags of which location is not moved/switched is set to “0”, because locations of all the cargo transfer bags 70 are to be moved/switched to determine the arrangement of cargo transfer bags 70, at the start of the operation of determining the arrangement.

After step S12, the number CTB of cargo transfer bag 70 is set to the initial value of “1” (step S13). Then, location of triple-size cargo transfer bag 70 having the number CTB “1” is moved to a free space (area) neighboring in the upward/downward or left/right direction, and the center of gravity at each location after movement is calculated (step S14). Thereafter, the triple-size cargo bag 70 having the number CTB “1” is switched at random with a triple-size cargo transfer bag 70 having different number CTB, and the center of gravity at the switched location is calculated (step S15).

Through the movement of location of triple-size cargo transfer bag 70 in step S14 and the switching of location of triple-size cargo transfer bag 70 in step S115, the triple-size cargo bag 70 having the number CTB “1” is moved/switched to the location where the deviation in the center of gravity is the smallest (step S16). Specifically, in steps S14 to S16, a location, where the deviation of the center of gravity is the smallest when the triple-size cargo transfer bag 70 having the number CTB “1” is changed by movement or switching, is determined, and the triple-size cargo transfer bag 70 having the number CTB “1” is moved and switched to the thus determined location.

Then, then number CTB of the next cargo transfer bag 70 of which location is to be changed by movement and switching is determined (step S17). Specifically, the next number CTB is determined by
Next number CTB=mod(CTB, Max CTB)+1 (1).

According to equation (1), the next number CTB is determined successively, from a smaller one to larger one. Then, the next number CTB is set to a minimum one after reaching a maximum one, and the determination of the next number CTB is repeated according to equation (1).

Next, when the number of cargo transfer bag 70 of which location is to be moved and switched is determined, whether the number NoChange of bags of which location is not moved/switched is equal to the total number MaxCTB of cargo transfer bags 70 set in step S11 or not is determined (step S18). When the number NoChange of bags of which location is not moved/switched is not equal to the total number MaxCTB of cargo transfer bags 70, steps S14 to S18 are repeated until the number NoChange of bags of which location is not moved/switched reaches the total number MaxCTB of cargo transfer bags 70. In other words, steps S14 to S18 are repeated until the location at which the deviation in the center of gravity is the smallest is determined for each of cargo transfer bags 70 having the number: 1, . . . , MaxCTB and cargo transfer bags 70 of respective numbers CTB are moved/switched to the determined locations.

When the number NoChange of bags of which location is not moved/switched becomes equal to the total number MaxCTB of cargo transfer bags 70, a cargo transfer bag 70 of which location is to be changed by movement/switching no longer exists, and therefore, the operation of determining the arrangement is terminated.

In the foregoing, determination of the next number CTB in step S17 is described as proceeding successively from smaller CTB number to larger CTB number. In the present invention, the next number CTB may be determined by other methods.

Specifically, the next number CTB may be determined successively from larger CTB number to smaller CTB number. Alternatively, the next CTB number may be determined successively first among even numbers followed by odd numbers, or determined successively first among odd numbers followed by even numbers. Alternatively, the next CTB number may be determined at random.

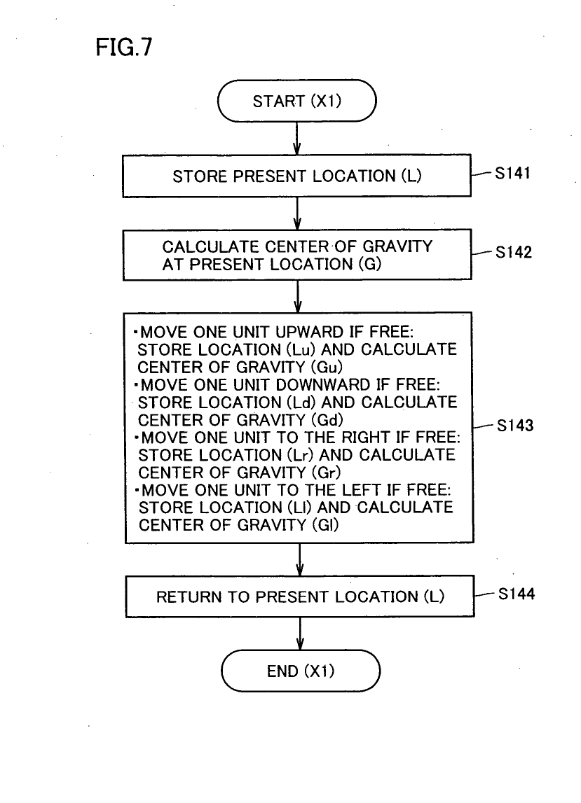

FIG. 7 is a flow chart representing details of the operation in step S14 of the flow chart shown in FIG. 6. After step S13 of the flow chart shown in FIG. 6, present location L of the triple-size cargo transfer bag 70 having the number CTB “1” is stored (step S141). Thereafter, the center of gravity G at the present location L is calculated (step S142).

Thereafter, the triple-size cargo transfer bag 70 having the number CTB “11” is moved to a free space neighboring in upward/downward or left/right direction, the location after movement is stored and the center of gravity at that location is calculated (step S143). Specifically, when a neighboring space above the object cargo transfer bag 70 is available, the object cargo transfer bag 70 is moved up to the free space above, the location after movement Lu is stored, and the center of gravity Gu at the location Lu is calculated. When a neighboring space below the object cargo transfer bag 70 is available, the object cargo transfer bag 70 is moved down to the free space below, the location after movement Ld is stored, and the center of gravity Gd at the location Ld is calculated. When a neighboring space to the right to the object cargo transfer bag 70 is available, the object cargo transfer bag 70 is moved to the free space on the right side, the location after movement Lr is stored, and the center of gravity Gr at the location Lr is calculated. When a neighboring space to the left to the object cargo transfer bag 70 is available, the object cargo transfer bag 70 is moved to the free space on the left side, the location after movement L1 is stored, and the center of gravity G1 at the location L1 is calculated.

Specifically, in step S143, when there is any free area to which the object cargo transfer bag 70 can be moved, all the locations of the available areas are stored, and the center of gravity is calculated for every available location.

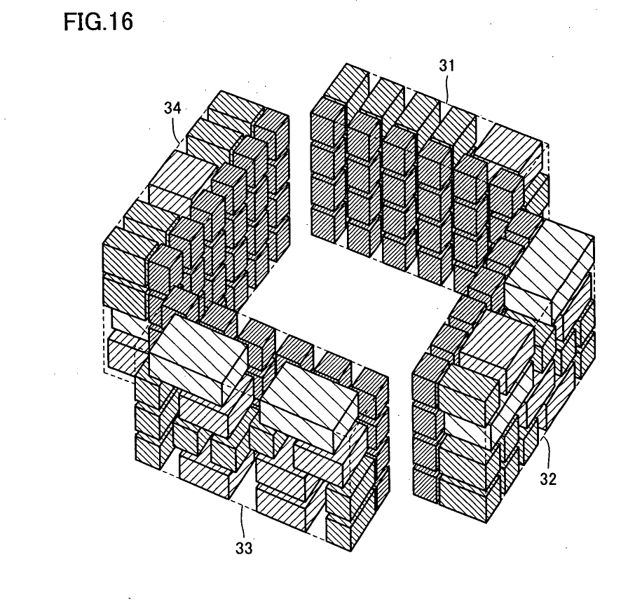

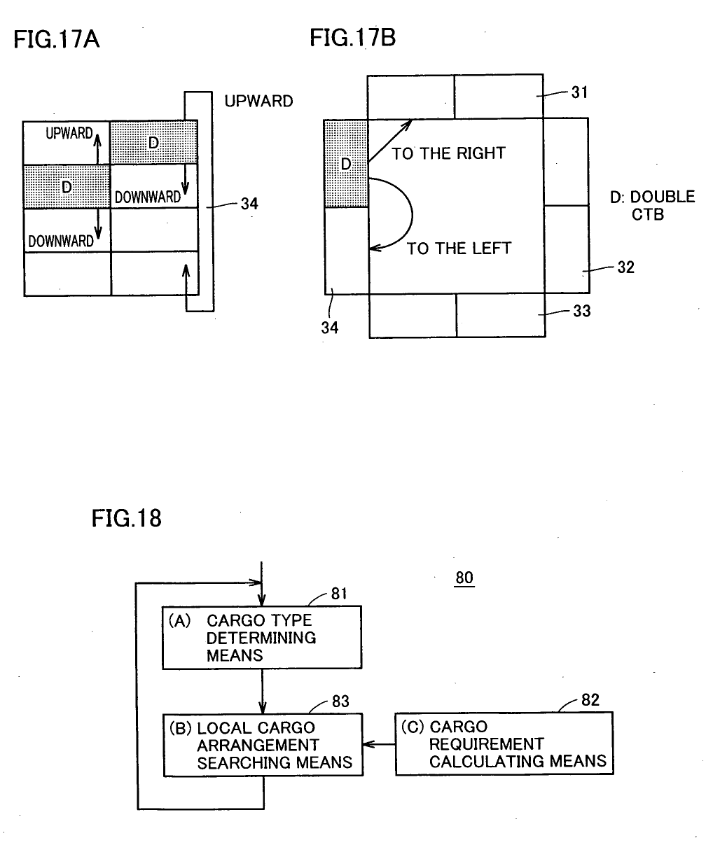

After step S143, the object cargo transfer bag 70 is returned to the present location L (step S144), and the specific operations of step S14 shown in FIG. 16 end.

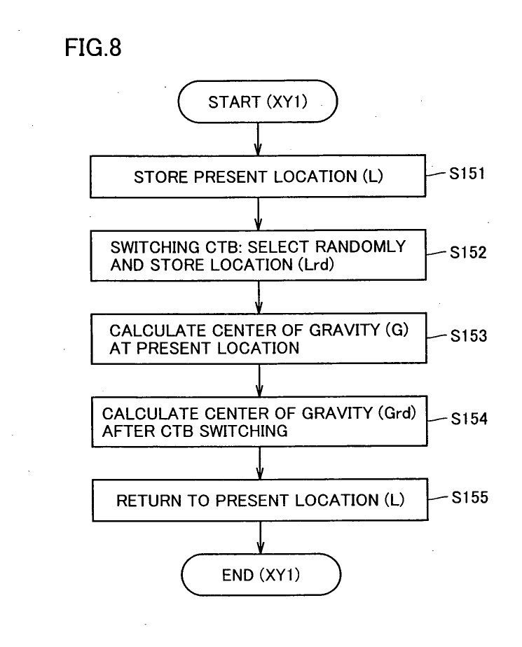

FIG. 8 is a flow chart representing details of the operation of step S15 of the flow chart shown in FIG. 6. After step S14 of the flow chart shown in FIG. 6, the present location L of a triple-size cargo transfer bag 70 having the number CTB “1” is stored (step S151). Thereafter, a cargo transfer bag 70 having a different number CTB to be switched with the object cargo transfer bag 70 is selected at random, and the object cargo transfer bag 70 is switched to the selected cargo transfer bag, so as to change the location of the object cargo transfer bag 70. Then, the location Lrd of the cargo transfer bag of which location has been changed by the switching is stored (step S152).

Thereafter, the center of gravity G at the present location L is calculated (step S153), and the center of gravity Grd at the switched location Lrd is calculated (step S154). After the calculation of the center of gravity Grd, the bag is returned to the present location L (step S155), and the specific operations of step S15 shown in FIG. 6 end.

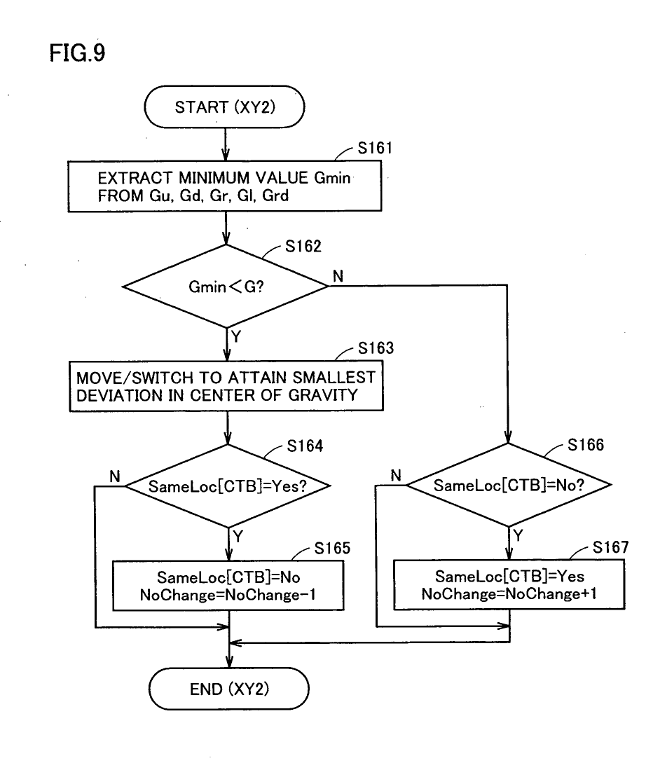

FIG. 9 is a flow chart representing details of the operation in step S16 of the flow chart shown in FIG. 6. After step S15 of the flow chart shown in FIG. 6, among the values of center of gravity Gu, Gd, Gr, G1, and Grd calculated in steps S14 and S15, the center of gravity Gmin at which the deviation from the optimal center of gravity when no cargo transfer bag is loaded to cargo compartments 31 to 34 is the smallest is extracted (step S161). Whether the center of gravity Gmin is smaller than the center of gravity G at the present location or not is determined (step S162).

In step S162, when the center of gravity Gmin is smaller than the center of gravity G, that is, when the deviation from the optimal center of gravity becomes smaller by moving/switching the triple-size cargo transfer bag as the object from the present location to another location, the triple-size cargo transfer bag 70 as the object is moved/switched to the location, at which the deviation of the center of gravity is the smallest, extracted in step S161 (step S163). Then, whether the same location flag SameLoc[CTB] of the cargo transfer bag 70 having the number CTB “1” is “Yes” or not, that is, whether the location of the object cargo transfer bag 70 is the same as before or not, is determined (step S164). Determination as to whether the location of the object cargo transfer bag 70 is the same as the previous location or not is made as there is a possibility that the object cargo transfer bag 70 will be repeatedly determined to be at the same location, namely the object cargo transfer bag 70 can no further be moved to a location where the deviation in the center of gravity becomes smaller, in steps S14 to S16.

In step S164, when the same location flag SameLoc [CTB] is not “Yes”, that is, when the location of the object cargo transfer bag 70 is different from the previous location, specific operations of step S16 shown in FIG. 6 end. On the contrary, when the same location flag SameLoc [CTB] is “Yes” in step S164, that is, when the location of the object cargo transfer bag 70 is the same as the previous location, the same location flag SameLoc [CTB] is set to “No”, the number NoChange of bags of which location is not moved/switched is decreased by “1” (step S165), and the specific operations of step S16 shown in FIG. 6 end.

In step S164, when the same location flag SameLoc [CTB] is “Yes”, the same location flag SameLoc [CTB] is set to “No” in step S165 because it is possible to further move the location of the object cargo transfer bag 70 as it is at the same location as before. Whether the cargo transfer bag having the number CTB of which same location flag SameLoc [CTB] has been set to “No” in step S165 can actually be moved/switched in steps S14, S15 of FIG. 6 will be determined in step S143 of FIG. 7 representing details of step S14 and in step S152 of FIG. 8 representing details of step S15. In step S165 shown in FIG. 9, the possibility of moving/switching cargo transfer bag 70 as the object of determining arrangement to a location with smaller deviation in the center of gravity is left. Such setting enables detection of the location of cargo transfer bag 70 at which the deviation in the center of gravity becomes smaller.

In step S162, when the center of gravity Gmin is not smaller than the center of gravity G, that is, when the deviation from the optimal center of gravity is smaller when the triple-size cargo transfer bag 70 as the object is kept at the present location, whether the same location flag SameLoc [CTB] of the object cargo transfer bag 70 is “No” or not, that is, whether the location of the object cargo transfer bag 70 is different from the previous location or not is determined (step S166).

In step S166, when the same location flag SameLoc [CTB] is not “No”, that is, when the object cargo transfer bag 70 is at the same location, specific operations of step S16 shown in FIG. 6 end. When the same location flag SameLoc [CTB] is “No” in step S166, that is, when the location of the object cargo transfer bag 70 is different from the previous location, the same location flag SameLoc [CTB] is set to “Yes”, the number NoChange of bags of which location is not moved/switched is increased by 1 (step S167), and the specific operations of step S16 shown in FIG. 6 end.

In step S166, when the same location flag SameLoc [CTB] is “No”, the same location flag SameLoc [CTB] is set to “Yes” in step S167, as the possibility of further moving the object cargo transfer bag 70 is small.

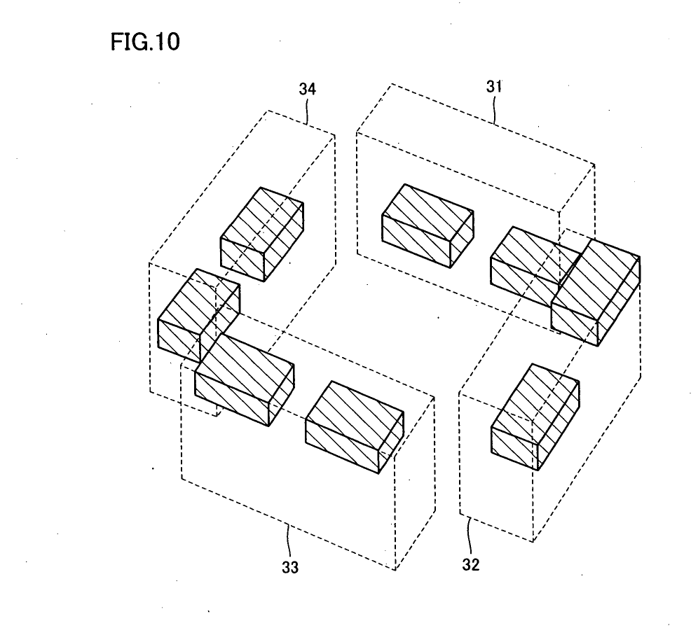

As described above, in accordance with the flow chart shown in FIGS. 6 to 9, a location at which the deviation in the center of gravity becomes the smallest is determined for the triple-size cargo transfer bag 70, and the triple-size cargo transfer bag 70 is moved/switched to the determined location. In this example, the triple-size cargo transfer bags are arranged in four cargo compartments 31 to 34 as shown in FIG. 10.

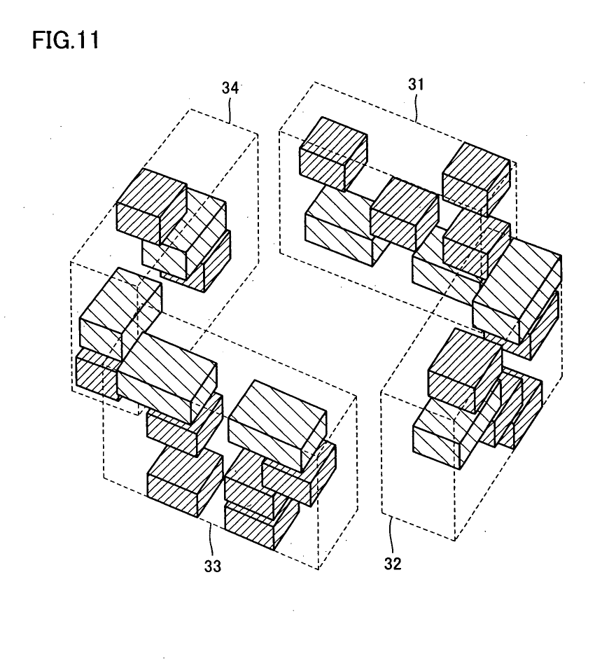

The arrangement of double-size cargo transfer bags 60 determined in step S3 of the flow chart shown in FIG. 5 may also be determined in accordance with the same flow as shown in the flow charts of FIGS. 6 to 9, in which triple-size cargo transfer bags 70 are changed to double-size cargo transfer bags 60. When the arrangement of the double-size cargo transfer bags 60 is to be determined in accordance with the flow charts shown in FIGS. 6 to 9, locations of the double-size cargo transfer bags 60 are moved/switched using free space in cargo compartments 31 to 34 in which triple-size cargo transfer bags 70 have been loaded as shown in FIG. 10, and the arrangement of double-size cargo transfer bags 60 is determined such that the deviation in the center of gravity is the smallest with the triple-size and double-size cargo transfer bags 70 and 60 loaded. As a result, the triple-size and double-size cargo transfer bags 70 and 60 are arranged in four cargo compartments 31 to 34 as shown in FIG. 11.

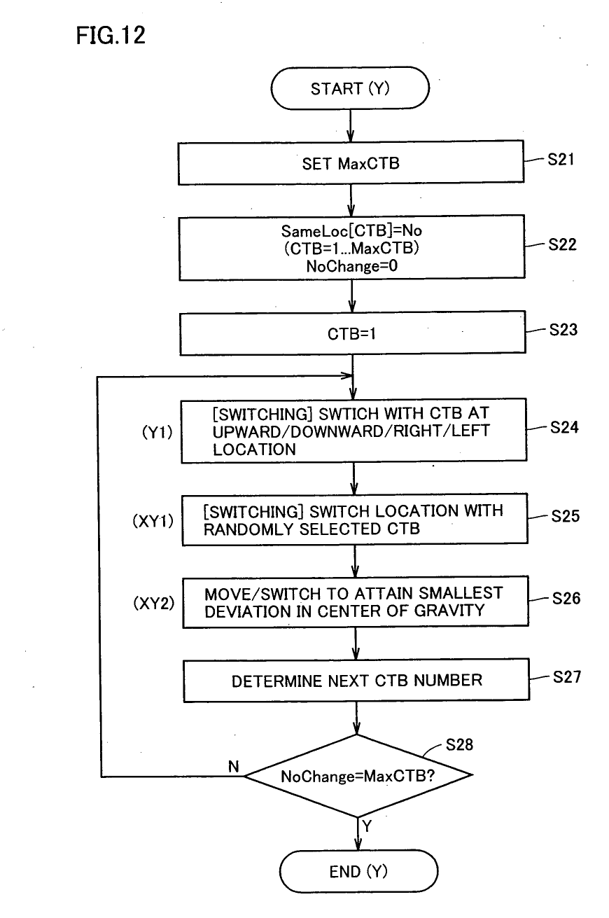

FIG. 12 is a flow chart representing an operation of determining arrangement of single-size cargo transfer bags 50 and of half-size cargo transfer bags 40 shown in steps S4 and S5 of the flow chart of FIG. 5. When the arrangement of single-size cargo transfer bags 50 is to be determined, locations of the single-size cargo transfer bags 50 are switched using the free space of cargo compartments 31 to 34 in which triple-size and double-size cargo transfer bags 70 and 60 have been loaded as shown in FIG. 11, and the arrangement of single-size cargo transfer bags 50 is determined such that the deviation in the center of gravity is the smallest with the triple-size, double-size and single-size cargo transfer bags 70, 60 and 50 loaded.

At the start of operation for determining the arrangement of single-size cargo transfer bags 50, the total number MaxCTB of the single-size cargo transfer bags 50 is input (step S21). For all cargo transfer bags 50 as the object of determining arrangement (cargo transfer bags 50 having the numbers 1 to MaxCTB), the same location flag SameLoc[CTB] is set to “No”, and the number NoChange of cargo transfer bags 50 of which location is not moved/switched is set to “0” (step S22).

The reason why the same location flag SameLoc[CTB] is set to “No” for all the cargo transfer bags 50 in step S22 is the same as the reason why the same location flag SameLoc[CTB] is set to “No” in step S12 of FIG. 6. Further, the reason why the number NoChange of bags of which location is not moved/switched is set to “0” is the same as the reason why the number of bags of which location is not moved/switched is set to “0” in step S12 of FIG. 6.

After step S22, the number CTB of cargo transfer bag 50 is set to the initial value of “1” (step S23). Then, location of single-size cargo transfer bag 50 having the number CTB “1” is switched to a location of a single-size cargo transfer bag neighboring in the upward/downward or left/right direction, and the center of gravity at each location after switching is calculated (step S24). Thereafter, the single-size cargo bag 50 having the number CTB “1” is switched at random with a single-size cargo transfer bag 50 having different number CTB, and the center of gravity at the switched location is calculated (step S25).

Through the switching of single-size cargo transfer bag 50 with a single-size cargo transfer bag at a neighboring location in step S24 and the switching of single-size cargo transfer bag 50 with a single-size cargo transfer bag 50 at a random location in step S25, the single-size cargo bag 50 having the number CTB “1” is switched to the location where the deviation in the center of gravity is the smallest (step S26). Specifically, in steps S24 to S26, a location, where the deviation of the center of gravity is the smallest when the location of single-size cargo transfer bag 50 having the number CTB “1” is changed by switching, is determined, and the single-size cargo transfer bag 50 having the number CTB “1” is switched to the thus determined location.

Then, the next number CTB of the cargo transfer bag 50 of which location is to be changed by switching is determined in accordance with equation (1) (step S27).

Next, when the number of cargo transfer bag 50 of which location is to be switched is determined, whether the number NoChange of bags of which location is not switched is equal to the total number MaxCTB of cargo transfer bags 50 set in step S21 or not is determined (step S28). When the number NoChange of bags of which location is not switched is not equal to the total number MaxCTB of cargo transfer bags 50, steps S24 to S28 are repeated until the number NoChange of bags of which location is not switched reaches the total number MaxCTB of cargo transfer bags 50. In other words, steps S24 to S28 are repeated until the location at which the deviation in the center of gravity is the smallest is determined for each of cargo transfer bags 50 having the number: 1, . . . , MaxCTB and cargo transfer bags 50 of respective numbers CTB are switched to the determined locations.

When the number NoChange of bags of which location is not switched becomes equal to the total number MaxCTB of cargo transfer bags 50, a cargo transfer bag 50 of which location is to be changed by switching no longer exists, and therefore, the operation of determining the arrangement is terminated.

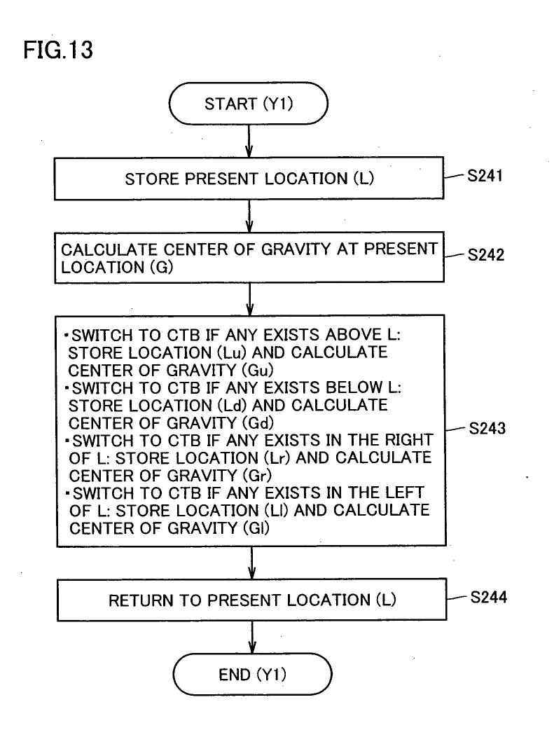

FIG. 13 is a flow chart representing details of the operation of step S24 of the flow chart shown in FIG. 12. After step S23 shown in FIG. 12, the present location L of the single-size cargo transfer bag 50 is stored (step S241). Then, the center of gravity G at the present location is calculated (step S242).

Thereafter, location of the single-size cargo transfer bag 50 having the number CTB “1” is switched to a location of a neighboring single-size cargo transfer bag in upward/downward or left/right direction, the location after switching is stored and the center of gravity at that location is calculated (step S243). Specifically, when there is a neighboring single-size cargo transfer bag above the object cargo transfer bag 50, the object cargo transfer bag 50 is switched with the neighboring single-size cargo transfer bag above (up), the location after switching Lu is stored, and the center of gravity Gu at the location Lu is calculated. When there is a neighboring single-size cargo transfer bag below the object cargo transfer bag 50, the object cargo transfer bag 50 is switched with the neighboring single-size cargo transfer bag below (down), the location after switching Ld is stored, and the center of gravity Gd at the location Ld is calculated. When there is a neighboring single-size cargo transfer bag to the right to the object cargo transfer bag 50, the object cargo transfer bag 50 is switched with the neighboring single-size cargo transfer bag to the right, the location after switching Lr is stored, and the center of gravity Gr at the location Lr is calculated. When there is a neighboring single-size cargo transfer bag to the left to the object cargo transfer bag 50, the object cargo transfer bag 50 is switched with the neighboring single-size cargo transfer bag to the left, the location after switching L1 is stored, and the center of gravity G1 at the location L1 is calculated.

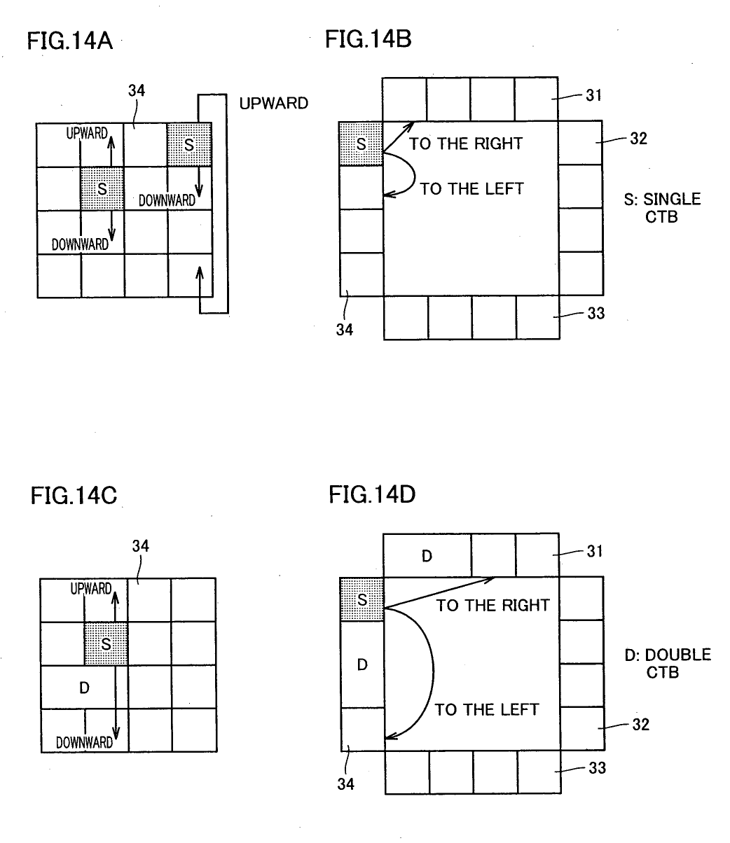

Specifically, in step S243, when there is any single-size cargo transfer bag that can be switched with the object cargo transfer bag 50, all the switchable locations are stored, and center of gravity at every switchable location is calculated. In step S243, the single-size cargo transfer bag 50 may be switched not only with single-size cargo transfer bags at neighboring locations but also with single-size cargo transfer bags with a double-size cargo transfer bag being interposed (see FIGS. 14C and 14D). FIGS. 14A and 14C show the cargo compartments 31 to 34 viewed from the front side, and FIGS. 14B and 14D show the cargo compartments 31 to 34 viewed from above. Generally, the single-size cargo transfer bag 50 may be switched not only with single-size cargo transfer bags at neighboring locations but also with single-size cargo transfer bags with triple-size/double-size cargo transfer bag being interposed. It is noted that switching of location is not limited between single-size cargo transfer bags within one cargo compartment 34 (or 31, 32 or 33), and switching may take place between single-size cargo transfer bags existing in neighboring cargo compartments 31 and 34, as shown in FIG. 14.

After step S243, the object cargo transfer bag 50 is returned to the present location L (step S244), and the specific operations of step S24 shown in FIG. 12 end.

Specific operations of step S25 of the flow chart shown in FIG. 12 are executed in accordance with the same flow chart as that shown in FIG. 8. Further, specific operations of step S26 of the flow chart shown in FIG. 12 are executed in accordance with the same flow chart as that shown in FIG. 9.

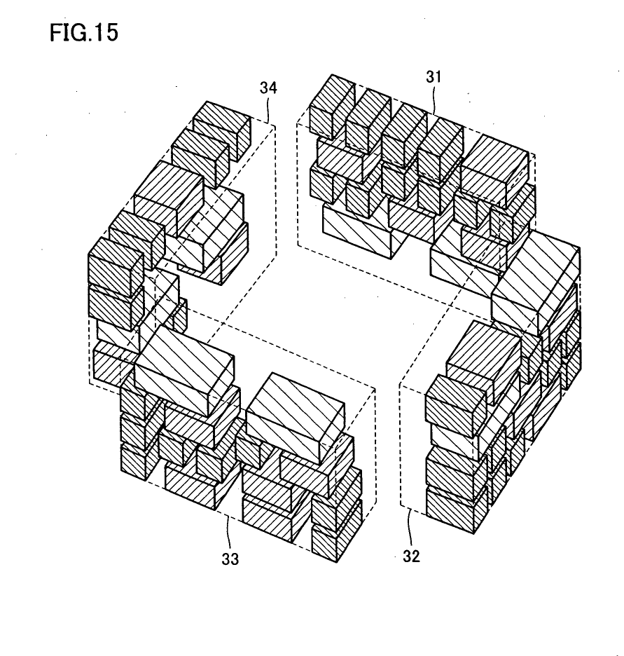

As described above, in accordance with the flow charts shown in FIGS. 8, 9, 12 and 13, the location at which the deviation in the center of gravity is the smallest is determined for the single-size cargo transfer bag 50, and the single-size cargo transfer bag 50 is switched to the thus determined location. In this example, the triple-size, double-size and single-size cargo transfer bags are arranged in four cargo compartments 31 to 34 as shown, for example, in FIG. 15.

The arrangement of half-size cargo transfer bags 40 determined in step S5 of the flow chart shown in FIG. 5 may also be determined in accordance with the same flow as shown in the flow charts of FIGS. 8, 9, 12 and 13, in which single-size cargo transfer bags 50 are changed to half-size cargo transfer bags 40. When the arrangement of the half-size cargo transfer bags 40 is to be determined in accordance with the flow charts shown in FIGS. 8, 9, 12 and 13, locations of the half-size cargo transfer bags 40 are switched using free space in cargo compartments 31 to 34 in which triple-size, double-size and single-size cargo transfer bags 70, 60 and 50 have been loaded as shown in FIG. 15, and the arrangement of half-size cargo transfer bags 40 is determined such that the deviation in the center of gravity is the smallest with the triple-size, double-size, single-size and half-size cargo transfer bags 70, 60, 50 and 40 loaded. As a result, the triple-size, double-size, single-size and half-size cargo transfer bags 70, 60, 50 and 40 are arranged in four cargo compartments 31 to 34 as shown in FIG. 16. When the arrangement of half-size cargo transfer bags 40 is to be determined, the half-size cargo transfer bag 40 is always switched with a neighboring half-size cargo transfer bag, in step S243 shown in FIG. 13.

In this manner, the arrangement of four different types of cargo transfer bags 40, 50, 60 and 70 in cargo compartments 31 to 34 is determined. The center of gravity with four different types of cargo transfer bags 40, 50, 60 and 70 arranged in cargo compartments 31 to 34 is deviated by as small as 0.109 to 0.225 mm from the optimal center of gravity, which deviation is far smaller than the target value of 12.6 mm.

As described above, determination of the arrangement of triple-size and double-size cargo transfer bags 70 and 60 is different from determination of the arrangement of single-size and half-size cargo transfer bags 50 and 40, as the former is achieved through movement and switching of cargo transfer bags while the latter is achieved through switching of cargo transfer bags only. Therefore, in the present invention, the method of determining the arrangement of cargo transfer bags with the free area being larger than a prescribed value is different from the method of determining the arrangement of cargo transfer bags with the free area being smaller than a prescribed value.

When the arrangement of single-size and half-size cargo transfer bags 50 and 40 is to be determined, the method of arrangement is based on the same mechanism in that the single-size cargo transfer bags 50 and the half-size cargo transfer bags 40 are switched with cargo transfer bags of the same type. It is noted, however, that the mechanism of determining the arrangement of single-size cargo transfer bags 50 is different from that of half-size cargo transfer bags 40, as the single-size cargo transfer bag 50 may be switched with a single-size cargo transfer bag at a neighboring location or with a single-size cargo transfer bag at a location with a triple-size and/or double-size cargo transfer bag interposed, while the half-size cargo transfer bag 40 is always switched with a half-size cargo transfer bag at a neighboring location.

FIG. 18 is a functional block diagram representing the function of a program determining arrangement of cargo transfer bags 40, 50, 60 and 70 executed in accordance with the flow charts shown in FIGS. 5 to 9, 12 and 13. The functional block 80 of the program in accordance with the present invention includes cargo type determining means 81, cargo requirement calculating means 82, and local cargo arrangement searching means 83. Cargo type determining means 81 determines types of the cargo transfer bags to be loaded to cargo compartments 31 to 34 of transport 10. Specifically, cargo type determining means 81 selects cargo transfer bags successively, starting from the one that has the largest influence on the user's requirement that deviation in the center of gravity when cargo transfer bags 40, 50, 60 and 70 are loaded to cargo compartments 31 to 34 is at most 12.6 mm, from the input cargo transfer bags 40, 50, 60 and 70.

Cargo requirement calculating means 82 calculates the requirement that deviation between the center of gravity when cargo transfer bags 40, 50, 60 and 70 are loaded to cargo compartments 31 to 34 and the center of gravity when cargo transfer bags 40, 50, 60 and 70 are loaded should be within 12.6 mm.

Local cargo arrangement searching means 83 successively searches for a location where each of the cargo transfer bags 40, 50, 60 and 70 locally satisfies the requirement from requirement calculating means 82, in the order of cargo transfer bags 70, 60, 50 and 40 as selected by cargo type determining means 81. Here, local cargo arrangement searching means 83 specifically searches for a location where each of the cargo transfer bags 40, 50, 60 and 70 locally satisfies the requirement from cargo requirement calculating means 82 by local movement of the cargo transfer bags 40, 50, 60 and 70 or location switching between the cargo transfer bags of the same type, and moves or switches the cargo transfer bags 40, 50, 60 and 70 to the searched out locations.

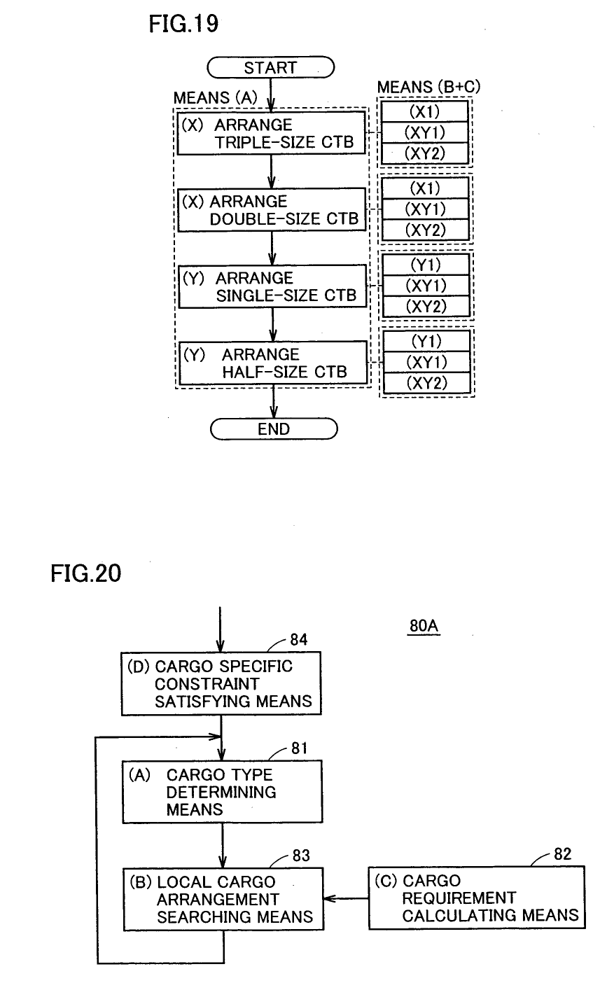

FIG. 19 represents relation between cargo type determining means 81, cargo requirement calculating means 82 and local cargo arrangement searching means 83 and the flow charts shown in FIGS. 5 to 9, 12 and 13. In FIG. 19, cargo type determining means 81 is denoted by “A”, cargo requirement calculating means 82 is denoted by “C” and local cargo arrangement searching means 83 is denoted by “B”. Further, steps S2 and S3 of FIG. 5 are denoted by “X”, and steps S4 and S5 are denoted by “Y”. Further, the flow chart of FIG. 7 is denoted by “X1”, the flow chart of FIG. 8 is denoted by “XY1”, and the flow chart of FIG. 9 is denoted by “XY2”.

Cargo type determining means 81 performs the function corresponding to steps S2 to S5 shown in FIG. 5, that is, the function of determining arrangement of cargo transfer bags 40, 50, 60 and 70, starting from triple-size cargo transfer bags 70, followed by double-size cargo transfer bags 60, single-size cargo transfer bags 50 and half-size cargo transfer bags 40 in this order, for the four different types of cargo transfer bags 40, 50, 60 and 70. Further, cargo requirement calculating means 82 and local cargo arrangement searching means 83 perform the function corresponding to the flow charts of FIGS. 7 to 9, that is, the function of calculating the requirement that the deviation in the center of gravity is set within 12.6 mm, locally moving or switching locations of cargo transfer bags 40, 50, 60 and 70 to satisfy the calculated requirement and eventually moving or switching locations of cargo transfer bags 40, 50, 60 and 70 to locations that realize small deviation of the center of gravity.

The functional block of the program in accordance with the present invention may be the block 80A shown in FIG. 20. Functional block 80A is the same as functional block 80 except that cargo specific constraint satisfying means 84 is added.

Cargo specific constraint satisfying means 84 arranges cargo transfer bags 40, 50, 60 and 70 such that constraints imposed individually on each of the cargo transfer bags 40, 50, 60 and 70 are satisfied. By way of example, cargo specific constraint satisfying means 84 arranges triple-size cargo transfer bags 70 to satisfy such a requirement that “among cargo transfer bags 40, 50, 60 and 70, the heaviest, triple-size cargo transfer bags 70 must be arranged at locations easiest for the astronaut to take out from cargo compartments 31 to 34.” It is noted that cargo specific constraint satisfying means 84 is provided to satisfy constraints individually imposed on each of cargo transfer bags 40, 50, 60 and 70 and not the constraints related to the overall arrangement of cargo transfer bags 40, 50, 60 and 70.

When individual constraint is to be satisfied after all the cargo transfer bags 40, 50, 60 and 70 have been arranged, it may possibly be necessary to cancel the once determined arrangement and start again from the beginning, necessitating redundant calculations. By the addition of cargo specific constraint satisfying means 84, such a problem can be solved, and the arrangement of cargo transfer bags 40, 50, 60 and 70 can be determined efficiently.

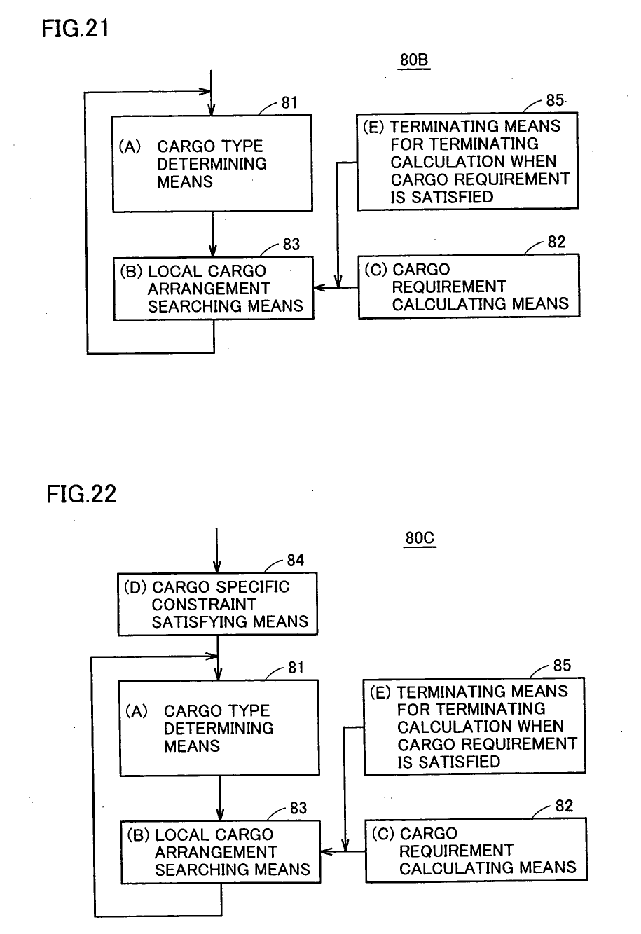

Alternatively, the functional block of the program in accordance with the present invention may be the functional block 80B shown in FIG. 21. Functional block 80B is the same as functional block 80 except that terminating means 85 is added for terminating calculation when cargo requirement is satisfied.

Terminating means 85 calculates whether each location of cargo transfer bags 40, 50, 60 and 60 satisfies the user's requirement or not, and when the requirement is satisfied, terminates calculation for the arrangement of cargo transfer bags 40, 50, 60 and 70. In functional block 80, even when the user's requirement is satisfied, calculation for the arrangement of cargo transfer bags 40, 50, 60 and 70 is continued to find a location where the deviation in the center of gravity becomes smaller. In contrast, in functional block 80B, when the deviation in the center of gravity attained by the arrangement of cargo transfer bags 40, 50, 60 and 70 calculated by cargo type determining means 81, cargo requirement calculating means 82, and local cargo arrangement searching means 83 satisfies the user's requirement, calculation for the arrangement of cargo transfer bags 40, 50, 60 and 70 is terminated at that time point. This eliminates unnecessary additional calculation, and an arrangement that satisfies the user's requirement can be attained with smaller number of switching of the cargo transfer bags.

Alternatively, the functional block of the program in accordance with the present invention may be the functional block 80C shown in FIG. 22. Functional block 80C is the same as functional block 80 except that it additionally includes cargo specific constraint satisfying means 84 and terminating means 85 for terminating calculation when cargo requirement is satisfied. Cargo specific constraint satisfying means 84 is the same as that described with respect to functional block 80A, and terminating means 85 is the same as that described with respect to functional block 80B.

As compared with functional blocks 80, 80A and 80B, in functional block 80C, unnecessary calculation can further be reduced and arrangement of cargo transfer bags 40, 50, 60 and 70 can be determined with higher efficiency.

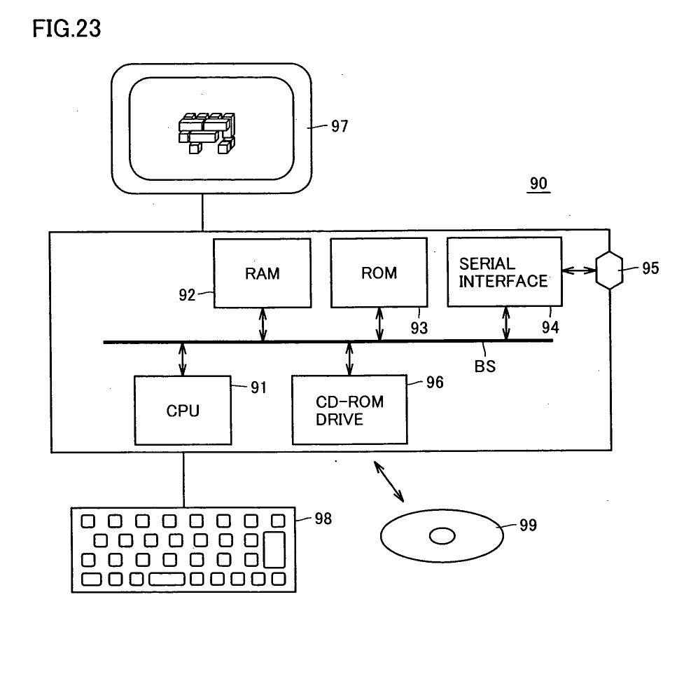

FIG. 23 is a functional block diagram of a personal computer executing determination of arrangement of cargo transfer bags 40, 50, 60 and 70 to satisfy the user's requirement, using the program described above. A personal computer 90 includes a data bus BS, a CPU (Central Processing Unit) 91, an RAM (Random Access Memory) 92, an ROM (Read Only Memory) 93, a serial interface 94, a terminal 95, a CD-ROM drive 96, a display 97 and a keyboard 98.

CPU 91 reads the program stored in ROM 93 through data bus BS, and using the read program, determines the arrangement of cargo transfer bags 40, 50, 60 and 70. Alternatively, CPU 91 stores the program obtained through serial interface 94, terminal 95 and the Internet, or the program read from a CD (Compact Disk) 99 through CD-ROM drive 96, in ROM 93. Further, CPU 91 receives an instruction from the user input through keyboard 98, and displays the arrangement of cargo transfer bags 40, 50, 60 and 70 calculated by the program described above on the display.

RAM 92 is a work memory when the arrangement of cargo transfer bags 40, 50, 60 and 70 is to be determined by CPU 91 using the program described above. ROM 93 stores the above described program. Serial interface 94 exchanges data with data bus BS and terminal 95.

Terminal 95 is for connecting, by a cable, personal computer 90 to a modem (not shown). CD-ROM drive 96 reads the program recorded on CD 99. Display 97 provides various visual information with the user. Keyboard 98 is for inputting user's instruction.

When the user is to determine the arrangement of cargo transfer bags 40, 50, 60 and 70 by personal computer 90 using the program described above, CPU 91 reads the program from ROM 93 through data bus BS. CPU 91 executes the read program, and displays a message asking input of the type of the cargo transfer bags.

In reply to the message appearing on display 97, the user of personal computer 90 inputs the types (weight and size) of the cargo transfer bags to be used for calculation to personal computer 90 through keyboard 98. CPU 91 receives the types of the cargo transfer bags input through keyboard 98.

CPU 91 then determines the arrangement of cargo transfer bags 40, 50, 60 and 70 in accordance with the flow charts described above, and displays the result on display 97.

When the program represented by functional block 80A of FIG. 20 is used, CPU 91 asks the user to input constraint to be imposed individually upon each of the cargo transfer bags 40, 50, 60 and 70 used for calculation. When the user inputs through the keyboard 98 the constraint imposed individually, CPU 91 determines the arrangement of cargo transfer bags 40, 50, 60 and 70 to satisfy the input constraint.

When the program represented by the functional block 80B shown in FIG. 21 is used, CPU 91 displays the arrangement of cargo transfer bags 40, 50, 60 and 70 as a result of calculation, and displays a message asking whether the calculation is to be continued or not on display 97. When the user inputs an instruction to stop calculation through keyboard 98, CPU 91 stops calculation for determining the arrangement of cargo transfer bags 40, 50, 60 and 70.

When the program represented by the functional block 80C shown in FIG. 22 is used, the user is asked, by a message on display 97, to input the constraint to be imposed individually upon each of the cargo transfer bags 40, 50, 60 and 70 used for calculation. When the user inputs through the keyboard 98 the constraint imposed individually, CPU 91 determines the arrangement of cargo transfer bags 40, 50, 60 and 70 to satisfy the input constraint. Further, CPU 91 displays the arrangement of cargo transfer bags 40, 50, 60 and 70 as a result of calculation, and displays a message asking whether the calculation is to be continued or not on display 97. When the user inputs an instruction to stop calculation through keyboard 98, CPU 91 stops calculation for determining the arrangement of cargo transfer bags 40, 50, 60 and 70.

It is possible for the user to connect personal computer 90 to the modem (not shown) through terminal 95, and to obtain the program through the Internet. Then, CPU 91 stores the obtained program in ROM 93 through terminal 95, serial interface 94 and data bus BS. Further, the user loads CD 99 to CD-ROM drive 96 and reads the program recorded on CD 99 to personal computer 90. CPU 91 obtains the program read by CD-ROM drive 96 through data bus BS and stores the same in ROM 93. In response to an instruction from the user, CPU 91 reads the program stored in ROM 93 through data bus BS and determines the arrangement of cargo transfer bags 40, 50, 60 and 70.

In this manner, it is possible for personal computer 90 to obtain the program for determining arrangement of cargo transfer bags 40, 50, 60 and 70 through various methods. Therefore, in the present invention, the program for determining the arrangement of cargo transfer bags 40, 50, 60 and 70 includes the programs obtained through the above described methods.

[Second Embodiment]

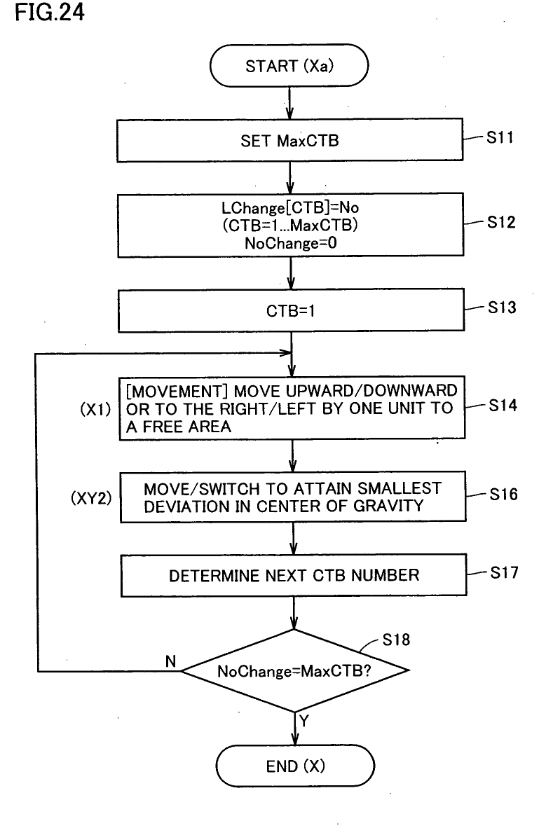

The program in accordance with the second embodiment proceeds along the same flow as the flow chart shown in FIG. 5. It is noted, however, that in the program of the second embodiment, specific operations of steps S2 and S3 shown in FIG. 5 are executed in accordance with the flow chart of FIG. 24, in place of the flow chart of FIG. 6.

The flow chart shown in FIG. 24 is the same as that shown in FIG. 6 except that step S15 of the flow chart of FIG. 6 is omitted. Specifically, according to the flow chart of FIG. 24, arrangement of triple-size cargo transfer bags 70 and double-size cargo transfer bags 60 is determined without performing switching of a triple-size cargo transfer bag 70 with a triple-size cargo transfer bag at a random location and switching of a double-size cargo transfer bag 60 with a double-size cargo transfer bag at a random location.

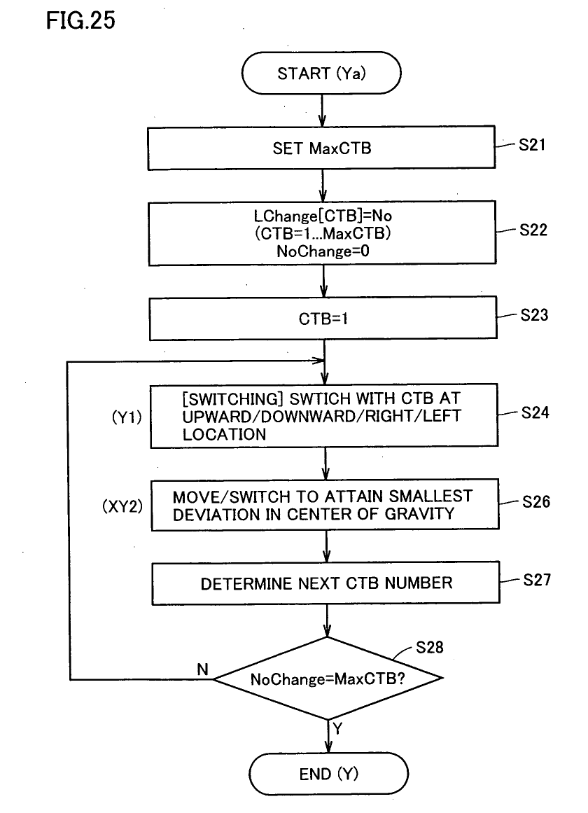

Further, in the program of the second embodiment, specific operations of steps S4 and S5 shown in FIG. 5 are executed in accordance with the flow chart of FIG. 25 in place of the flow chart of FIG. 12.

The flow chart shown in FIG. 25 is the same as that shown in FIG. 12 except that step S25 of the flow chart of FIG. 12 is omitted. Specifically, according to the flow chart of FIG. 25, arrangement of single-size cargo transfer bags 50 and half-size cargo transfer bags 40 is determined without performing switching of a single-size cargo transfer bag 50 with a single-size cargo transfer bag at a random location and switching of a half-size cargo transfer bag 40 with a half-size cargo transfer bag at a random location.

In this manner, according to the second embodiment, locations of cargo transfer bags 40, 50, 60 and 70 are not switched to the cargo transfer bags of the same type at random locations, but the cargo transfer bags 60 and 70 are moved to neighboring free areas and cargo transfer bags 40 and 50 are switched with neighboring cargo transfer bags of the same type, so as to determine the arrangement of the cargo transfer bags 40, 50, 60 and 70 to satisfy the user's requirement.

Except for these points, the embodiment is the same as the first embodiment.

[Third Embodiment]

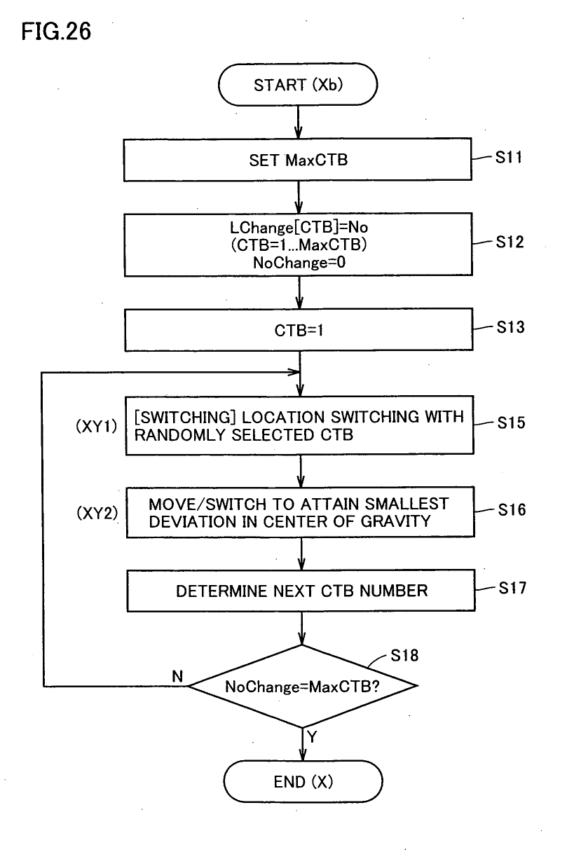

The program in accordance with the third embodiment proceeds along the same flow as the flow chart shown in FIG. 5. It is noted, however, that in the program of the third embodiment, specific operations of steps S2 and S3 shown in FIG. 5 are executed in accordance with the flow chart of FIG. 26, in place of the flow chart of FIG. 6.

The flow chart shown in FIG. 26 is the same as the flow chart shown in FIG. 6 except that step S14 of FIG. 6 is omitted. Specifically, according to the flowchart of FIG. 26, the arrangement of triple-size cargo transfer bags 70 and double-size cargo transfer bags 60 is determined without moving the triple-size and double-size cargo transfer bags 70 and 60 to neighboring free areas.

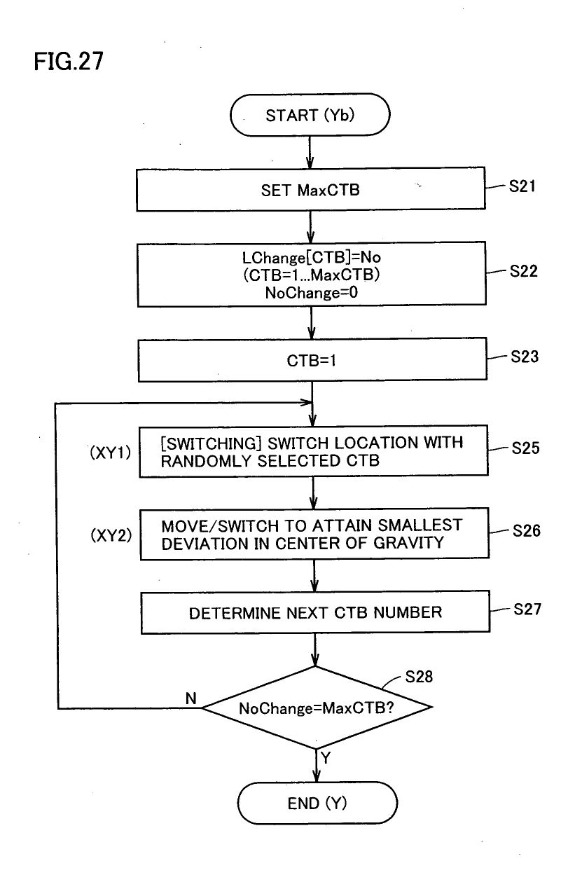

Further, in the program of the third embodiment, specific operations of steps S4 and S5 shown in FIG. 5 are executed in accordance with the flow chart shown in FIG. 27, in place of the flow chart shown in FIG. 12.

The flow chart shown in FIG. 27 is the same as the flow chart shown in FIG. 12 except that step S24 is omitted. Specifically, according to the flow chart shown in FIG. 27, arrangement of single-size cargo transfer bags 50 and half-size cargo transfer bags 40 is determined without performing switching of a single-size cargo transfer bag 50 with a single-size cargo transfer bag positioned above, below, to the right or to the left of the object cargo transfer bag 50 and switching of a half-size cargo transfer bag 40 with a half-size cargo transfer bag positioned above, below, to the right or to the left of the object cargo transfer bag 40.

In this manner, according to the third embodiment, arrangement of the cargo transfer bags 40, 50, 60 and 70 can be determined to satisfy the user's requirement simply by switching the locations of cargo transfer bags 40, 50, 60 and 70 with locations of cargo transfer bags of the same type existing at random locations.

Except for these points, the embodiment is the same as the first embodiment.

In the foregoing, determination of the arrangement of cargo transfer bags 40, 50, 60 and 70 to satisfy the user's request attained by moving and/or switching four different types of cargo transfer bags has been described. It is noted that the program in accordance with the present invention generally determines the arrangement of cargo transfer bags 40, 50, 60 and 70 by changing the locations of cargo transfer bags 40, 50, 60 and 70, when the arrangement of four different types of cargo transfer bags 40, 50, 60 and 70 is to be determined to satisfy the user's requirement.

Though a program for determining arrangement of four different types of cargo transfer bags has been described above, according to the present invention, the types of cargo transfer bags may be one or more and not limited to four. Even when there is only one type of cargo transfer bags, it is still necessary to arrange a plurality of cargo transfer bags in cargo compartments 31 to 34 with the deviation of the center of gravity as small as possible as shown in FIG. 10, as the plurality of cargo transfer bags are arranged in the cargo compartments. Therefore, the program of the present invention is applicable even when the arrangement of cargo transfer bags of one type is to be determined.

In the foregoing, a program for determining arrangement of cargo transfer bags such that deviation in the center of gravity of a transport is minimized when a plurality of different types of cargo transfer bags are to be loaded to the transport and delivered to the cosmic space has been described. The present invention is also applicable for determining time schedule of medical practitioners and nurses at a medical institution, determining furniture arrangement in a private housing, determining arrangement of packs for delivery or pieces of furniture for moving in a truck, determining arrangement of a plurality of types of circuits on a printed board, or determining arrangement of cargoes in a airplane.

When the present invention is applied to arrangement of nurses and medical practitioners at a medical institution, the nurse and the medical practitioner correspond to the types of the objects. By way of example, time schedule of a plurality of nurses and a plurality of medical practitioners is determined by the program described above, with a constraint that one nurse or one medical practitioner works at most two days a week. The individual constraint imposed on objects may be scheduling such that all the inpatients can be treated, considering medical specialties of the practitioners.

When the furniture is to be arranged in a private housing, pieces of furniture correspond to the types of objects. By way of example, arrangement of the furniture including a plurality of different types of pieces is determined in accordance with the program described above, starting from the piece having larger volume, to satisfy the constraint that the space after the arrangement of the furniture should be wider than a prescribed value. The individual constraint imposed on objects may include that a desk should be placed at a light location near the window, a TV set should be placed at a location convenient for the viewers, and that a VCR deck should be placed near the TV set.

When a plurality of circuits are to be arranged on a circuit board, circuits of different sizes correspond to the types of the objects. By way of example, the arrangement of the plurality of different types of circuits is determined in accordance with the above described program starting from the circuit having largest size, to satisfy the constraint that circuits of as many types as possible are to be arranged on the circuit board. The individual constraint imposed on objects may be that a circuit with high heat radiation should be placed on a peripheral portion of the board and that circuits of the same type should be distributed uniformly over the board.

[Fourth Embodiment]

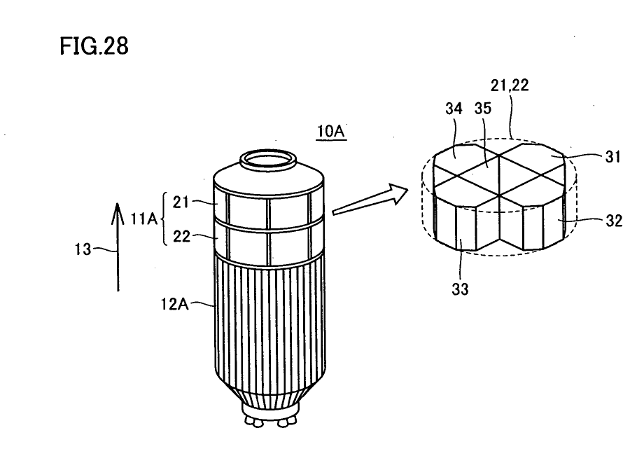

FIG. 28 is a perspective view showing a transport 10A and a cargo bay 11A of transport 10A in accordance with the fourth embodiment. Transport 10A has a columnar shape and includes cargo bay 11A and a thrusting portion 12A. Cargo bay 11A has a bottom surface with the diameter of about 45 m, and its length along the height direction (direction of the arrow 13) is 2.3 m. Cargo bay 11A has two cargo bay sections 21 and 22.

The weight of transport 10A is about 10 t without any cargo. To thrusting portion 12A, an engine, various exposed pallets that may be exposed to radiation in the cosmic space, water and fuel are loaded. As a result, when there is no cargo loaded thereon, the center of gravity of transport 10A is off from the optimal position. The engine thrusts transport 10A from the launch to reach spacecraft 20.

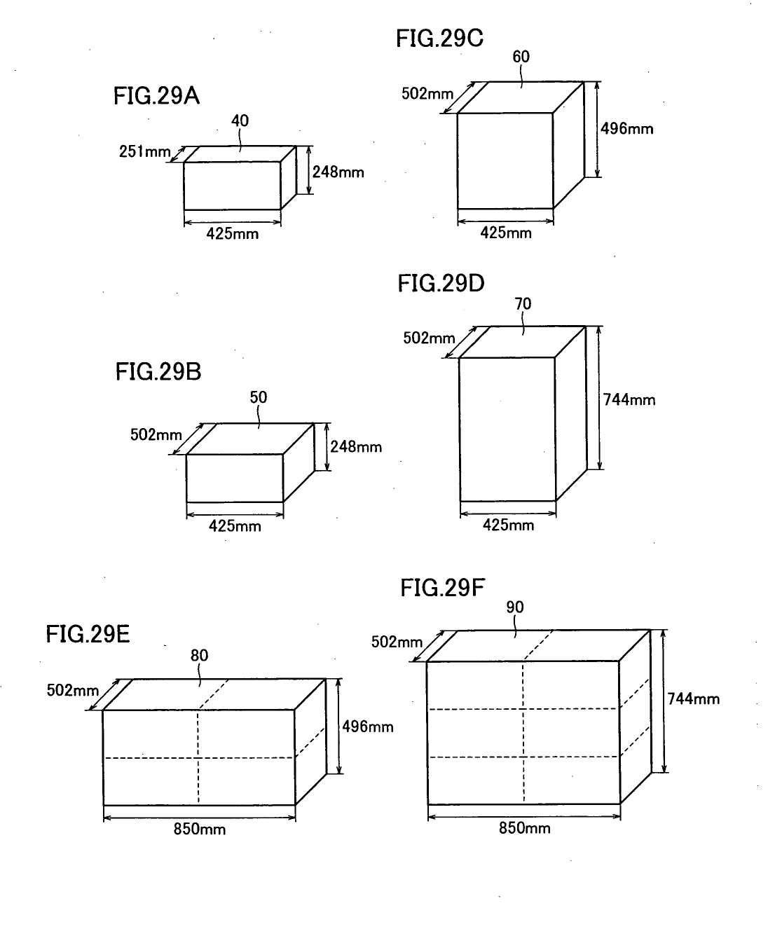

FIGS. 29A to 29F represent types and sizes of cargo transfer bags to be loaded to cargo compartments 31 to 34 in accordance with the fourth embodiment. In the fourth embodiment, cargo transfer bags to be loaded to cargo compartments 31 to 34 include cargo transfer bags 40, 50, 60, 70, 80 and 90. Cargo transfer bags 40, 50, 60 and 70 are the same as those described with reference to the first embodiment.

Cargo transfer bag 80 has the width of 850 mm, height of 496 mm, and depth of 502 mm. Cargo transfer bag 80 has twice the width of cargo transfer bag 60, and twice the width and twice the height of cargo transfer bag 50. Therefore, the size of cargo transfer bag 80 corresponds to four cargo transfer bags 50 put together (see FIG. 29E).

Cargo transfer bag 90 has the width of 850 mm, height of 744 mm, and depth of 502 mm. Cargo transfer bag 90 has twice the width of cargo transfer bag 70, and twice the width and third times the height of cargo transfer bag 50. Therefore, the size of cargo transfer bag 80 corresponds to six cargo transfer bags 50 put together (see FIG. 29F).

In the fourth embodiment, cargo transfer bags 40, 50, 60, 70, 80 and 90 have the following weights: Cargo transfer bag 40, 7.1 kg in average (tolerance: 0.9˜13 kg); cargo transfer bag 50, 18.6 kg in average (tolerance: 1.6˜27 kg); cargo transfer bag 60, 29.6 kg in average (tolerance: 1.9˜54 kg); cargo transfer bag 70, 32.1 kg in average (tolerance: 2.6˜81 kg); cargo transfer bag 80, 79 kg in average (tolerance: 4.8˜90 kg); and cargo transfer bag 90, 108.7 kg in average (tolerance: 3.1˜136 kg).

As described above, cargo transfer bags 40, 50, 60 and 70 have the same width and different heights, depths and weights. Cargo transfer bags 80 and 90 have the same width and depth and different heights. Here, cargo transfer bags 80 and 90 are intended to contain cargo transfer bags 40, 50, 60 and 70, and cargo transfer bags 80 and 90 will be referred to as “M02 bag” and “M01 bag”, respectively.

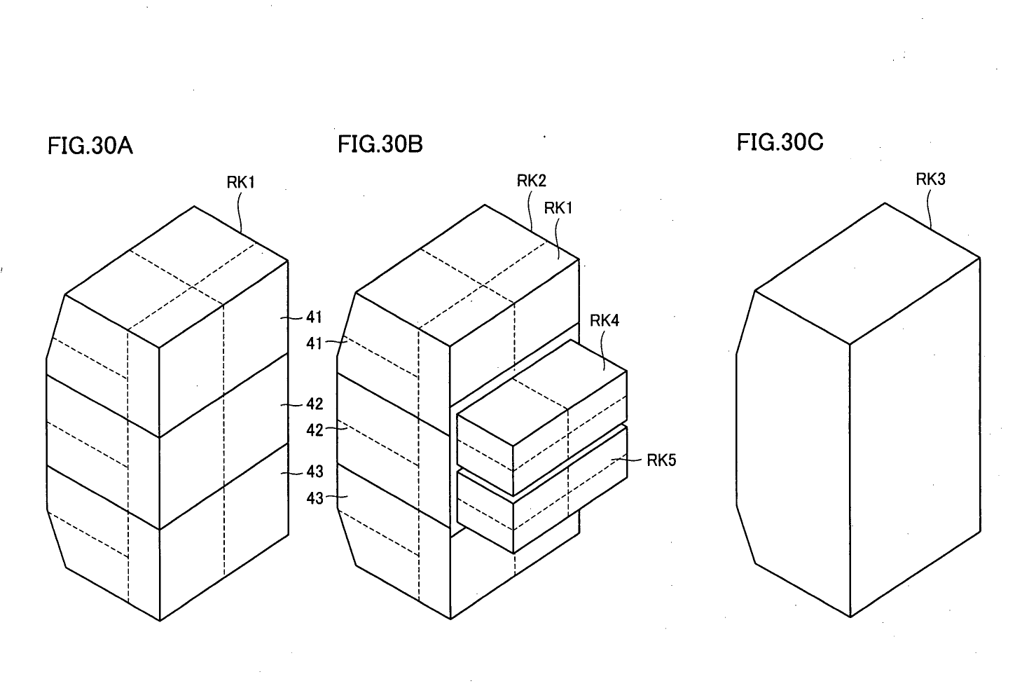

FIGS. 30A to 30C are perspective views showing racks constituting cargo compartments 31 to 34. The rack forming cargo compartments 31 to 34 includes cargo racks RK1, RK2 and a pack rack RK3. Cargo rack RK1 is partitioned into three areas 41 to 43. In each of the areas 41 to 43, six cargo transfer bags 50 shown in FIG. 29B can be loaded (see FIG. 30A).

Cargo rack RK2 includes cargo rack RK1 and cargo racks RK4, RK5. In other words, cargo rack RK2 has cargo racks RK4 and RK5 arranged in front of cargo rack RK1. Each of the cargo racks RK4 and RK5 is capable of containing cargo transfer bags 40, 50, 60, 70 and 80 shown in FIGS. 29A to 29E, respectively. When-combined, cargo racks RK4 and RK5 can contain cargo transfer bag 90 shown in FIG. 29F (see FIG. 30B). Pack rack RK3 is one pack by itself, and it cannot contain any of cargo transfer bags 40, 50, 60, 70, 80 and 90 shown in FIGS. 29A to 29F, respectively. Further, different from cargo rack RK2, it is impossible to arrange cargo racks RK4 and RK5 in front of pack rack RK3 (see FIG. 30C).

Cargo rack RK1 is capable of containing cargo transfer bags 40, 50, 60, 70 and 80. Cargo rack RK2 is capable of containing cargo transfer bags 40, 50, 60, 70 and 80 in rack RK1, capable of containing cargo transfer bags 40, 50, 60, 70 and 80 in racks RK4 and RK5, and is capable of containing cargo transfer bag 90 in racks RK4 and RK5 combined. Therefore, cargo transfer bag 90 is not placed in cargo rack RK1. Further, cargo transfer bags 40, 50, 60, 70 and 80 are carried into and out from cargo rack RK1 of cargo rack RK2, with cargo racks RK4 and RK5 removed.

Each of cargo transfer compartments 31 to 34 consists of any one of cargo racks RK1, RK2 and pack rack RK3. Therefore, there is 81 combinations of cargo racks RK1, RK2 and pack rack RK3 that form cargo compartments 31 to 34, per one bay section.

The program in accordance with the fourth embodiment determines a suitable arrangement of cargo transfer bags 40, 50, 60, 70, 80 and 90 such that deviation between the center of gravity of transport 10A when six different types of cargo transfer bags 40, 50, 60, 70, 80 and 90 having different sizes and weights are loaded to cargo bay 11 from the optimal center of gravity is at most 25 mm, with each of the cargo compartments 31 to 34 being formed of any of cargo racks RK1, RK2 and pack rack RK3.

In the following, the program for determining arrangement of cargo transfer bags 40, 50, 60, 70, 80 and 90, when cargo transfer bags 40, 50, 60, 70, 80 and 90 are loaded to four cargo compartments 31 to 34 while maintaining the deviation in the center of gravity of transport 10A within 25 mm will be described.

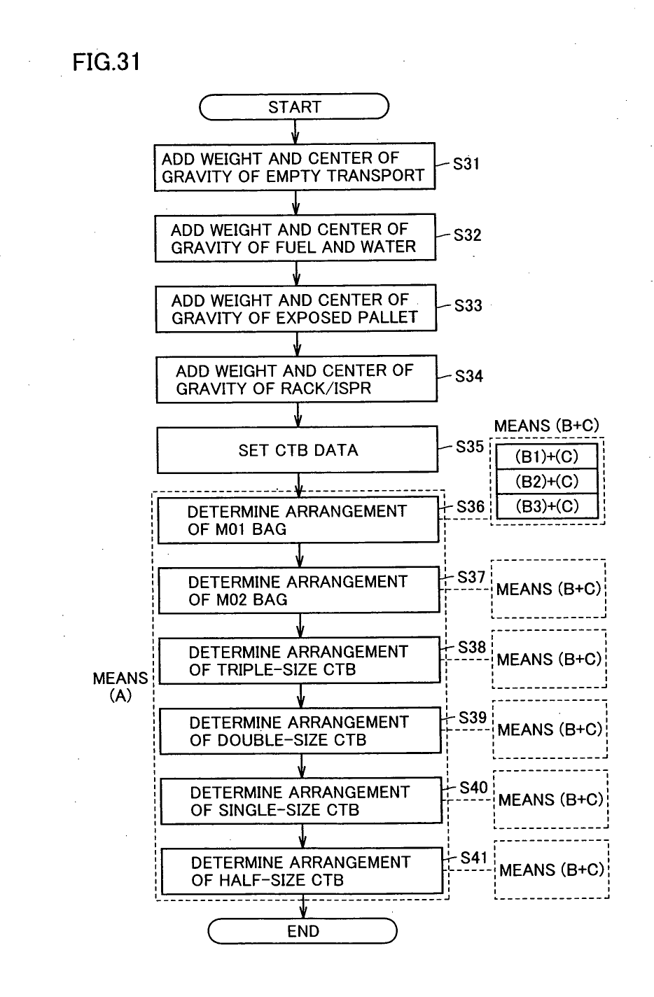

FIG. 31 is a flow chart of the program in accordance with the fourth embodiment. Description will be given assuming that before the start of the flow chart shown in FIG. 31, the combination of cargo racks RK1, RK2 and pack rack RK3 that form cargo compartments 31 to 34 has been determined.

When an operation of determining arrangement of cargo transfer bags 40, 50, 60, 70, 80 and 90 starts, weight of empty transport 10A is input, and the center of gravity of transport 10A is calculated (step S31). Thereafter, weights of fuel and water to be loaded to thrust portion 12A are input, and the center of gravity of transport 10A, fuel and water is calculated (step S32). Further, weight of exposed pallets is input, and center of gravity of transport 10A, fuel, water and exposed pallets is calculated (step S33). Further, weights of cargo racks (combination of cargo racks RK1, RK2 and pack rack RK3) forming cargo compartments 31 to 34 are input, and the center of gravity of transport 10A, fuel, water, exposed pallets and cargo racks is calculated (step S34).

In this manner, in steps S31 to S34, the initial center of gravity of transport 10A before cargo transfer bags 40, 50, 60, 70, 80 and 90 are loaded to transport 10A is calculated. Using the calculated initial center of gravity, arrangement of cargo transfer bags 40, 50, 60, 70, 80 and 90 is determined such that deviation of the center of gravity of transport 10A with cargo transfer bags 40, 50, 60, 70, 80 and 90 loaded in cargo compartments 31 to 34 from the optimal center of gravity is at most 25 mm.

When the initial center of gravity of transport 10A is calculated, the types of cargo transfer bags (CTBs and M01, M02) to be loaded to cargo compartments 31 to 34 are input (step S35). Specifically, the size and weight of six different types of cargo transfer bags 40, 50, 60, 70, 80 and 90 are input as the types of the cargo transfer bags.

Among the input types of cargo transfer bags, arrangement of the cargo transfer bags 90 (M01 bags) having the largest size is determined (step S36). Thereafter, arrangement of the cargo transfer bags 80 (M02 bags) having the second largest size is determined (step S37). Further, arrangement of the triple-size cargo transfer bags 70 having the third largest size is determined (step S38), followed by the arrangements of double-size cargo transfer bags 60, single-size cargo transfer bags 50 and half-size cargo transfer bags 40 (steps S39 to S41). Then, the operation of determining the arrangement of cargo transfer bags 40, 50, 60, 70, 80 and 90 in cargo compartments 31 to 34 ends.

As described above, in the operation of determining the arrangement of cargo transfer bags, the arrangement in cargo compartments 31 to 34 is determined starting from the bags having larger sizes, from the same reason as described with respect to the first embodiment.

In step S36, the operation of determining the arrangement of cargo transfer bags 90 (M01 bags) is executed by means B and C that will be described later. Specifically, means B+C may be means B1+C, B2+C and B3+C. In steps S37 to S41, the operations of determining the arrangement of cargo transfer bags 80 (M02 bags), triple-size cargo transfer bags 70, double-size cargo transfer bags 60, single-size cargo transfer bags 50 and half-size cargo transfer bags 40 are also executed by the same means B+C as in the operation of determining arrangement of cargo transfer bags 90 (M01 bags).

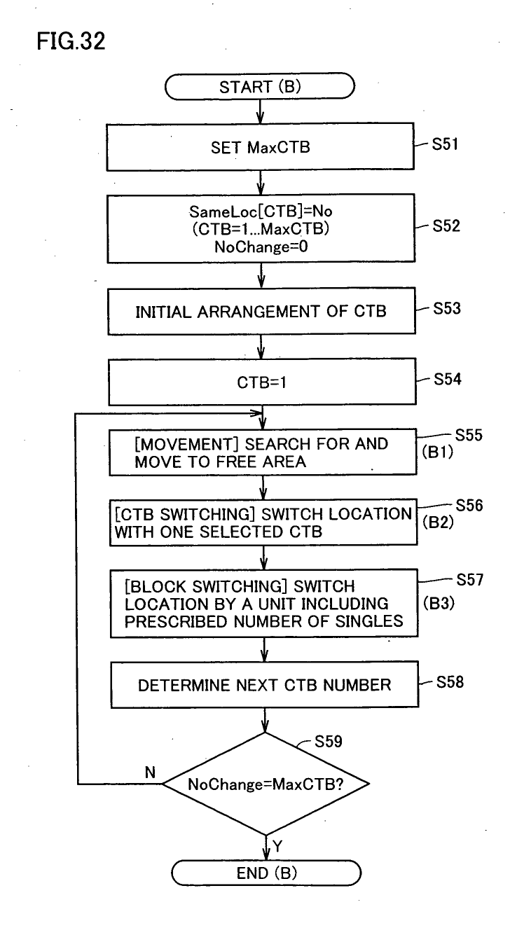

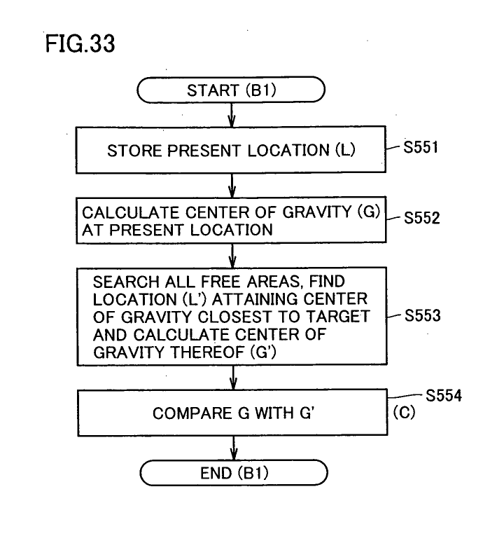

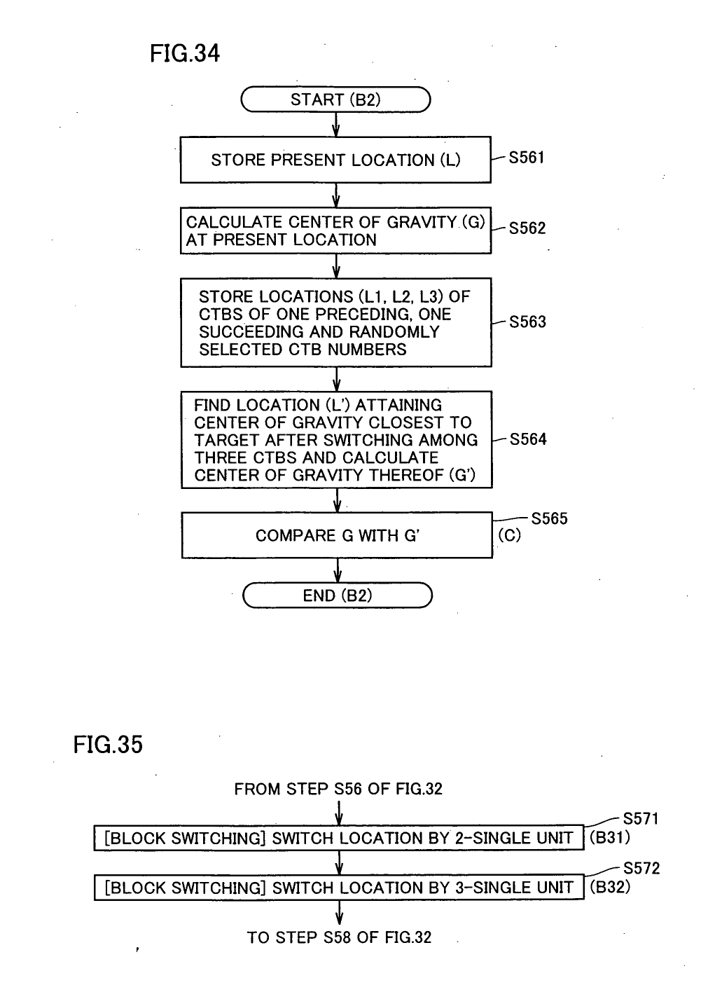

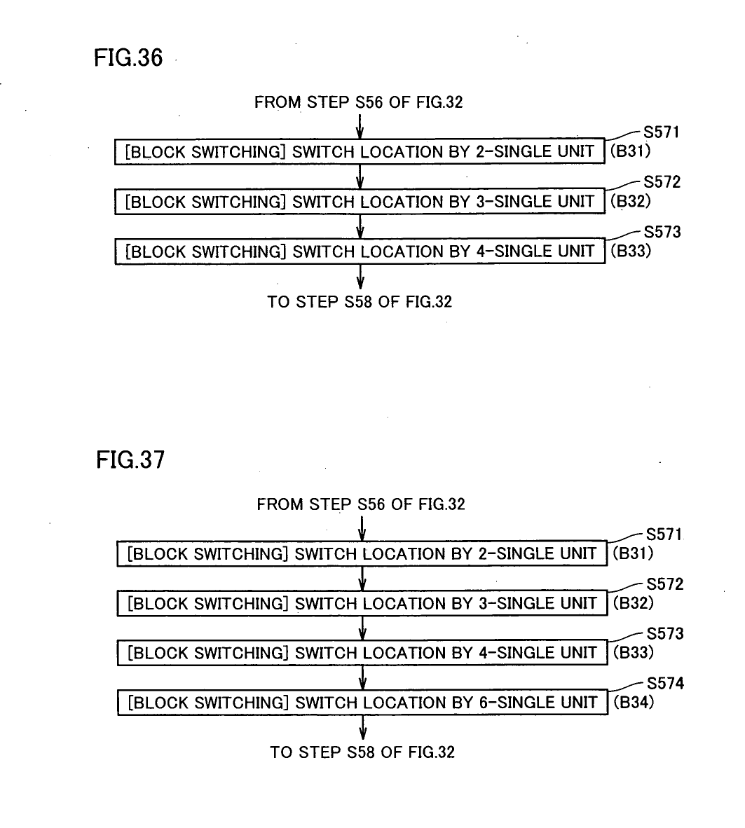

FIG. 32 is a flow chart representing the operation performed by the means B shown in FIG. 31. In the following, the operation of the means B will be described with reference to cargo transfer bags 90 (M01 bags) as an example. When the operation of the means B starts, the total number MaxCTB of cargo transfer bags 90 (M01 bags) is input (step S51). For all cargo transfer bags 90 (having the number from 1 to MaxCTB) as the objects of determining the arrangement, the same location flag SameLoc [CTB] is set to “No”, and the number NoChange of cargo transfer bags 90 of which location is not moved/switched is set to “0” (step S52).

The same location flag SameLoc [CTB] being set to “No” means that the location of the cargo transfer bag 90 as the object of determining arrangement is not at the same location as before (namely, it means that the bag has been moved), and the same location flag SameLoc [CTB] being set to “Yes” means that the location of the cargo transfer bag 90 as the object of determining arrangement is the same as before (namely, it means that the bag has not been moved). In step S52, the same location flag SameLoc [CTB] is set to “No” for every cargo transfer bag 90, to assume that, at the start of the operation of determining the arrangement, locations of cargo transfer bags 90 as the objects have been moved from previous locations, namely the cargo transfer bags 90 are in movable states. Further, the number bags of which location is not moved/switched is set to “0”, because locations of all the cargo transfer bags 90 are to be moved/switched to determine the arrangement of cargo transfer bags 90, at the start of the operation of determining the arrangement.

After step S52, cargo transfer bags 90 of which total number is MaxCTB are arranged at random, and initial arrangement of cargo transfer bags 90 is attained (step S53). Then, the number CTB of cargo transfer bag 90 is set to the initial value “1” (step S54), the location of cargo transfer bag having the number CTB of “1” is moved to a free location (area), and the center of gravity at each free area after movement is calculated (step S55). Here, cargo transfer bag 90 having the number CTB of “1” may be moved not only to a neighboring free area but also to any free area.

Thereafter, cargo transfer bag 90 having the number CTB of “1” is switched at random with a cargo transfer bag 90 of different number CTB, and the center of gravity at the switched location is calculated (step S56).

Then, location is switched block by block with each block including a prescribed number of single-size cargo transfer bags 50, and the center of gravity at the switched location is calculated (step S57). Details of block switching in step S57 will be described later. The number of single-size cargo transfer bags constituting the block is determined by the type of cargo transfer bags as the object of block switching.

When step S57 ends, through the movement of location of cargo transfer bag 90 in step S55, switching of location of cargo transfer bag 90 in step S56, and block switching in step S57, cargo transfer bag 90 having the number CTB “1” is moved/switched to the location where the deviation in the center of gravity is the smallest. Specifically, in steps S55 to S57, a location, where the deviation of the center of gravity is the smallest when the cargo transfer bag 90 having the number CTB “1” is changed by movement or switching, is determined, and the cargo transfer bag 90 having the number CTB “1” is moved/switched to the thus determined location.

Then, the next number CTB of the cargo transfer bag 90 of which location is to be changed by movement and switching is determined in accordance with equation (1) (step S58).

Next, when the number of cargo transfer bag 90 of which location is to be moved or switched is determined, whether the number NoChange of bags of which location is not moved/switched is equal to the total number MaxCTB of cargo transfer bags 90 set in step S51 or not is determined (step S59). When the number NoChange of bags of which location is not moved/switched is not equal to the total number MaxCTB of cargo transfer bags 90, steps S55 to S59 are repeated until the number NoChange of bags of which location is not moved/switched reaches the total number MaxCTB of cargo transfer bags 90. In other words, steps S55 to S59 are repeated until the location at which the deviation in the center of gravity is the smallest is determined for each of cargo transfer bags 90 having the number: 1, . . . , MaxCTB and cargo transfer bags 90 of respective numbers CTB are moved/switched to the determined locations.

When the number NoChange of bags of which location is not moved/switched becomes equal to the total number MaxCTB of cargo transfer bags 90, a cargo transfer bag 90 of which location is to be changed by movement or switching no longer exists, and therefore, the operation of determining the arrangement is terminated.

It is noted that the flow chart shown in FIG. 32 is also executed in determining the arrangement of cargo transfer bags 80, 70, 60, 50 and 40 in steps S37 to S41 shown in FIG. 31.

In the foregoing, determination of the next number CTB in step S58 is described as proceeding successively from smaller CTB number to larger CTB number. In the present invention, the next number CTB may be determined by other methods.

Specifically, the next number CTB may be determined successively from larger CTB number to smaller CTB number. Alternatively, the next CTB number may be determined successively first among even numbers followed by odd numbers, or determined successively first among odd numbers followed by even numbers. Alternatively, the next CTB number may be determined at random.

Further, it is not necessary to execute all of steps S55, S56 and S57. What is necessary is execution of at least one of steps S55, S56 and S57.

FIG. 33 is a flow chart representing the details of operation in step S55 of the flow chart shown in FIG. 32. After the step S54 of the flow chart shown in FIG. 32, the present location L of cargo transfer bag 90 having the number CTB “1” is stored (step S551). Thereafter, the center of gravity G at the present location L is calculated (step S552).

Thereafter, cargo transfer bag 90 having the number CTB “1” is moved to all free locations to search for a location L′ where the center of gravity comes closest to the target value, and the searched out location L′ is stored and center of gravity G′ at that location L′ is calculated (step S553). Specifically, the object cargo transfer bag 90 is moved to a free area, the location L1 of the free area is stored, and the center of gravity G1 at the location L1 is calculated. Then, the object cargo transfer bag 90 is moved to another free area L2, the location L2 of the free area is stored, and the center of gravity G2 at the location L2 is calculated. This operation is repeated for all free areas Ln, and the center of gravity Gn at the location Ln is calculated.

Thereafter, among the calculated centers of gravity G1 to Gn, the center of gravity G′ closest to the target is selected, the location L′ at which the center of gravity G′ is calculated is detected among locations L1 to Ln, and the location L′ and the center of gravity G′ are stored.

In step S553, the object cargo transfer bag 90 may not be moved to all the free areas. When the cargo transfer bag 90 is moved to one free area the center of gravity becomes closer to the target as a result, the location of the one free area may be stored and the center of gravity at that location may be calculated.

After step S553, the center of gravity G′ is compared with the center of gravity G, and when the center of gravity G′ is closer to the target than the center of gravity G, the object cargo transfer bag 90 is moved to the location L′, and when the center of gravity G′ is farther from the target than the center of gravity G, the object cargo transfer bag 90 is returned to the original location L (step S554). Thus, specific operations of step S55 shown in FIG. 32 end.

FIG. 34 is a flow chart representing details of the operation of step S56 of the flow chart shown in FIG. 32. After step S55 of the flow chart shown in FIG. 32, the present location L of the cargo transfer bag 90 having the number CTB “1” is stored (step S561). Then, the center of gravity G at the present location L is calculated (step S562). Then, as the location of a cargo transfer bag having a different number CTB to be switched with the object cargo transfer bag 90, the location L1 of a cargo transfer bag 90 having the number CTB preceding by one the number of the object cargo transfer bag 90, the location L2 of a cargo transfer bag 90 having the number CTB succeeding by one the number of the object cargo transfer bag 90, and the location L3 of a cargo transfer bag 90 having the number CTB selected at random are selected, and the selected locations L1, L2 and L3 are stored (step S563).

Thereafter, among the three locations L1, L2 and L3, the location L′ where the center of gravity after switching comes closest to the target is stored, and the center of gravity G′ at that location L′ is calculated (step S564). After step S564, the center of gravity G′ is compared with the center of gravity G, and when the center of gravity G′ is closer to the target than the center of gravity G, then the object cargo transfer bag 90 is switched with the object at the location L′, and when the center of gravity G′ is farther from the target than the center of gravity G, the object cargo transfer bag 90 is returned to the original location L (step S565). Thus, the specific operations of step S56 shown in FIG. 32 end.

FIG. 35 is a flow chart representing the operation of block switching in step S57 of the flow chart shown in FIG. 32. FIG. 36 is another flow chart representing the operation of block switching in step S57 of the flow chart shown in FIG. 32. FIG. 37 is a still another flow chart representing the operation of block switching in step S57 of the flow chart shown in FIG. 32.

First, the flow chart shown in FIG. 35 will be described. After step S56 of the flow char shown in FIG. 32, location switching is performed block by block, with each block corresponding to two single-size cargo transfer bags 50 (2-single unit) (step S571). Then, location switching is performed block by block, with each block corresponding to three single-size cargo transfer bags 50 (3-single unit) (step S572). Thereafter, step S58 of the flow chart shown in FIG. 32 is performed.

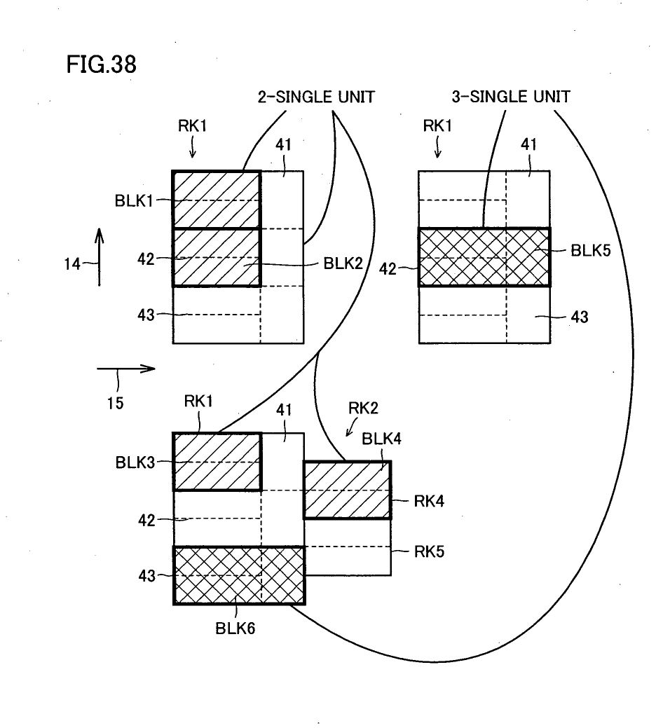

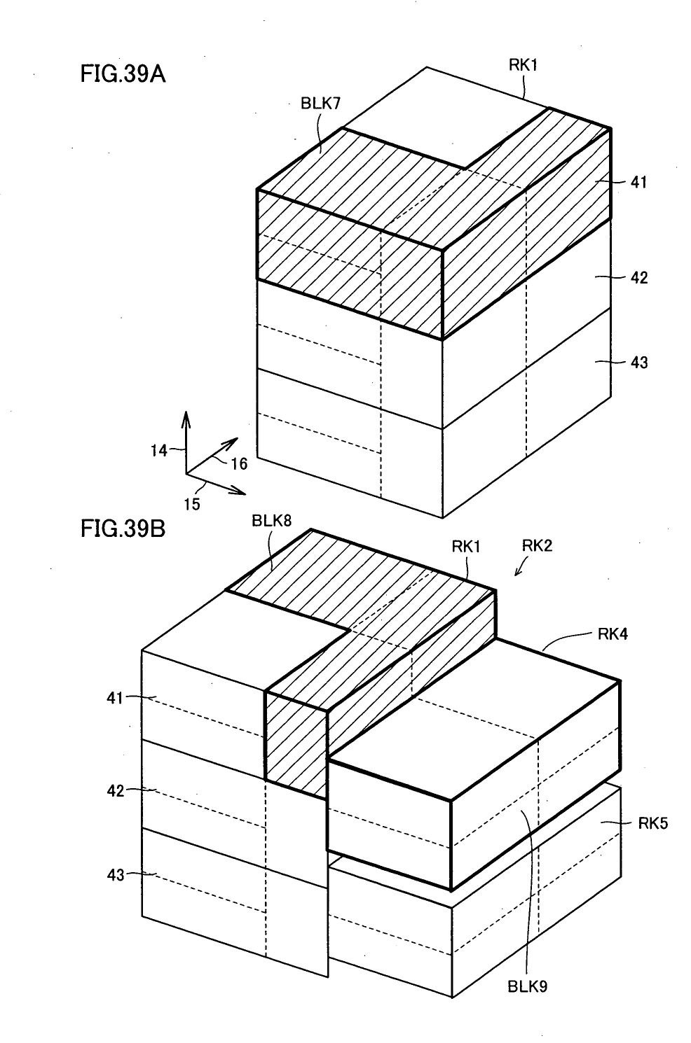

FIG. 38 is an illustration representing the concept of block switching in steps S571 and S572 of the flow chart shown in FIG. 35.

Step S57 of the flow chart shown in FIG. 32 is performed in steps S36 to S41 of the flow chart shown in FIG. 31. Specifically, step 57 of the flow chart shown in FIG. 32 is performed in determining the arrangement of cargo transfer bags 90 (M01 bags), the arrangement of cargo transfer bags 80 (M02 bags), the arrangement of triple-size cargo transfer bags 70, the arrangement of double-size cargo transfer bags 60, the arrangement of single-size cargo transfer bags 50 and the arrangement of half-size cargo transfer bags 40.

As cargo transfer bags 90 and 80 are capable of containing six single-size cargo transfer bags 50 and four single-size cargo transfer bags 50, respectively, block-by-block switching with each block corresponding to two single-size cargo transfer bags 50 or block-by-block switching with each block corresponding to three single-size cargo transfer bags 50 is also possible.

Therefore, in step S571 of the flow chart shown in FIG. 35, location switching takes place among block BLK1 arranged in the area 41 of cargo rack RK1, block BLK2 arranged in the area 42 of cargo rack RK1, block BLK3 arranged in the area 41 of cargo rack RK2 and block BLK4 arranged in cargo rack RK4, as shown in FIG. 38.

Further, in step S572 of the flow chart shown in FIG. 35, location switching takes place between block BLK5 arranged in the area 42 of cargo rack RK1 and block BLK6 arranged in the area 43 of cargo rack RK2.

Here, areas 41 to 43 are partitioned from each other along the direction of the arrow 14, and therefore, blocks BLK1 to BLK4 are formed of half-size, single-size and double-size cargo transfer bags 40, 50 and 60 arranged along the direction of the arrow 15 orthogonal to the direction of the arrow 14, and not of the cargo transfer bags 40, 50 and 60 arranged in the direction of the arrow 14. Further, blocks BLK5 and BLK6 are formed of half-size, single-size, double-size and triple-size cargo transfer bags 40, 50, 60 and 70 arranged along the direction of the arrow 15 orthogonal to the direction of the arrow 14, and not of the cargo transfer bags 40, 50, 60 and 70 arranged in the direction of the arrow 14.

Cargo transfer bags 40, 50, 60 and 70 are also arranged on the deep side of the sheet of FIG. 38, and therefore, in block switching of step S571 and S572, blocks BLK1 to BLK4 may be switched with a 2-single unit block positioned on the deeper side of the sheet, and blocks BLK5 and BLK6 may be switched with a 3-single unit block positioned on the deeper side of the sheet.

It is noted that at least one of steps S571 and 572 shown in FIG. 35 has to be performed.

The flow chart shown in FIG. 36 will be described. After step S56 of the flow chart shown in FIG. 32, steps S571 and S572 described above are performed. Then, block-by-block location switching with the block corresponding to four single-size cargo transfer bags 50 (4-single unit) is performed (step S573). Thereafter, step S58 of the flow chart shown in FIG. 32 is executed.

FIGS. 39A and 39B are illustrations showing the concept of block switching in step S573 of the flow chart shown in FIG. 36.

As cargo transfer bags 90 and 80 are capable of containing six single-size cargo transfer bags 50 and four single-size cargo transfer bags 50, respectively, block-by-block switching with each block corresponding to four single-size cargo transfer bags 50 is also possible.

Therefore, in step S573 of the flow chart shown in FIG. 36, location switching takes place among block BLK7 arranged in the area 41 of cargo rack RK1 shown in FIG. 39A, block BLK8 arranged in the area 41 of cargo rack RK2 shown in FIG. 39B and block BLK9 arranged in cargo rack RK4.

Here, areas 41 to 43 are partitioned from each other along the direction of the arrow 14, and therefore, in the block switching of 4-single unit also, blocks BLK7 to BLK9 are formed of half-size, single-size, double-size and triple-size cargo transfer bags 40, 50, 60 and 70 and cargo transfer bags 80 (M02 bags) arranged along the direction of the arrows 15 and 16 orthogonal to the direction of the arrow 14, and not of the cargo transfer bags 40, 50, 60, 70 and 80 arranged in the direction of the arrow 14.

It is noted that at least one of steps S571, S572 and S573 has to be executed.

Finally, the flow chart shown in FIG. 37 will be described. After step S56 of the flow chart shown in FIG. 32, steps S571 to 573 described above are executed. Then, block-by-block location switching with the block corresponding to six single-size cargo transfer bags 50 (6-single unit) is performed (step S574). Thereafter, step S58 of the flow chart shown in FIG. 32 is executed.

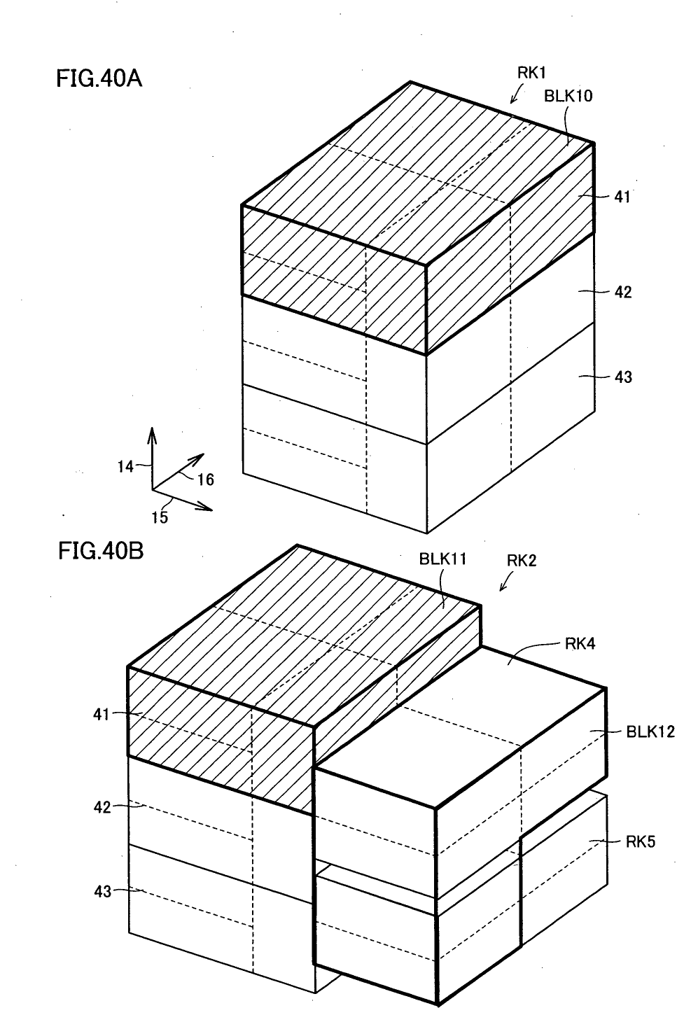

FIGS. 40A and 40B are schematic illustrations showing the concept of block switching in step S574 of the flow chart shown in FIG. 37.

As cargo transfer bags 90 and 80 are capable of containing six single-size cargo transfer bags 50 and four single-size cargo transfer bags 50, respectively, block-by-block switching with each block corresponding to six single-size cargo transfer bags 50 is also possible. A cargo transfer bag 80 forms a block of 6-single unit by any combination of four half-size cargo transfer bags 40, two single-size cargo transfer bags 50 and one double-size cargo transfer bag 60.

In step S574 of the flow chart shown in FIG. 37, location switching takes place among block BLK10 arranged in the area 41 of cargo rack RK1 shown in FIG. 40A, block BLK11 arranged in the area 41 of cargo rack RK2 shown in FIG. 40B, and block BLK12 arranged in cargo rack RK4.

Here, areas 41 to 43 are partitioned from each other along the direction of the arrow 14, and therefore, in the block switching of 6-single unit also, blocks BLK10 to BLK12 are formed of half-size, single-size, double-size and triple-size cargo transfer bags 40, 50, 60 and 70 and cargo transfer bags 80 (M02 bags) and 90 (M01 bags) arranged along the direction of the arrows 15 and 16 orthogonal to the direction of the arrow 14, and not of the cargo transfer bags 40, 50, 60, 70, 80 and 90 arranged in the direction of the arrow 14.

It is noted that at least one of steps S571, S572, S573 and S574 shown in FIG. 37 has to be performed.

[2-Single Unit and 3-Single Unit Block Switching]

When the flow chart shown in FIG. 35 is selected as-step S57 of the flow chart shown in FIG. 32, step S571 shown in FIG. 35 is performed in steps S36, S37, S38, S39 to S41 shown in FIG. 31, and step S572 shown in FIG. 35 is performed in steps S36 to S41 shown in FIG. 31. Specifically, step S571 (block switching of 2-single unit) shown in FIG. 35 is not performed in step S38 shown in FIG. 31. The reason is that a triple-size cargo transfer bag 70 cannot form a block of 2-single unit by itself.

In step S36 shown in FIG. 31, only the cargo transfer bags 90 (M01 bags) are arranged in cargo compartments 31 to 34. It is noted, however, that a cargo transfer bag 90 is large enough to contain six single-size cargo transfer bags 50. Therefore, block switching is performed between a block of 2-single unit or 3-single unit formed of some of the plurality of cargo transfer bags 40, 50, 60 and 70 contained in one cargo transfer bag 90 (formed of an arbitrary combination of cargo transfer bags 40, 50, 60 and 70 arranged in an area large enough to arrange six cargo transfer bags 50) and a block of 2-single unit or 3-single unit formed of some of the plurality of cargo transfer bags 40, 50, 60 and 70 contained in another cargo transfer bag 90 (formed of an arbitrary combination of cargo transfer bags 40, 50, 60 and 70 arranged in an area large enough to arrange six cargo transfer bags 50).

In step S37 shown in FIG. 31, cargo transfer bags 90 (M01 bags) and 80 (M02 bags) are arranged in cargo compartments 31 to 34. As cargo transfer bags 90 and 80 are capable of containing six single-size cargo transfer bags and four single-size cargo transfer bags, respectively, the following three types of block switching can be performed.

The first block switching is between a block of 2-single unit or 3-single unit formed of some of the plurality of cargo transfer bags 40, 50, 60 and 70 contained in one cargo transfer bag 90 (formed of an arbitrary combination of cargo transfer bags 40, 50, 60 and 70 arranged in an area large enough to arrange six cargo transfer bags 50) and a block of 2-single unit or 3-single unit formed of some of the plurality of cargo transfer bags 40, 50, 60 and 70 contained in another cargo transfer bag 90 (formed of an arbitrary combination of cargo transfer bags 40, 50, 60 and 70 arranged in an area large enough to arrange six cargo transfer bags 50). The second type block switching is between a block of 2-single unit or 3-single unit formed of some of the plurality of cargo transfer bags 40, 50 and 60 contained in one cargo transfer bag 80 (formed of an arbitrary combination of cargo transfer bags 40, 50 and 60 arranged in an area large enough to arrange four cargo transfer bags 50) and a block of 2-single unit or 3-single unit formed of some of the plurality of cargo transfer bags 40, 50 and 60 contained in another cargo transfer bag 80 (formed of an arbitrary combination of cargo transfer bags 40, 50 and 60 arranged in an area large enough to arrange four cargo transfer bags 50). The third block switching is between a block of 2-single unit or 3-single unit formed of some of the plurality of cargo transfer bags 40, 50, 60 and 70 contained in one cargo transfer bag 90 (formed of an arbitrary combination of cargo transfer bags 40, 50, 60 and 70 arranged in an area large enough to arrange six cargo transfer bags 50) and a block of 2-single unit or 3-single unit formed of some of the plurality of cargo transfer bags 40, 50 and 60 contained in a cargo transfer bag 80 (formed of an arbitrary combination of cargo transfer bags 40, 50 and 60 arranged in an area large enough to arrange four cargo transfer bags 50).

In step S38 shown in FIG. 31, cargo transfer bags 90 (M01 bags) and 80 (M02 bags) and triple-size cargo transfer bags 70 are arranged in cargo compartment 31 to 34. Block switching of 3-single unit is performed in this state. Further, as the cargo transfer bags 90 and 80 are objects of 3-single unit block switching, in the 3-single unit block switching executed in step S38 shown in FIG. 31, 3-single unit block switching is possible among cargo transfer bags 70 arranged in cargo racks RK1, RK2, cargo transfer bags 40, 50 and 60 contained in cargo transfer bags 80 arranged in cargo racks RK1, RK2, cargo transfer bags 40, 50 and 60 contained in cargo transfer bags 80, 90 arranged in cargo racks RK4, RK5, and cargo transfer bags 70 contained in cargo transfer bags 90 arranged in cargo racks RK4 and RK5. When cargo transfer bags 80 and 90 are already arranged, 2-single unit block switching is performed in step S38.

Further, in step S39 shown in FIG. 31, cargo transfer bags 90 (M01 bags) and 80 (M02 bags), triple-size cargo transfer bags 70 and double-size cargo transfer bags 60 are arranged in cargo compartments 31 to 34. In this state, 2-single unit and 3-single unit block switching operations are performed. Further, as the cargo transfer bags 90 and 80 are objects of 3-single unit block switching and 2-single unit block switching as described above, in the 3-single unit block switching and 2-single unit block switching executed in step S39 shown in FIG. 31, 2-single unit block switching is possible among cargo transfer bags 60 arranged in cargo racks RK1, RK2, cargo transfer bags 40, 50 and 60 contained in cargo transfer bags 80 arranged in cargo racks RK1, RK2, and cargo transfer bags 40, 50 and 60 contained in cargo transfer bags 80, 90 arranged in cargo racks RK4 and RK5, and 3-single unit block switching is possible among cargo transfer bags 60 and 70 arranged in cargo racks RK1, RK2, cargo transfer bags 40, 50 and 60 contained in cargo transfer bags 80 arranged in cargo racks RK1, RK2, cargo transfer bags 40, 50 and 60 contained in cargo transfer bags 80 and 90 arranged in cargo racks RK4, RK5, and cargo transfer bags 70 contained in cargo transfer bags 90 arranged in cargo racks RK4 and RK5.

In step S40 shown in FIG. 31, cargo transfer bags 90 (M01 bags) and 80 (M02 bags), triple-size cargo transfer bags 70, double-size cargo transfer bags 60 and single-size cargo transfer bags 50 are arranged in cargo compartments 31 to 34. In this state, 2-single unit and 3-single unit block switching operations are performed. Further, as the cargo transfer bags 90 and 80 are objects of 2-single unit block switching and 3-single unit block switching as described above, in the 3-single unit block switching and 2-single unit block switching executed in step S40 shown in FIG. 31, 2-single unit block switching is possible among cargo transfer bags 50, 60 arranged in cargo racks RK1, RK2, cargo transfer bags 40, 50 and 60 contained in cargo transfer bags 80 arranged in cargo racks RK1, RK2, and cargo transfer bags 40, 50 and 60 contained in cargo transfer bags 80, 90 arranged in cargo racks RK4 and RK5, and 3-single unit block switching is possible among cargo transfer bags 50, 60 and 70 arranged in cargo racks RK1, RK2, cargo transfer bags 40, 50 and 60 contained in cargo transfer bags 80 arranged in cargo racks RK1, RK2, cargo transfer bags 40, 50 and 60 contained in cargo transfer bags 80 and 90 arranged in cargo racks RK4, RK5, and cargo transfer bags 70 contained in cargo transfer bags 90 arranged in cargo racks RK4 and RK5.

Further, in step S41 shown in FIG. 31, cargo transfer bags 90 (M01 bags) and 80 (M02 bags), triple-size cargo transfer bags 70, double-size cargo transfer bags 60, single-size cargo transfer bags 50 and half-size cargo transfer bags 40 are arranged in cargo compartments 31 to 34. In this state, 2-single unit and 3-single unit block switching operations are performed. Further, as the cargo transfer bags 90 and 80 are objects of 2-single unit block switching and 3-single unit block switching as described above, in the 2-single unit block switching and 3-single unit block switching executed in step S41 shown in FIG. 31, 2-single unit block switching is possible among cargo transfer bags 40, 50, 60 arranged in cargo racks RK1, RK2, cargo transfer bags 40, 50 and 60 contained in cargo transfer bags 80 arranged in cargo racks RK1, RK2, and cargo transfer bags 40, 50 and 60 contained in cargo transfer bags 80, 90 arranged in cargo racks RK4 and RK5, and 3-single unit block switching is possible among cargo transfer bags 40, 50, 60, and 70 arranged in cargo racks RK1, RK2, cargo transfer bags 40, 50 and 60 contained in cargo transfer bags 80 arranged in cargo racks RK1, RK2, cargo transfer bags 40, 50 and 60 contained in cargo transfer bags 80 and 90 arranged in cargo racks RK4, RK5, and cargo transfer bags 70 contained in cargo transfer bags 90 arranged in cargo racks RK4 and RK5.

Further, 2-single unit block switching for cargo transfer bags 40, 50, 60, 80 and 90 involves location switching between cargo transfer bags of the same type and/or location switching between cargo transfer bags of different types.

As four cargo transfer bags 40 constitute a 2-single unit block, 2-single unit location switching corresponds to location switching between either four cargo transfer bags 40 or a combination of two cargo transfer bags 40 and one cargo transfer bag 50 and any of one double-size cargo transfer bag 60, two single-size cargo transfer bags 50, a combination of two cargo transfer bags 40 and one cargo transfer bag 50 and four half-size cargo transfer bags 40. Therefore, 2-single unit block switching of cargo transfer bags 40 corresponds to location switching between cargo transfer bags of the same type and location switching between cargo transfer bags of different types.

Further, as two cargo transfer bags 50 constitute a 2-single unit block, 2-single unit location switching corresponds to location switching between either two cargo transfer bags 50 or a combination of two cargo transfer bag 40 and one cargo transfer bag 50 and any of one double-size cargo transfer bag 60, two single-size cargo transfer bags 50, a combination of two cargo transfer bags 40 and one cargo transfer bag 50 and four half-size cargo transfer bags 40. Therefore, 2-single unit block switching of cargo transfer bags 50 corresponds to location switching between cargo transfer bags of the same type and location switching between cargo transfer bags of different types.

Further, as one cargo transfer bag 60 constitutes 2-single unit block, 2-single unit location switching corresponds to location switching between one cargo transfer bag 60 and any of one double size cargo transfer bag 60, two single-size cargo transfer bags 50, a combination of two cargo transfer bags 40 and one cargo transfer bag 50 and four half-size cargo transfer bags 40. Therefore, 2-single unit block switching of cargo transfer bag 60 corresponds to location switching between cargo transfer bags of the same type and location switching between cargo transfer bags of different types.

As cargo transfer bag 80 has such a size that can contain four single-size cargo transfer bags 50, it may contain various combinations of half-size, single-size, and double-size cargo transfer bags 40, 50 and 60. Therefore, 2-single unit block switching involves location switching of 2-single unit block formed of combinations of half-size, single-size and double-size cargo transfer bags 40, 50 and 60 contained in cargo transfer bag 80. Therefore, 2-single unit block switching of cargo transfer bag 80 corresponds to location switching between cargo transfer bags of different types.

Further, as cargo transfer bag 90 has such a size that can contain six single-size cargo transfer bags 50, it may contain various combinations of half-size, single-size, double-size and triple size cargo transfer bags 40, 50, 60 and 70. Therefore, 2-single unit block switching involves location switching of 2-single unit block formed of combinations of half-size, single-size and double-size cargo transfer bags 40, 50 and 60 contained in cargo transfer bag 90. Therefore, 2-single unit block switching of cargo transfer bag 90 corresponds to location switching between cargo transfer bags of different types.

Further, a 3-single unit block switching for cargo transfer bags 40, 50, 60, 70, 80 and 90 involves location switching between cargo transfer bags of the same type and/or location switching between cargo transfer bags of different types.

Six cargo transfer bags 40 constitute a 3-single unit block, and therefore, 3-single unit location switching corresponds to location switching between any of [6×cargo transfer bag 40], [1×cargo transfer bag 50+1×cargo transfer bag 60] and [2×cargo transfer bag 40+1×cargo transfer bag 60] and any of [6×cargo transfer bag 40], [3×cargo transfer bag 50], [1×cargo transfer bag 70], [1×cargo transfer bag 50+1×cargo transfer bag 60], [2×cargo transfer bag 40+1×cargo transfer bag 60], [2×cargo transfer bag 50+2×cargo transfer bag 40] and [1×cargo transfer bag 50+4×cargo transfer bag 40].

Here, [6×cargo transfer bag 40] represents six half-size cargo transfer bags 40, and [3×cargo transfer bag 50] represents three single-size cargo transfer bags 50. Further, [1×cargo transfer bag 70] represents one triple-size cargo transfer bag 70, and [1×cargo transfer bag 50+1×cargo transfer bag 60] represents a combination of one single-size cargo transfer bag 50 and one double-size cargo transfer bag 60. Further, [2×cargo transfer bag 40+1×cargo transfer bag 60] represents a combination of two half-size cargo transfer bags 40 and one double size cargo transfer bag 60, and [2×cargo transfer bag 50+2×cargo transfer bag 40] represents a combination of two single-size cargo transfer bags 50 and two half-size cargo transfer bags 40. Further, [1×cargo transfer bag 50+4×cargo transfer bag 40] represents a combination of one single-size cargo transfer bag 50 and four half-size cargo transfer bags 40.

Therefore, a 3-single unit block switching for cargo transfer bag 40 corresponds to location switching between cargo transfer bags of the same type and location switching between cargo transfer bags of different types.

Three cargo transfer bags 50 constitute a 3-single unit block, and therefore, 3-single unit location switching corresponds to location switching between any of [3×cargo transfer bag 50],], [1×cargo transfer bag 50+1×cargo transfer bag 60], [2×cargo transfer bag 50+2×cargo transfer bag 40] and [1×cargo transfer bag 50+4×cargo transfer bag 40] and any of [6×cargo transfer bag 40], [3×cargo transfer bag 50], [1×cargo transfer bag 70], [1×cargo transfer bag 50+1×cargo transfer bag 60], [2×cargo transfer bag 40+1×cargo transfer bag 60], [2×cargo transfer bag 50+2×cargo transfer bag 40] and [1×cargo transfer bag 50+4×cargo transfer bag 40]. Therefore, a 3-single unit block switching for cargo transfer bag 50 corresponds to location switching between cargo transfer bags of the same type and location switching between cargo transfer bags of different types.

Further, a cargo transfer bag 60 constitutes a 3-single unit block by a combination with one single-size cargo transfer bag 50 or two half-size cargo transfer bags 40. Therefore, 3-single unit location switching corresponds to location switching between either [1×cargo transfer bag 60+1×cargo transfer bag 50] or [1×cargo transfer bag 60+2×cargo transfer bag 40] and any of [6×cargo transfer bag 40], [3×cargo transfer bag 50], [1×cargo transfer bag 70], [1×cargo transfer bag 50+1×cargo transfer bag 60], [2×cargo transfer bag 40+1×cargo transfer bag 60], [2×cargo transfer bag 50+2×cargo transfer bag 40] and [1×cargo transfer bag 50+4×cargo transfer bag 40].

It is noted that at each location switching, arrangement relation between cargo transfer bags 60 and 40 or between cargo transfer bags 60 and 50 may be the same or different before and after the location switching. Therefore, a 3-single unit block switching for cargo transfer bag 60 corresponds to location switching between cargo transfer bags of the same type and location switching between cargo transfer bags of different types.

One cargo transfer bag 70 constitutes a 3-single unit block, and therefore, 3-single unit location switching corresponds to location switching between one cargo transfer bag 70 and any of [6×cargo transfer bag 40], [3×cargo transfer bag 50], [1×cargo transfer bag 70], [1×cargo transfer bag 50+1×cargo transfer bag 60], [2×cargo transfer bag 40+1×cargo transfer bag 60], [2×cargo transfer bag 50+2×cargo transfer bag 40] and [1×cargo transfer bag 50+4×cargo transfer bag 40]. Therefore, a 3-single unit block switching for cargo transfer bag 70 corresponds to location switching between cargo transfer bags of the same type and location switching between cargo transfer bags of different types.

A cargo transfer bag 80 has such a size that can contain four single-size cargo transfer bags 50. Therefore, it may contain various combinations of half-size, single-size, and double-size cargo transfer bags 40, 50 and 60. Therefore, in a 3-single unit block switching, location of a 3-single unit formed by a combination of half-size, single-size, and double-size cargo transfer bags 40, 50 and 60 contained in cargo transfer bag 80 is switched. Therefore, a 3-single unit block switching for cargo transfer bag 80 corresponds to location switching between cargo transfer bags of different types.

A cargo transfer bag 90 has such a size that can contain six single-size cargo transfer bags 50. Therefore, it may contain various combinations of half-size, single-size, double-size and triple-size cargo transfer bags 40, 50, 60 and 70. Therefore, in a 3-single unit block switching, location of a 3-single unit formed by a combination of half-size, single-size, double-size and triple-size cargo transfer bags 40, 50, 60 and 70 contained in cargo transfer bag 90 is switched. Therefore, a 3-single unit block switching for cargo transfer bag 90 corresponds to location switching between cargo transfer bags of different types.

[Block Switching of 2-Single Unit, 3-Single Unit and 4-Single Unit]

When the flow chart shown in FIG. 36 is selected as step S56 of the flow chart shown in FIG. 32, step S561 shown in FIG. 36 is executed in steps S36, S37, S38 and S39 to S41, and steps S562 and S563 shown in FIG. 36 are executed in steps S36 to S41 shown in FIG. 31.

Block switching of 2-single unit and 3-single unit shown in steps S561 and S562 are as described above. Therefore, in the following, block switching of 4-single unit of step S563 shown in FIG. 36 will be described.

In step S36 shown in FIG. 31, only cargo transfer bags 90 (M01 bag) are arranged in cargo compartments 31 to 34. One cargo transfer bag 90 has such a size that can contain six single-size cargo transfer bags 50, and therefore, a 4-single unit block formed of some of the plurality of cargo transfer bags 40, 50, 60 and 70 contained in one cargo transfer bag 90 (arbitrary combination of cargo transfer bags 40, 50, 60 and 70 that can be arranged in an area large enough to arrange six cargo transfer bags 50) is switched with a 4-single unit block formed of some of the plurality of cargo transfer bags 40, 50, 60 and 70 contained in another cargo transfer bag 90 (arbitrary combination of cargo transfer bags 40, 50, 60 and 70 that can be arranged in an area large enough to arrange six cargo transfer bags 50).

Further, in step S37 shown in FIG. 31, cargo transfer bags 80 and 90 (M01 and M02 bags) are arranged in cargo compartments 31 to 34. Cargo transfer bags 90 and 80 are capable of containing six and four single size cargo transfer bags 50, respectively, and therefore, the following three different manners of 3-single unit block switching are possible.

The first block switching is between a 4-single unit block formed of some of the plurality of cargo transfer bags 40, 50, 60 and 70 contained in one cargo transfer bag 90 (arbitrary combination of cargo transfer bags 40, 50, 60 and 70 that can be arranged in an area large enough to arrange six cargo transfer bags 50) and a 4-single unit block formed of some of the plurality of cargo transfer bags 40, 50, 60 and 70 contained in another cargo transfer bag 90 (arbitrary combination of cargo transfer bags 40, 50, 60 and 70 that can be arranged in an area large enough to arrange six cargo transfer bags 50). The second block switching is between a 4-single unit block formed of some of the plurality of cargo transfer bags 40, 50 and 60 contained in one cargo transfer bag 80 (arbitrary combination of cargo transfer bags 40, 50 and 60 that can be arranged in an area large enough to arrange four cargo transfer bags 50) and a 4-single unit block formed of some of the plurality of cargo transfer bags 40, 50 and 60 contained in another cargo transfer bag 80 (arbitrary combination of cargo transfer bags 40, 50 and 60 that can be arranged in an area large enough to arrange four cargo transfer bags 50). The third block switching is between a 4-single unit block formed of some of the plurality of cargo transfer bags 40, 50, 60 and 70 contained in one cargo transfer bag 90 (arbitrary combination of cargo transfer bags 40, 50, 60 and 70 that can be arranged in an area large enough to arrange six cargo transfer bags 50) and a 4-single unit block formed of some of the plurality of cargo transfer bags 40, 50 and 60 contained in one cargo transfer bag 80 (arbitrary combination of cargo transfer bags 40, 50 and 60 that can be arranged in an area large enough to arrange four cargo transfer bags 50).

In step S38 shown in FIG. 31, cargo transfer bags 90 and 80 (M01 and M02 bags) and triple-size cargo transfer bags 70 are arranged in cargo compartments 31 to 34. In this state, a 4-single unit block switching takes place. As cargo transfer bags 90 and 80 are objects of block switching by 4-single unit as described above, in the 4-single unit block switching executed in step S38 shown in FIG. 31, 4-single unit block switching is possible among cargo transfer bags 70 arranged in cargo racks RK1, RK2, cargo transfer bags 40, 50 and 60 contained in cargo transfer bags 80 arranged in cargo racks RK1, RK2, cargo transfer bags 40, 50 and 60 contained in cargo transfer bags 80 and 90 arranged in cargo transfer racks RK4, RK5 and cargo transfer bags 70 contained in cargo transfer bags 90 arranged in cargo racks RK4, RK5.

Further, in step S39 shown in FIG. 31, cargo transfer bags 90 and 80 (M01 and M02 bags) and triple-size and double-size cargo transfer bags 70 and 60 are arranged in cargo compartments 31 to 34. In this state, a 4-single unit block switching takes place. As cargo transfer bags 90 and 80 are objects of block switching by 4-single unit as described above, in the 4-single unit block switching executed in step S39 shown in FIG. 31, 4-single unit block switching is possible among cargo transfer bags 60 and 70 arranged in cargo racks RK1, RK2, cargo transfer bags 40, 50 and 60 contained in cargo transfer bags 80 arranged in cargo racks RK1, RK2, cargo transfer bags 40, 50 and 60 contained in cargo transfer bags 80 and 90 arranged in cargo transfer racks RK4, RK5 and cargo transfer bags 70 contained in cargo transfer bags 90 arranged in cargo racks RK4, RK5.

Further, in step S40 shown in FIG. 31, cargo transfer bags 90 and 80 (M01 and M02 bags) and triple-size, double-size, and single-size cargo transfer bags 70, 60 and 50 are arranged in cargo compartments 31 to 34. In this state, a 4-single unit block switching takes place. As cargo transfer bags 90 and 80 are objects of block switching by 4-single unit as described above, in the 4-single unit block switching executed in step S40 shown in FIG. 31, 4-single unit block switching is possible among cargo transfer bags 50, 60 and 70 arranged in cargo racks RK1, RK2, cargo transfer bags 40, 50 and 60 contained in cargo transfer bags 80 arranged in cargo racks RK1, RK2, cargo transfer bags 40, 50 and 60 contained in cargo transfer bags 80 and 90 arranged in cargo transfer racks RK4, RK5 and cargo transfer bags 70 contained in cargo transfer bags 90 arranged in cargo racks RK4, RK5.

Further, in step S41 shown in FIG. 31, cargo transfer bags 90 and 80 (M01 and M02 bags) and triple-size, double-size, single-size and half-size cargo transfer bags 70, 60, 50 and 40 are arranged in cargo compartments 31 to 34. In this state, a 4-single unit block switching takes place. As cargo transfer bags 90 and 80 are objects of block switching by 4-single unit as described above, in the 4-single unit block switching executed in step S41 shown in FIG. 31, 4-single unit block switching is possible among cargo transfer bags 40, 50, 60 and 70 arranged in cargo racks RK1, RK2, cargo transfer bags 40, 50 and 60 contained in cargo transfer bags 80 arranged in cargo racks RK1, RK2, cargo transfer bags 40, 50 and 60 contained in cargo transfer bags 80 and 90 arranged in cargo transfer racks RK4, RK5 and cargo transfer bags 70 contained in cargo transfer bags 90 arranged in cargo racks RK4, RK5.

Further, a 4-single unit block switching for cargo transfer bags 40, 50, 60, 70, 80 and 90 involves location switching between cargo transfer bags of the same type and location switching between cargo transfer bags of different types.

Eight cargo transfer bags 40 constitute a 4-single unit block, and therefore, 4-single unit location switching corresponds to location switching between any of [1×cargo transfer bag 70+2×cargo transfer bag 40], [1×cargo transfer bag 60+1×cargo transfer bag 50+2×cargo transfer bag 40], [1×cargo transfer bag 60+4×cargo transfer bag 40], [3×cargo transfer bag 50+2×cargo transfer bag 40], [2×cargo transfer bag 50+4×cargo transfer bag 40], [1×cargo transfer bag 50+6×cargo transfer bag 40] and [8×cargo transfer bag 40] and any of [1×cargo transfer bag 80], [1×cargo transfer bag 70+1×cargo transfer bag 50], [1×cargo transfer bag 70+2×cargo transfer bag 40], [2×cargo transfer bag 60], [1×cargo transfer bag 60+2×cargo transfer bag 50], [1×cargo transfer bag 60+1×cargo transfer bag 50+2×cargo transfer bag 40], [1×cargo transfer bag 60+4×cargo transfer bag 40], [4×cargo transfer bag 50], [3×cargo transfer bag 50+2×cargo transfer bag 40], [2×cargo transfer bag 50+4×cargo transfer bag 40], [1×cargo transfer bag 50+6×cargo transfer bag 40] and [8×cargo transfer bag 40].

Here, [1×cargo transfer bag 80] represents one cargo transfer bag 80, and [1×cargo transfer bag 70+1×cargo transfer bag 50] represents a combination of one triple-size cargo transfer bag 70 and one single-size cargo transfer bag 50. Further, [1×cargo transfer bag 70+2×cargo transfer bag 40] represents a combination of one triple-size cargo transfer bag 70 and two half-size cargo transfer bags 40, and [2×cargo transfer bag 60] represents two double-size cargo transfer bags 60. Further, [1×cargo transfer bag 60+2×cargo transfer bag 50] represents a combination of one double-size cargo transfer bag 60 and two single-size cargo transfer bags 50, and [1×cargo transfer bag 60+1×cargo transfer bag 50+2×cargo transfer bag 40] represents a combination of one double-size cargo transfer bag 60, one single-size cargo transfer bag 50 and two half-size cargo transfer bags 40. Further, [1×cargo transfer bag 60+4×cargo transfer bag 40] represents a combination of one double-size cargo transfer bag 60 and four half-size cargo transfer bags 40, and [4×cargo transfer bag 50] represents four single-size cargo transfer bags 50. Further, [3×cargo transfer bag 50+2×cargo transfer bag 40] represents a combination of three single-size cargo transfer bags 50 and two half-size cargo transfer bags 40, and [2×cargo transfer bag 50+4×cargo transfer bag 40] represents a combination of two single-size cargo transfer bags 50 and four half-size cargo transfer bags 40. Further, [1×cargo transfer bag 50+6×cargo transfer bag 40] represents a combination of one single-size cargo transfer bag 50 and six half-size cargo transfer bags 40, and [8×cargo transfer bag 40] represents eight half-size cargo transfer bags 40.

Therefore, a 4-single unit block switching for cargo transfer bags 40 involves location switching between cargo transfer bags of the same type and/or location switching between cargo transfer bags of different types.

Four cargo transfer bags 50 constitute a 4-single unit block, and therefore, 4-single unit location switching corresponds to location switching between any of [1×cargo transfer bag 70+1×cargo transfer bag 50], [1×cargo transfer bag 60+2×cargo transfer bag 50], [1×cargo transfer bag 60+1×cargo transfer bag 50+2×cargo transfer bag 40], [4×cargo transfer bag 50], [3×cargo transfer bag 50+2×cargo transfer bag 40], [2×cargo transfer bag 50+4×cargo transfer bag 40] and [1×cargo transfer bag 50+6×cargo transfer bag 40] and any of [1×cargo transfer bag 80], [1×cargo transfer bag 70+1×cargo transfer bag 50], [1×cargo transfer bag 70+2×cargo transfer bag 40], [2×cargo transfer bag 60], [1×cargo transfer bag 60+2×cargo transfer bag 50], [1×cargo transfer bag 60+1×cargo transfer bag 50+2×cargo transfer bag 40], [1×cargo transfer bag 60+4×cargo transfer bag 40], [4×cargo transfer bag 50], [3×cargo transfer bag 50+2×cargo transfer bag 40], [2×cargo transfer bag 50+4×cargo transfer bag 40], [1×cargo transfer bag 50+6×cargo transfer bag 40] and [8×cargo transfer bag 40]. Therefore, a 4-single unit block switching for cargo transfer bags 50 involves location switching between cargo transfer bags of the same type and location switching between cargo transfer bags of different types.

Further, two cargo transfer bags 60 constitute a 4-single unit block, and therefore, 4-single unit location switching corresponds to location switching between any of [2×cargo transfer bag 60], [1×cargo transfer bag 60+2×cargo transfer bag 50], [1×cargo transfer bag 60+1×cargo transfer bag 50+2×cargo transfer bag 40] and [1×cargo transfer bag 60+4×cargo transfer bag 40] and any of [1×cargo transfer bag 80], [1×cargo transfer bag 70+1×cargo transfer bag 50], [1×cargo transfer bag 70+2×cargo transfer bag 40], [2×cargo transfer bag 60], [1×cargo transfer bag 60+2×cargo transfer bag 50], [1×cargo transfer bag 60+1×cargo transfer bag 50+2×cargo transfer bag 40], [1×cargo transfer bag 60+4×cargo transfer bag 40], [4×cargo transfer bag 50], [3×cargo transfer bag 50+2×cargo transfer bag 40], [2×cargo transfer bag 50+4×cargo transfer bag 40], [1×cargo transfer bag 50+6×cargo transfer bag 40] and [8×cargo transfer bag 40]. Therefore, a 4-single unit block switching for cargo transfer bags 60 involves location switching between cargo transfer bags of the same type and location switching between cargo transfer bags of different types.

Further, one cargo transfer bag 70 and one single-size cargo transfer bag 50 or two half-size cargo transfer bags 40 constitute a 4-single unit block, and therefore, 4-single unit location switching corresponds to location switching between either [1×cargo transfer bag 70+1×cargo transfer bag 50] or [1×cargo transfer bag 70+2×cargo transfer bag 40] and any of [1×cargo transfer bag 80], [1×cargo transfer bag 70+1×cargo transfer bag 50], [1×cargo transfer bag 70+2×cargo transfer bag 40], [2×cargo transfer bag 60], [1×cargo transfer bag 60+2×cargo transfer bag 50], [1×cargo transfer bag 60+1×cargo transfer bag 50+2×cargo transfer bag 40], [1×cargo transfer bag 60+4×cargo transfer bag 40], [4×cargo transfer bag 50], [3×cargo transfer bag 50+2×cargo transfer bag 40], [2×cargo transfer bag 50+4×cargo transfer bag 40], [1×cargo transfer bag 50+6×cargo transfer bag 40] and [8×cargo transfer bag 40].

It is noted that at each location switching, arrangement relation between cargo transfer bags 70 and 40 or between cargo transfer bags 70 and 50 may be the same or different before and after the location switching. Therefore, a 4-single unit block switching for cargo transfer bag 70 corresponds to location switching between cargo transfer bags of the same type and location switching between cargo transfer bags of different types.

A cargo transfer bag 80 has such a size that can contain four single-size cargo transfer bags 50. Therefore, it may contain various combinations of half-size, single-size, and double-size cargo transfer bags 40, 50 and 60. Therefore, in a 4-single unit block switching, location of a 4-single unit formed by a combination of half-size, single-size, and double-size cargo transfer bags 40, 50 and 60 contained in cargo transfer bag 80 is switched. Therefore, a 4-single unit block switching for cargo transfer bag 80 corresponds to location switching between cargo transfer bags of different types.

A cargo transfer bag 90 has such a size that can contain six single-size cargo transfer bags 50. Therefore, it may contain various combinations of half-size, single-size, double-size and triple-size cargo transfer bags 40, 50, 60 and 70. Therefore, in a 4-single unit block switching, location of a 4-single unit formed by a combination of half-size, single-size, double-size and triple-size cargo transfer bags 40, 50, 60 and 70 contained in cargo transfer bag 90 is switched. Therefore, a 4-single unit block switching for cargo transfer bag 90 corresponds to location switching between cargo transfer bags of different types.

[Block Switching of 2-Single Unit, 3-Single Unit, 4-Single Unit and 6-Single Unit]

When the flow chart shown in FIG. 37 is selected as step S57 of the flow chart shown in FIG. 32, step S571 shown in FIG. 37 is executed in steps S36, S37, S38 and S39 to S41 shown in FIG. 31, steps S572 and S573 shown in FIG. 37 are executed in steps S36 to S41 shown in FIG. 31, and step S574 shown in FIG. 37 is executed in steps S36 to S41 shown in FIG. 31.

The block switching of 2-single unit, 3-single unit and 4-single unit in steps S571 to 573 of the flow chart shown in FIG. 37 is as described above.

In the following, a 6-single unit block switching in step S574 of FIG. 37 will be described.

In step S36 shown in FIG. 31, only cargo transfer bags 90 (M01 bags) are arranged in cargo compartments 31 to 34. One cargo transfer bag 90 has such a size that can contain six single-size cargo transfer bags 50, and therefore, a 6-single unit block formed of some of the plurality of cargo transfer bags 40, 50, 60 and 70 contained in one cargo transfer bag 90 (arbitrary combination of cargo transfer bags 40, 50, 60 and 70 that can be arranged in an area large enough to arrange six cargo transfer bags 50) is switched with a 6-single unit block formed of some of the plurality of cargo transfer bags 40, 50, 60 and 70 contained in another cargo transfer bag 90 (arbitrary combination of cargo transfer bags 40, 50, 60 and 70 that can be arranged in an area large enough to arrange six cargo transfer bags 50).

In step S37 shown in FIG. 31, cargo transfer bags 90 and 80 (M01 and M02 bags) are arranged in cargo compartments 31 to 34. In this state, a 6-single unit block switching takes place. As cargo transfer bags 90 and 80 are objects of block switching by 6-single unit, in the 6-single unit block switching executed in step S37 shown in FIG. 31, 6-single unit block switching is possible among cargo transfer bag 80 including cargo transfer bags 40, 50, and 60 arranged in cargo racks RK1, RK2, cargo transfer bags 40, 50, and 60 contained in cargo transfer bags 80 and 90 arranged in cargo racks RK4, RK5 and cargo transfer bag 70 contained in cargo transfer bag 90 arranged in cargo transfer racks RK4, RK5.

In step S38 shown in FIG. 31, cargo transfer bags 90 and 80 (M01 and M02 bags) and triple-size cargo transfer bags 70 are arranged in cargo compartments 31 to 34. In this state, a 6-single unit block switching takes place. As cargo transfer bags 90 and 80 are objects of block switching by 6-single unit as described above, in the 6-single unit block switching executed in step S38 shown in FIG. 31, 6-single unit block switching is possible among cargo transfer bag 80 including cargo transfer bags 40, 50, and 60 arranged in cargo racks RK1, RK2, cargo transfer bags 40, 50, and 60 contained in cargo transfer bags 80 and 90 arranged in cargo racks RK4, RK5 and cargo transfer bag 70 contained in cargo transfer bag 90 arranged in cargo transfer racks RK4, RK5.

Further, in step S39 shown in FIG. 31, cargo transfer bags 90 and 80 (M01 and M02 bags) and triple-size and double-size cargo transfer bags 70 and 60 are arranged in cargo compartments 31 to 34. In this state, a 6-single unit block switching takes place. As cargo transfer bags 90 and 80 are objects of block switching by 6-single unit as described above, in the 6-single unit block switching executed in step S39 shown in FIG. 31, 6-single unit block switching is possible among cargo transfer bag 80 including cargo transfer bags 40, 50, and 60 arranged in cargo racks RK1, RK2, cargo transfer bags 40, 50, and 60 contained in cargo transfer bags 80 and 90 arranged in cargo racks RK4, RK5 and cargo transfer bag 70 contained in cargo transfer bag 90 arranged in cargo transfer racks RK4, RK5.

Further, in step S40 shown in FIG. 31, cargo transfer bags 90 and 80 (M01 and M02 bags) and triple-size, double-size, and single-size cargo transfer bags 70, 60 and 50 are arranged in cargo compartments 31 to 34. In this state, a 6-single unit block switching takes place. As cargo transfer bags 90 and 80 are objects of block switching by 6-single unit as described above, in the 6-single unit block switching executed in step S40 shown in FIG. 31, 6-single unit block switching is possible among cargo transfer bag 80 including cargo transfer bags 40, 50, and 60 arranged in cargo racks RK1, RK2, cargo transfer bags 40, 50, and 60 contained in cargo transfer bags 80 and 90 arranged in cargo racks RK4, RK5 and cargo transfer bag 70 contained in cargo transfer bag 90 arranged in cargo transfer racks RK4, RK5.

Further, in step S41 shown in FIG. 31, cargo transfer bags 90 and 80 (M01 and M02 bags) and triple-size, double-size, single-size and half-size cargo transfer bags 70, 60, 50 and 40 are arranged in cargo compartments 31 to 34. In this state, a 6-single unit block switching takes place. As cargo transfer bags 90 and 80 are objects of block switching by 6-single unit as described above, in the 6-single unit block switching executed in step S41 shown in FIG. 31, 6-single unit block switching is possible among cargo transfer bag 80 including cargo transfer bags 40, 50, and 60 arranged in cargo racks RK1, RK2 cargo transfer bags 40, 50, and 60 contained in cargo transfer bags 80, 90 arranged in cargo transfer racks RK4, RK5, and cargo transfer bags 70 contained in cargo transfer bag 90 arranged in cargo transfer racks RK4, RK5.

Further, a 6-single unit block switching for cargo transfer bags 40, 50, 60, 70, 80 and 90 involves location switching between cargo transfer bags of the same type and location switching between cargo transfer bags of different types.

Twelve cargo transfer bags 40 constitute a 6-single unit block, and therefore, 6-single unit location switching corresponds to location switching between any of [1×cargo transfer bag 80+4×cargo transfer bag 40], [1×cargo transfer bag 80+1×cargo transfer bag 50+2×cargo transfer bag 40], [1×cargo transfer bag 70+1×cargo transfer bag 60+2×cargo transfer bag 40], [1×cargo transfer bag 70+2×cargo transfer bag 50+2×cargo transfer bag 40], [1×cargo transfer bag 70+1×cargo transfer bag 50+4×cargo transfer bag 40], [1×cargo transfer bag 70+6×cargo transfer bag 40], [2×cargo transfer bag 60+1×cargo transfer bag 50+2×cargo transfer bag 40], [2×cargo transfer bag 60+4×cargo transfer bag 40], [1×cargo transfer bag 60+3×cargo transfer bag 50+2×cargo transfer bag 40], [1×cargo transfer bag 60+2×cargo transfer bag 50+4×cargo transfer bag 40], [1×cargo transfer bag 60+1×cargo transfer bag 50+6×cargo transfer bag 40], [1×cargo transfer bag 60+8×cargo transfer bag 40], [5×cargo transfer bag 50+2×cargo transfer bag 40], [4×cargo transfer bag 50+4×cargo transfer bag 40], [3×cargo transfer bag 50+6×cargo transfer bag 40], [2×cargo transfer bag 50+8×cargo transfer bag 40], [1×cargo transfer bag 50+10×cargo transfer bag 40] and [12×cargo transfer bag 40] and any of [1×cargo transfer bag 90], [1×cargo transfer bag 80+1×cargo transfer bag 60], [1×cargo transfer bag 80+2×cargo transfer bag 50], [1×cargo transfer bag 80+4×cargo transfer bag 40], [1×cargo transfer bag 80+1×cargo transfer bag 50+2×cargo transfer bag 40], [2×cargo transfer bag 70], [1×cargo transfer bag 70+1×cargo transfer bag 60+1×cargo transfer bag 50], [1×cargo transfer bag 70+1×cargo transfer bag 60+2×cargo transfer bag 40], [1×cargo transfer bag 70+3×cargo transfer bag 50], [1×cargo transfer bag 70+2×cargo transfer bag 50+2×cargo transfer bag 40], [1×cargo transfer bag 70+1×cargo transfer bag 50+4×cargo transfer bag 40], [1×cargo transfer bag 70+6×cargo transfer bag 40], [3×cargo transfer bag 60], [2×cargo transfer bag 60+2×cargo transfer bag 50], [2×cargo transfer bag 60+1×cargo transfer bag 50+2×cargo transfer bag 40], [2×cargo transfer bag 60+4×cargo transfer bag 40], [1×cargo transfer bag 60+4×cargo transfer bag 50], [1×cargo transfer bag 60+3×cargo transfer bag 50+2×cargo transfer bag 40], [1×cargo transfer bag 60+2×cargo transfer bag 50+4×cargo transfer bag 40], [1×cargo transfer bag 60+1×cargo transfer bag 50+6×cargo transfer bag 40], [1×cargo transfer bag 60+8×cargo transfer bag 40], [6×cargo transfer bag 50], [5×cargo transfer bag 50+2×cargo transfer bag 40], [4×cargo transfer bag 50+4×cargo transfer bag 40], [3×cargo transfer bag 50+6×cargo transfer bag 40], [2×cargo transfer bag 50+8×cargo transfer bag 40], [1×cargo transfer bag 50+10×cargo transfer bag 40] and [12×cargo transfer bag 40].

Here, [1×cargo transfer bag 90] represents one cargo transfer bag 90, and [1×cargo transfer bag 80+1×cargo transfer bag 60] represents a combination of one cargo transfer bag 80 and one double-size cargo transfer bag 60. Further, [1×cargo transfer bag 80+2×cargo transfer bag 50] represents a combination of one cargo transfer bag 80 and two single-size cargo transfer bags 50, and [1×cargo transfer bag 80+4×cargo transfer bag 40] represents a combination of one cargo transfer bag 80 and four half-size cargo transfer bags 40.

Further, [1×cargo transfer bag 80+1×cargo transfer bag 50+2×cargo transfer bag 40] represents a combination of one cargo transfer bag 80, one single-size cargo transfer bag 50 and two half-size cargo transfer bags 40, and [2×cargo transfer bag 70] represents two triple-size cargo transfer bags 70. Further, [1×cargo transfer bag 70+1×cargo transfer bag 60+1×cargo transfer bag 50] represents a combination of one triple-size cargo transfer bag 70, one double-size cargo transfer bag 60 and one single-size cargo transfer bag 50, and [1×cargo transfer bag 70+1×cargo transfer bag 60+2×cargo transfer bag 40] represents a combination of one triple-size cargo transfer bag 70, one double-size cargo transfer bag 60 and two half-size cargo transfer bags 40.

Further, [1×cargo transfer bag 70+3×cargo transfer bag 50] represents a combination of one triple-size cargo transfer bag 70 and three single-size cargo transfer bags 50, and [1×cargo transfer bag 70+2×cargo transfer bag 50+2×cargo transfer bag 40] represents a combination of one triple-size cargo transfer bag 70, two single-size cargo transfer bags 50 and two half-size cargo transfer bags 40. Further, [1×cargo transfer bag 70+1×cargo transfer bag 50+4×cargo transfer bag 40] represents a combination of one triple-size cargo transfer bag 70, one single-size cargo transfer bag 50 and four half-size cargo transfer bags 40, and [1×cargo transfer bag 70+6×cargo transfer bag 40] represents a combination of one triple-size cargo transfer bag 70 and six half-size cargo transfer bags 40.

Further, [3×cargo transfer bag 60] represents three double-size cargo transfer bags 60, and [2×cargo transfer bag 60+2×cargo transfer bag 50] represents a combination of two double-size cargo transfer bags 60 and two single-size cargo transfer bags 50. Further, [2×cargo transfer bag 60+1×cargo transfer bag 50+2×cargo transfer bag 40] represents a combination of two double-size cargo transfer bags 60, one single-size cargo transfer bag 50 and two half-size cargo transfer bags 40, and [2×cargo transfer bag 60+4×cargo transfer bag 40] represents a combination of two double-size cargo transfer bags 60 and four half-size cargo transfer bags 40.

Further, [1×cargo transfer bag 60+4×cargo transfer bag 50] represents a combination of one double-size cargo transfer bag 60 and four single-size cargo transfer bags 50, and [1×cargo transfer bag 60+3×cargo transfer bag 50+2×cargo transfer bag 40] represents a combination of one double-size cargo transfer bag 60, three single-size cargo transfer bags 50 and two half-size cargo transfer bags 40. Further, [1×cargo transfer bag 60+2×cargo transfer bag 50+4×cargo transfer bag 40] represents a combination of one double-size cargo transfer bag 60, two single-size cargo transfer bags 50 and four half-size cargo transfer bags 40, and [1×cargo transfer bag 60+1×cargo transfer bag 50+6×cargo transfer bag 40] represents a combination of one double-size cargo transfer bag 60, one single-size cargo transfer bag 50 and six half-size cargo transfer bags 40.

Further, [1×cargo transfer bag 60+8×cargo transfer bag 40] represents a combination of one double-size cargo transfer bag 60 and eight half-size cargo transfer bags 40, and [6×cargo transfer bag 50] represents six single-size cargo transfer bags 50. Further, [5×cargo transfer bag 50+2×cargo transfer bag 40] represents a combination of five single-size cargo transfer bags 50 and two half-size cargo transfer bags 40, and [4×cargo transfer bag 50+4×cargo transfer bag 40] represents a combination of four single-size cargo transfer bags 50 and four half-size cargo transfer bags 40.

Further, [3×cargo transfer bag 50+6×cargo transfer bag 40] represents a combination of three single-size cargo transfer bags 50 and six half-size cargo transfer bags 40, [2×cargo transfer bag 50+8×cargo transfer bag 40] represents a combination of two single-size cargo transfer bags 50 and eight half-size cargo transfer bags 40, and [1×cargo transfer bag 50+10×cargo transfer bag 40] represents a combination of one single-size cargo transfer bag 50 and ten half-size cargo transfer bags 40. Further, [12×cargo transfer bag 40] represents twelve half-size cargo transfer bags 40.

Therefore, a 6-single unit block switching for cargo transfer bags 40 involves location switching between cargo transfer bags of the same type and location switching between cargo transfer bags of different types.

Six cargo transfer bags 50 constitute a 6-single unit block, and therefore, 6-single unit location switching corresponds to location switching between any of [1×cargo transfer bag 80+2×cargo transfer bag 50], [1×cargo transfer bag 80+1×cargo transfer bag 50+2×cargo transfer bag 40], [1×cargo transfer bag 70+1×cargo transfer bag 60+1×cargo transfer bag 50], [1×cargo transfer bag 70+3×cargo transfer bag 50], [1×cargo transfer bag 70+2×cargo transfer bag 50+2×cargo transfer bag 40], [1×cargo transfer bag 70+1×cargo transfer bag 50+4×cargo transfer bag 40], [2×cargo transfer bag 60+2×cargo transfer bag 50], [2×cargo transfer bag 60+1×cargo transfer bag 50+2×cargo transfer bag 40], [1×cargo transfer bag 60+4×cargo transfer bag 50], [1×cargo transfer bag 60+3×cargo transfer bag 50+2×cargo transfer bag 40], [1×cargo transfer bag 60+2×cargo transfer bag 50+4×cargo transfer bag 40], [1×cargo transfer bag 60+1×cargo transfer bag 50+6×cargo transfer bag 40], [6×cargo transfer bag 50], [5×cargo transfer bag 50+2×cargo transfer bag 40], [4×cargo transfer bag 50+4×cargo transfer bag 40], [3×cargo transfer bag 50+6×cargo transfer bag 40], [2×cargo transfer bag 50+8×cargo transfer bag 40] and [1×cargo transfer bag 50+10×cargo transfer bag 40] and any of [1×cargo transfer bag 90], [1×cargo transfer bag 80+1×cargo transfer bag 60], [1×cargo transfer bag 80+2×cargo transfer bag 50], [1×cargo transfer bag 80+4×cargo transfer bag 40], [1×cargo transfer bag 80+1×cargo transfer bag 50+2×cargo transfer bag 40], [2×cargo transfer bag 70], [1×cargo transfer bag 70+1×cargo transfer bag 60+1×cargo transfer bag 50], [1×cargo transfer bag 70+1×cargo transfer bag 60+2×cargo transfer bag 40], [1×cargo transfer bag 70+3×cargo transfer bag 50], [1×cargo transfer bag 70+2×cargo transfer bag 50+2×cargo transfer bag 40], [1×cargo transfer bag 70+1×cargo transfer bag 50+4×cargo transfer bag 40], [1×cargo transfer bag 70+6×cargo transfer bag 40], [3×cargo transfer bag 60], [2×cargo transfer bag 60+2×cargo transfer bag 50], [2×cargo transfer bag 60+1×cargo transfer bag 50+2×cargo transfer bag 40], [2×cargo transfer bag 60+4×cargo transfer bag 40], [1×cargo transfer bag 60+4×cargo transfer bag 50], [1×cargo transfer bag 60+3×cargo transfer bag 50+2×cargo transfer bag 40], [1×cargo transfer bag 60+2×cargo transfer bag 50+4×cargo transfer bag 40], [1×cargo transfer bag 60+1×cargo transfer bag 50+6×cargo transfer bag 40], [1×cargo transfer bag 60+8×cargo transfer bag 40], [6×cargo transfer bag 50], [5×cargo transfer bag 50+2×cargo transfer bag 40], [4×cargo transfer bag 50+4×cargo transfer bag 40], [3×cargo transfer bag 50+6×cargo transfer bag 40], [2×cargo transfer bag 50+8×cargo transfer bag 40], [1×cargo transfer bag 50+10×cargo transfer bag 40] and [12×cargo transfer bag 40]. Therefore, a 6-single unit block switching for cargo transfer bags 50 involves location switching between cargo transfer bags of the same type and location switching between cargo transfer bags of different types.

Further, three cargo transfer bags 60 constitute a 6-single unit block, and therefore, 6-single unit location switching corresponds to location switching between any of [1×cargo transfer bag 80+1×cargo transfer bag 60], [1×cargo transfer bag 70+1×cargo transfer bag 60+1×cargo transfer bag 50], [1×cargo transfer bag 70+1×cargo transfer bag 60+2×cargo transfer bag 40], [3×cargo transfer bag 60], [2×cargo transfer bag 60+2×cargo transfer bag 50], [2×cargo transfer bag 60+1×cargo transfer bag 50+2×cargo transfer bag 40], [2×cargo transfer bag 60+4×cargo transfer bag 40], [1×cargo transfer bag 60+4×cargo transfer bag 50], [1×cargo transfer bag 60+3×cargo transfer bag 50+2×cargo transfer bag 40], [1×cargo transfer bag 60+2×cargo transfer bag 50+4×cargo transfer bag 40], [1×cargo transfer bag 60+1×cargo transfer bag 50+6×cargo transfer bag 40] and [1×cargo transfer bag 60+8×cargo transfer bag 40] and any of [1×cargo transfer bag 90], [1×cargo transfer bag 80+1×cargo transfer bag 60], [1×cargo transfer bag 80+2×cargo transfer bag 50], [1×cargo transfer bag 80+4×cargo transfer bag 40], [1×cargo transfer bag 80+1×cargo transfer bag 50+2×cargo transfer bag 40], [2×cargo transfer bag 70], [1×cargo transfer bag 70+1×cargo transfer bag 60+1×cargo transfer bag 50], [1×cargo transfer bag 70+1×cargo transfer bag 60+2×cargo transfer bag 40], [1×cargo transfer bag 70+3×cargo transfer bag 50], [1×cargo transfer bag 70+2×cargo transfer bag 50+2×cargo transfer bag 40], [1×cargo transfer bag 70+1×cargo transfer bag 50+4×cargo transfer bag 40], [1×cargo transfer bag 70+6×cargo transfer bag 40], [3×cargo transfer bag 60], [2×cargo transfer bag 60+2×cargo transfer bag 50], [2×cargo transfer bag 60+1×cargo transfer bag 50+2×cargo transfer bag 40], [2×cargo transfer bag 60+4×cargo transfer bag 40], [1×cargo transfer bag 60+4×cargo transfer bag 50], [1×cargo transfer bag 60+3×cargo transfer bag 50+2×cargo transfer bag 40], [1×cargo transfer bag 60+2×cargo transfer bag 50+4×cargo transfer bag 40], [1×cargo transfer bag 60+1×cargo transfer bag 50+6×cargo transfer bag 40], [1×cargo transfer bag 60+8×cargo transfer bag 40], [6×cargo transfer bag 50], [5×cargo transfer bag 50+2×cargo transfer bag 40], [4×cargo transfer bag 50+4×cargo transfer bag 40], [3×cargo transfer bag 50+6×cargo transfer bag 40], [2×cargo transfer bag 50+8×cargo transfer bag 40], [1×cargo transfer bag 50+10×cargo transfer bag 40] and [12×cargo transfer bag 40]. Therefore, a 6-single unit block switching for cargo transfer bags 60 involves location switching between cargo transfer bags of the same type and location switching between cargo transfer bags of different types.

Further, two cargo transfer bags 10 constitute a 6-single unit block, and therefore, 6-single unit location switching corresponds to location switching between any of [2×cargo transfer bag 70], [1×cargo transfer bag 70+1×cargo transfer bag 60+1×cargo transfer bag 50], [1×cargo transfer bag 70+1×cargo transfer bag 60+2×cargo transfer bag 40], [1×cargo transfer bag 70+3×cargo transfer bag 50], [1×cargo transfer bag 70+2×cargo transfer bag 50+2×cargo transfer bag 40], [1×cargo transfer bag 70+1×cargo transfer bag 50+4×cargo transfer bag 40] and [1×cargo transfer bag 70+6×cargo transfer bag 40] and any of [1×cargo transfer bag 90], [1×cargo transfer bag 80+1×cargo transfer bag 60], [1×cargo transfer bag 80+2×cargo transfer bag 50], [1×cargo transfer bag 80+4×cargo transfer bag 40], [1×cargo transfer bag 80+1×cargo transfer bag 50+2×cargo transfer bag 40], [2×cargo transfer bag 70], [1×cargo transfer bag 70+1×cargo transfer bag 60+1×cargo transfer bag 50], [1×cargo transfer bag 70+1×cargo transfer bag 60+2×cargo transfer bag 40], [1×cargo transfer bag 70+3×cargo transfer bag 50], [1×cargo transfer bag 70+2×cargo transfer bag 50+2×cargo transfer bag 40], [1×cargo transfer bag 70+1×cargo transfer bag 50+4×cargo transfer bag 40], [1×cargo transfer bag 70+6×cargo transfer bag 40], [3×cargo transfer bag 60], [2×cargo transfer bag 60+2×cargo transfer bag 50], [2×cargo transfer bag 60+1×cargo transfer bag 50+2×cargo transfer bag 40], [2×cargo transfer bag 60+4×cargo transfer bag 40], [1×cargo transfer bag 60+4×cargo transfer bag 50], [1×cargo transfer bag 60+3×cargo transfer bag 50+2×cargo transfer bag 40], [1×cargo transfer bag 60+2×cargo transfer bag 50+4×cargo transfer bag 40], [1×cargo transfer bag 60+1×cargo transfer bag 50+6×cargo transfer bag 40], [1×cargo transfer bag 60+8×cargo transfer bag 40], [6×cargo transfer bag 50], [5×cargo transfer bag 50+2×cargo transfer bag 40], [4×cargo transfer bag 50+4×cargo transfer bag 40], [3×cargo transfer bag 50+6×cargo transfer bag 40], [2×cargo transfer bag 50+8×cargo transfer bag 40], [1×cargo transfer bag 50+10×cargo transfer bag 40] and [12×cargo transfer bag 40]. Therefore, a 6-single unit block switching for cargo transfer bags 70 involves location switching between cargo transfer bags of the same type and location switching between cargo transfer bags of different types.

Further, a combination of one cargo transfer bag 80 and any of [1×cargo transfer bag 60], [2×cargo transfer bag 50], [1×cargo transfer bag 50+2×cargo transfer bag 40] and [4×cargo transfer bag 40] constitute a 6-single unit block, and therefore, 6-single unit location switching corresponds to location switching between any of [1×cargo transfer bag 80+1×cargo transfer bag 60], [1×cargo transfer bag 80+2×cargo transfer bag 50], [1×cargo transfer bag 80+1×cargo transfer bag 50+2×cargo transfer bag 40], and [1×cargo transfer bag 80+4×cargo transfer bag 40] and any of [1×cargo transfer bag 90], [1×cargo transfer bag 80+1×cargo transfer bag 60], [1×cargo transfer bag 80+2×cargo transfer bag 50], [1×cargo transfer bag 80+4×cargo transfer bag 40], [1×cargo transfer bag 80+1×cargo transfer bag 50+2×cargo transfer bag 40], [2×cargo transfer bag 70], [1×cargo transfer bag 70+1×cargo transfer bag 60+1×cargo transfer bag 50], [1×cargo transfer bag 70+1×cargo transfer bag 60+2×cargo transfer bag 40], [1×cargo transfer bag 70+3×cargo transfer bag 50], [1×cargo transfer bag 70+2×cargo transfer bag 50+2×cargo transfer bag 40], [1×cargo transfer bag 70+1×cargo transfer bag 50+4×cargo transfer bag 40], [1×cargo transfer bag 70+6×cargo transfer bag 40], [3×cargo transfer bag 60], [2×cargo transfer bag 60+2×cargo transfer bag 50], [2×cargo transfer bag 60+1×cargo transfer bag 50+2×cargo transfer bag 40], [2×cargo transfer bag 60+4×cargo transfer bag 40], [1×cargo transfer bag 60+4×cargo transfer bag 50], [1×cargo transfer bag 60+3×cargo transfer bag 50+2×cargo transfer bag 40], [1×cargo transfer bag 60+2×cargo transfer bag 50+4×cargo transfer bag 40], [1×cargo transfer bag 60+1×cargo transfer bag 50+6×cargo transfer bag 40], [1×cargo transfer bag 60+8×cargo transfer bag 40], [6×cargo transfer bag 50], [5×cargo transfer bag 50+2×cargo transfer bag 40], [4×cargo transfer bag 50+4×cargo transfer bag 40], [3×cargo transfer bag 50+6×cargo transfer bag 40], [2×cargo transfer bag 50+8×cargo transfer bag 40] [1×cargo transfer bag 50+10×cargo transfer bag 40] and [12×cargo transfer bag 40].

Here, [1×cargo transfer bag 60] represents one double-size cargo transfer bag 60, and [2×cargo transfer bag 50] represents two single-size cargo transfer bags 50. Further, [1×cargo transfer bag 50+2×cargo transfer bag 40] represents a combination of one single-size cargo transfer bag 50 and two half-size cargo transfer bags 40, and [4×cargo transfer bag 40] represents four half-size cargo transfer bags 40.

It is noted that at each location switching, arrangement relation between cargo transfer bags 80 and 40, between cargo transfer bags 80 and 50 or between cargo transfer bags 80 and 60 may be the same or different before and after the location switching. Therefore, a 6-single unit block switching for cargo transfer bag 80 corresponds to location switching between cargo transfer bags of the same type and location switching between cargo transfer bags of different types.

A cargo transfer bag 90 has such a size that can contain six single-size cargo transfer bags 50. Therefore, it may contain various combinations of half-size, single-size, double-size and triple-size cargo transfer bags 40, 50, 60 and 70. Therefore, in a 6-single unit block switching, location of a 6-single unit formed by a combination of half-size, single-size, double-size and triple-size cargo transfer bags 40, 50, 60 and 70 contained in cargo transfer bag 90 is switched. Therefore, a 6-single unit block switching for cargo transfer bag 90 corresponds to location switching between cargo transfer bags of different types.

As described above, the block switching in step S57 shown in FIG. 32 for cargo transfer bags 40, 50, 60, 70, 80 and 90 corresponds to location switching between cargo transfer bags of the same type and/or location switching between cargo transfer bags of different types. As the locations of a number of cargo transfer bags can be changed by the block switching, it is possible to efficiently bring the center of gravity of transport 10 with cargo transfer bags 40, 50, 60, 70, 80 and 90 loaded therein closer to the optimal position of center of gravity.

At step S57 shown in FIG. 32, which of the flow charts shown in FIGS. 35 to 37 should be adopted for block exchange is determined in consideration of the number of cargo transfer bags 80 and 90.

Specifically, when the number of cargo transfer bags 80 and 90 is smaller than a prescribed number, 2-single unit and 3-single unit block switching will be executed in accordance with the flow chart shown in FIG. 35. The reason is that when the number of cargo transfer bags 80 and 90 is small, block switching by 4-single unit or 6-single unit does not have significant influence to adjustment of the center of gravity of transport 10 with cargo transfer bags loaded, to the optimal center of gravity.

When the number of cargo transfer bags 80 is equal to or larger than the prescribed number and the number of cargo transfer bags 90 is smaller than the prescribed number, block switching by 2-single unit, 3-single unit and 4-single unit will be executed in accordance with the flow chart shown in FIG. 36.

Further, when the number of cargo transfer bags 80 and 90 is equal to or larger than the prescribed number, block switching by 2-single unit, 3-single unit, 4-single unit and 6-single unit will be executed in accordance with the flow chart shown in FIG. 37.

In this manner, block switching at step S57 of the flow chart shown in FIG. 32 is executed in accordance with a flow chart appropriate for the types and numbers of cargo transfer bags 40, 50, 60, 70, 80 and 90 arranged in cargo compartments 31 to 34.

Which of the flow charts shown in FIGS. 35 to 37 should be used for block switching may be determined independent from the number of cargo transfer bags 80 and 90. Specifically, block switching may be performed in accordance with a flow chart selected arbitrarily from the flow charts shown in FIGS. 35 to 37.

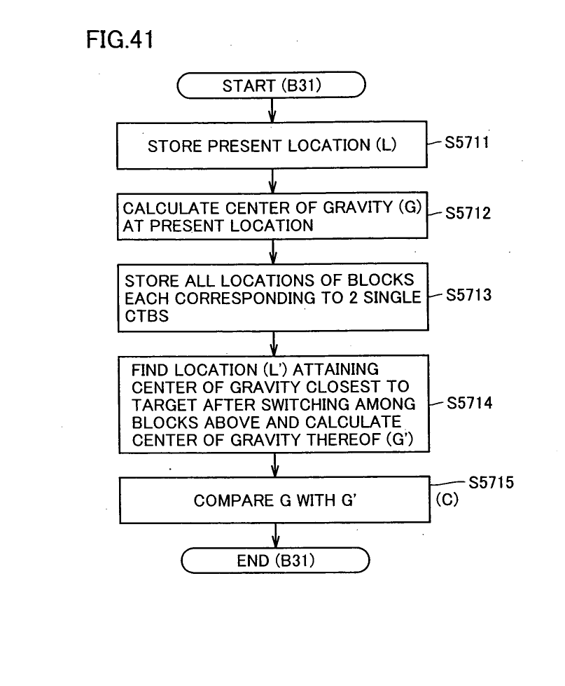

FIG. 41 is a flow chart representing specific operations in step S571 of the flow charts shown in FIGS. 35 to 37. When a 2-single unit block switching starts, the present location of a 2-single unit block as an object of block switching is stored (step S5711), and the center of gravity G at the present location L is calculated (step S5712).

Thereafter, every block that corresponds to two single-size cargo transfer bags 50 is extracted, and location of every extracted block is stored (step S5713). Thereafter, among all the blocks extracted in step S5713, the location L′ at which the center of gravity after switching comes closest to the target is stored and the center of gravity G′ at the location L′ is calculated (step S5714). After step S5714, the center of gravity G′ is compared with the center of gravity G, and when the center of gravity G′ is closer to the target than G, the object 2-single unit block is switched to the location L′. When the center of gravity G′ is farther to the target than G, the object 2-single unit block is returned to the original location L (step S5715). Thus, specific operations of step S571 shown in FIGS. 35 to 37 end.

The 2-single unit block switching executed in accordance with the flow chart shown in FIG. 41 will be the object of block switching only when the block that corresponds to two cargo transfer bags 50 is filled with cargo transfer bags 40, 50 and 60.

Though all blocks of 2-single unit are extracted to determine one block of which center of gravity is closest to the target in the example shown in FIG. 41, the present invention is not limited thereto, and the 2-single unit block switching may be terminated when a block switching that realizes the center of gravity closer to the target is finished.

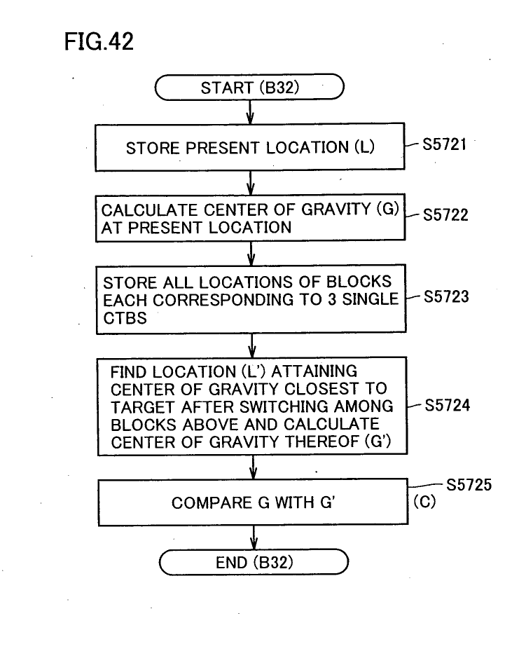

FIG. 42 is a flow chart representing specific operations of step S572 of the flow charts shown in FIGS. 35 to 37. When a 3-single unit block switching starts, the present location of a 3-single unit block as an object of block switching is stored (step S5721), and the center of gravity G at the present location L is calculated (step S5722).

Thereafter, every block that corresponds to three single-size cargo transfer bags 50 is extracted, and location of every extracted block is stored (step S5723). Thereafter, among all the blocks extracted in step S5723, the location L′ at which the center of gravity after switching comes closest to the target is stored and the center of gravity G′ at the location L′ is calculated (step S5724). After step S5724, the center of gravity G′ is compared with the center of gravity G, and when the center of gravity G′ is closer to the target than G, the object 3-single unit block is switched to the location L′. When the center of gravity G′ is farther to the target than G, the object 3-single unit block is returned to the original location L (step S5725). Thus, specific operations of step S572 shown in FIGS. 35 to 37 end.

The 3-single unit block switching executed in accordance with the flow chart shown in FIG. 42 will be the object of block switching only when the block that corresponds to three cargo transfer bags 50 is filled with cargo transfer bags 40, 50, 60 and 70.

Though all blocks of 3-single unit are extracted to determine one block of which center of gravity is closest to the target in the example shown in FIG. 42, the present invention is not limited thereto, and the 3-single unit block switching may be terminated when a block switching that realizes the center of gravity closer to the target is finished.

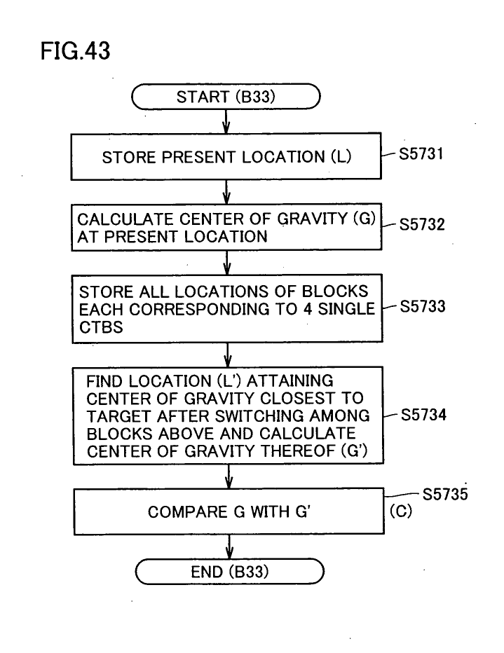

FIG. 43 is a flow chart representing specific operations of step S573 of the flow charts shown in FIGS. 35 to 37. When a 4-single unit block switching starts, the present location of a 4-single unit block as an object of block switching is stored (step S5731), and the center of gravity G at the present location L is calculated (step S5732).

Thereafter, every block that corresponds to four single-size cargo transfer bags 50 is extracted, and location of every extracted block is stored (step S5733). Thereafter, among all the blocks extracted in step S5733, the location L′ at which the center of gravity after switching comes closest to the target is stored and the center of gravity G′ at the location L′ is calculated (step S5734). After step S5734, the center of gravity G′ is compared with the center of gravity G, and when the center of gravity G′ is closer to the target than G, the object 4-single unit block is switched to the location L′. When the center of gravity G′ is farther to the target than G, the object 4-single unit block is returned to the original location L (step S5735). Thus, specific operations of step S573 shown in FIGS. 35 to 37 end.

The 4-single unit block switching executed in accordance with the flow chart shown in FIG. 43 will be the object of block switching only when the block that corresponds to four cargo transfer bags 50 is filled with cargo transfer bags 40, 50, 60, 70 and 80.

Though all blocks of 4-single unit are extracted to determine one block of which center of gravity is closest to the target in the example shown in FIG. 43, the present invention is not limited thereto, and the 4-single unit block switching may be terminated when a block switching that realizes the center of gravity closer to the target is finished.

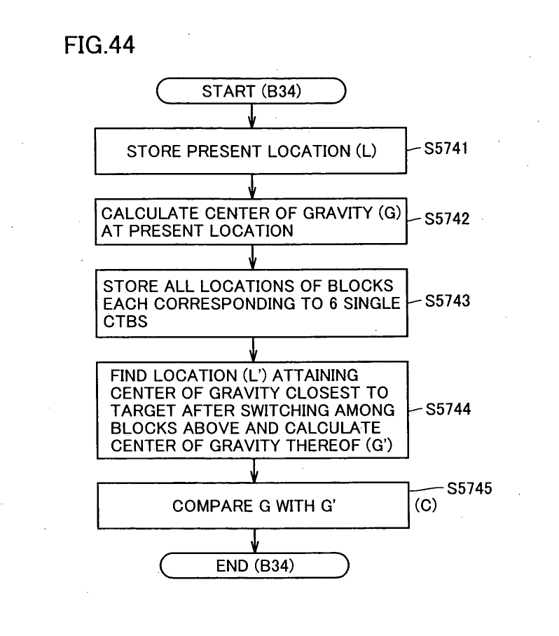

FIG. 44 is a flow chart representing specific operations of step S574 of the flow charts shown in FIGS. 35 to 37. When a 6-single unit block switching starts, the present location of a 6-single unit block as an object of block switching is stored (step $5741), and the center of gravity G at the present location L is calculated (step S5742).

Thereafter, every block that corresponds to six single-size cargo transfer bags 50 is extracted, and location of every extracted block is stored (step S5743). Thereafter, among all the blocks extracted in step S5743, the location L′ at which the center of gravity after switching comes closest to the target is stored and the center of gravity G′ at the location L′ is calculated (step S5744). After step S5744, the center of gravity G′ is compared with the center of gravity G, and when the center of gravity G′ is closer to the target than G, the object 4-single unit block is switched to the location L′. When the center of gravity G′ is farther to the target than G, the object 6-single unit block is returned to the original location L (step S5745). Thus, specific operations of step S574 shown in FIGS. 35 to 37 end.

The 6-single unit block switching executed in accordance with the flow chart shown in FIG. 44 will be the object of block switching only when the block that corresponds to six cargo transfer bags 50 is filled with cargo transfer bags 40, 50, 60, 70, 80 and 90.

Though all blocks of 6-single unit are extracted to determine one block of which center of gravity is closest to the target in the example shown in FIG. 44, the present invention is not limited thereto, and the 6-single unit block switching may be terminated when a block switching that realizes the center of gravity closer to the target is finished.

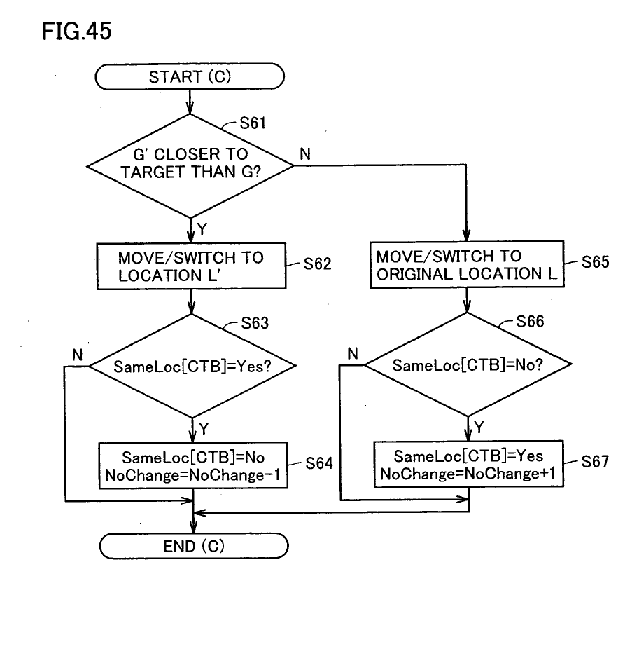

FIG. 45 is a flow chart representing an operation of means C shown in FIG. 31. Specifically, FIG. 45 represents specific operations of step S554 of the flow chart shown in FIG. 33, step S565 of the flow chart shown in FIG. 34, step S5715 of the flow chart shown in FIG. 41, step S5725 of the flow chart shown in FIG. 42, step S5735 of the flow chart shown in FIG. 43, and step S5745 of the flow chart shown in FIG. 44.

When the operation of means C starts, whether the center of gravity G′ calculated during the movement, location switching and block switching of the cargo transfer bags is closer to the target than the center of gravity G or not is determined (step S61).

In step S61, if the center of gravity G′ is closer to the target than the center of gravity G, that is, when the deviation from the optimal center of gravity becomes smaller by moving/switching the object cargo transfer bag 90 from the present location to another location, the object cargo transfer bag 90 is moved/switched to the location that attains the center of gravity G′ (step S62). Then, whether the same location flag SameLoc[CTB] of cargo transfer bag 90 having the CTB number “1” is “Yes” or not, that is, whether the location of the object cargo transfer bag 90 is the same as the previous location or not is determined (step S63). Determination as to whether the location of the object cargo transfer bag 90 is the same as the previous location or not is made in order to determine whether arrangement of cargo transfer bags of all CTB numbers has been completed or not for each of the cargo transfer bags 40, 50, 60, 70, 80 and 90.

In step S63, if the same location flag SameLoc[CTB] is not “Yes”, that is, when the location of the object cargo transfer bag 90 is different from the previous position, specific operations of step S554 of the flow chart shown in FIG. 33, step S565 of the flow chart shown in FIG. 34, step S5715 of the flow chart shown in FIG. 41, step S5725 of the flow chart shown in FIG. 42, step S5735 of the flow chart shown in FIG. 43, and step S5745 of the flow chart shown in FIG. 44 end.

When the same location flag SameLoc[CTB] is “Yes” in step S63, that is, when the location of the cargo transfer bag 90 is the same as the previous location, then the same location flag SameLoc[CTB] is set to “No”, the number NoChange of bags of which location is not moved/switched is decreased by “1” (step S64), and specific operations of step S554 of the flow chart shown in FIG. 33, step S565 of the flow chart shown in FIG. 34, step S5715 of the flow chart shown in FIG. 41, step S5725 of the flow chart shown in FIG. 42, step S5735 of the flow chart shown in FIG. 43, and step S5745 of the flow chart shown in FIG. 44 end.

In step S63, when the same location flag SameLoc[CTB] is “Yes”, the same location flag SameLoc[CTB] is set to “No” in step S64 because it is possible to further move the location of the object cargo transfer bag 90 as it is at the same location as before. Determination as to whether the cargo transfer bag having the number CTB of which same location flag SameLoc [CTB] has been set to “No” in step S64 can actually be moved/switched or not in steps S55, S56 of FIG. 32 will be made in step S553 of FIG. 33 representing details of step S55 and in steps S563, S564 of FIG. 34 representing details of step S56. In step S64 shown in FIG. 45, the possibility of moving/switching cargo transfer bag 90 as the object of determining arrangement to a location with smaller deviation in the center of gravity is left. Such setting enables detection of the location of cargo transfer bag 90 at which the deviation in the center of gravity becomes smaller.

In step S61, when the center of gravity G′ is not closer to the target than the center of gravity G, that is, when the center of gravity is closer to the target if the object cargo transfer bag 90 is maintained at the present location, then the object cargo transfer bag 90 is moved/switched to the original location L. Thereafter, whether the same location flag SameLoc[CTB] of the object cargo transfer bag 90 is “No” or not, that is, whether the location of the object cargo transfer bag 90 is different from the previous location or not is determined (step S66).

When the same location flag SameLoc[CTB] is not “No”, that is, when the location of the object cargo transfer bag 90 is the same as the previous location, specific operations of step S554 of the flow chart shown in FIG. 33, step S565 of the flow chart shown in FIG. 34, step S5715 of the flow chart shown in FIG. 41, step S5725 of the flow chart shown in FIG. 42, step S5735 of the flow chart shown in FIG. 43, and step S5745 of the flow chart shown in FIG. 44 end.

When the same location flag SameLoc[CTB] is “No”, that is, when the location of the object cargo transfer bag 90 is different from the previous location in step S66, then the same location flag SameLoc[CTB] is set to “Yes”, the number NoChange of bags of which location is not moved/switched is increased by “1” (step S67), and specific operations of step S554 of the flow chart shown in FIG. 33, step S565 of the flow chart shown in FIG. 34, step S5715 of the flow chart shown in FIG. 41, step S5725 of the flow chart shown in FIG. 42, step S5735 of the flow chart shown in FIG. 43, and step S5745 of the flow chart shown in FIG. 44 end.

In step S66, when the same location flag SameLoc [CTB] is “No”, the same location flag SameLoc [CTB] is set to “Yes” in step S67, as the possibility of further moving the object cargo transfer bag 90 is small, since the location of the object cargo transfer bag 90 is the same as the previous location.

The operation of means C is also executed in accordance with the flow chart shown in FIG. 45 for other cargo transfer bags 40, 50, 60, 70 and 80.

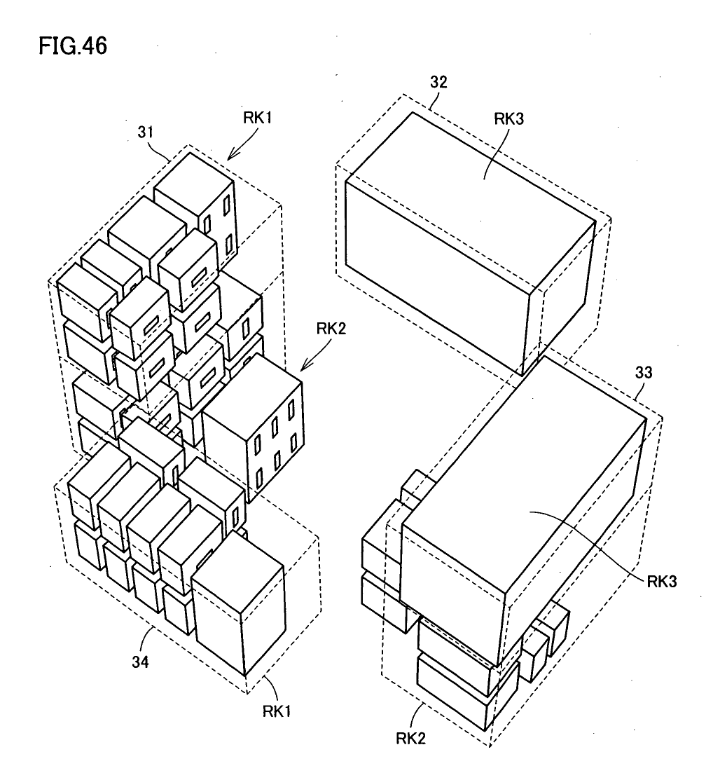

An example in which the arrangement of cargo transfer bags 40, 50, 60, 70, 80 and 90 in cargo compartments 31 to 34 is determined in accordance with the program of the present invention will be described. FIGS. 46 to 52 represent first to seventh exemplary arrangements of cargo transfer bags 40, 50, 60, 70, 80 and 90 that are determined using the program in accordance with the fourth embodiments.

It is noted that in FIGS. 46 to 52 show, exemplary arrangements of cargo transfer bags 40, 50, 60, 70, 80 and 90 in the cargo bay 11A, that is cargo bay sections 21 and 22 shown in FIG. 28. Therefore, each of the cargo compartments 31 to 34 are provided in upper and lower two stages.

In FIG. 46, cargo rack RK1 is arranged on the upper stage and cargo rack RK2 is arranged in on the lower stage of cargo compartment 31. Further, cargo pack rack RK3 is arranged on the upper stage in cargo compartment 32. Further, pack rack RK3 is arranged on the upper stage and cargo rack RK2 is arranged on the lower stage of cargo compartment 33. In front of cargo rack RK2 arranged on the lower stage of cargo compartment 33, two cargo transfer bags 60 and two cargo transfer bags 50 are arranged. Further, cargo rack RK1 is arranged on the lower stage of cargo compartment 34. In front of cargo rack RK2 arranged on the lower stage of cargo compartment 31, a cargo transfer bag 90 (M01 bag) is arranged.

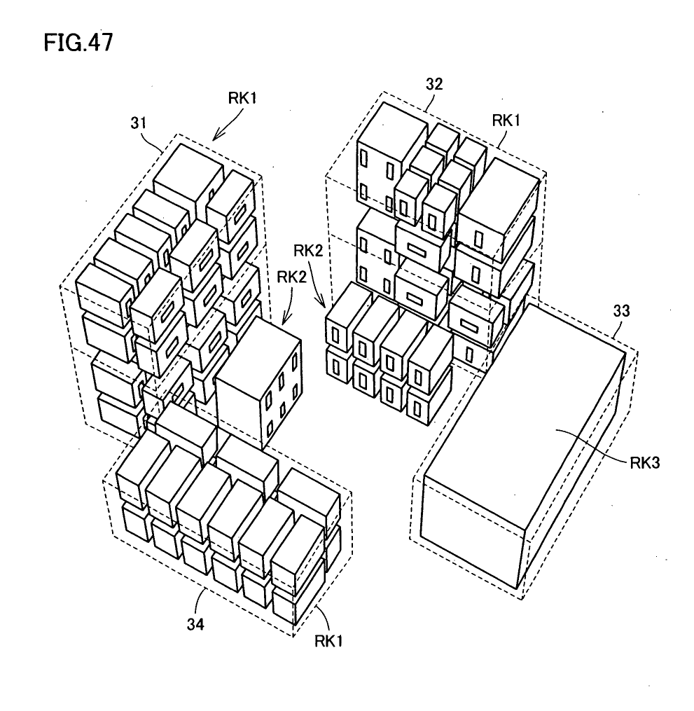

Referring to FIG. 47, in cargo compartment 31, cargo rack RK1 is arranged on the upper stage, and cargo rack RK2 is arranged on the lower stage. In cargo compartment 32, cargo rack RK1 is arranged on the upper stage and cargo rack RK2 is arranged on the lower stage. Further, in cargo compartment 33, pack rack RK3 is arranged on the upper stage. Further, in cargo compartment 34, cargo rack RK1 is arranged on the lower stage. In front of cargo rack RK2 arranged on the lower stage of cargo compartment 31, a cargo transfer bag 90 (M01 bag) is arranged, and in front of cargo rack RK2 arranged on the lower stage of cargo compartment 32, eight cargo transfer bags 50 are arranged.

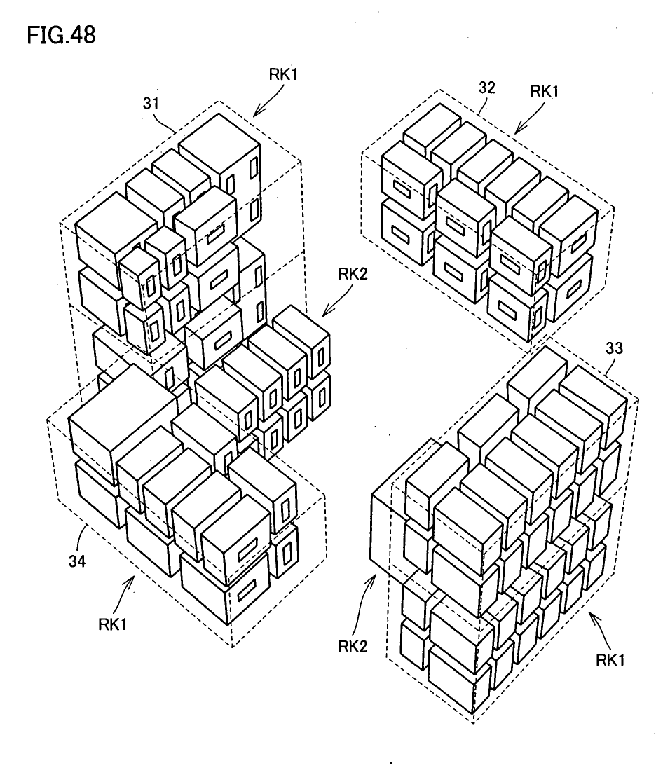

Referring to FIG. 48, in cargo compartment 31, cargo rack RK1 is arranged on the upper stage, and cargo rack RK2 is arranged on the lower stage. In cargo compartment 32, cargo rack RK1 is arranged on the upper stage. Further, in cargo compartment 33, cargo rack RK1 is arranged on the upper stage and cargo rack RK2 is arranged on the lower stage. Further, in cargo compartment 34, cargo rack RK1 is arranged on the lower stage. In front of cargo rack RK2 arranged on the lower stage of cargo compartment 31, eight cargo transfer bags 50 are arranged, and in front of cargo rack RK2 arranged on the lower stage of cargo compartment 33, a cargo transfer bag 90 (M01 bag) is arranged.

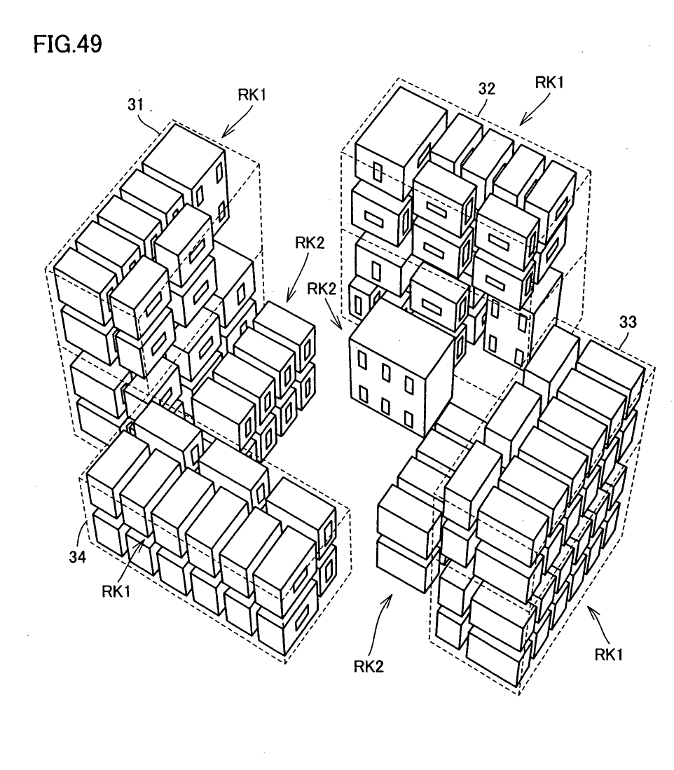

Referring to FIG. 49, in cargo compartment 31, cargo rack RK1 is arranged on the upper stage and cargo rack RK2 is arranged on the lower stage. In cargo compartment 32, cargo rack RK1 is arranged on the upper stage and cargo rack RK2 is arranged on the lower stage. Further, in cargo compartment 33, cargo rack RK1 is arranged on the upper stage and cargo rack RK2 is arranged on the lower stage. Further, in cargo compartment 34, cargo rack RK1 is arranged on the lower stage. In front of cargo racks RK2 arranged on the lower stages of cargo compartments 31 and 33, eight cargo transfer bags 50 are arranged, and in front of cargo rack RK2 arranged on the lower stage of cargo compartment 32, a cargo transfer bag 90 (M01 bag) is arranged.

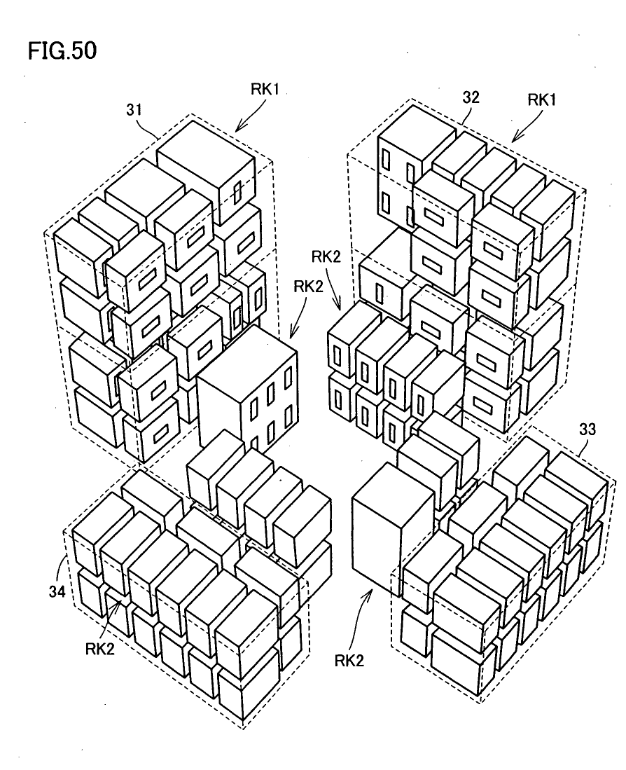

Referring to FIG. 50, in cargo compartment 31, cargo rack RK1 is arranged on the upper stage, and cargo rack RK2 is arranged on the lower stage. In cargo compartment 32, cargo rack RK1 is arranged on the upper stage and cargo rack RK2 is arranged on the lower stage. In cargo compartment 33, cargo rack RK2 is arranged on the lower stage. In cargo compartment 34, cargo rack RK2 is arranged on the lower stage. In front of cargo rack RK2 arranged on the lower stage of cargo compartment 31, a cargo transfer bag 90 (M01 bag) is arranged, and in front of cargo rack RK2 arranged on the lower stage of cargo compartment 32, eight cargo transfer bags 50 are arranged. Further, in front of cargo rack RK2 arranged on the lower stage of cargo compartment 33, one cargo transfer bag 80 and four single-size cargo transfer bags 50 are arranged, and in front of cargo rack RK2 arranged on the lower stage of cargo compartment 34, eight single-size cargo transfer bags 50 are arranged.

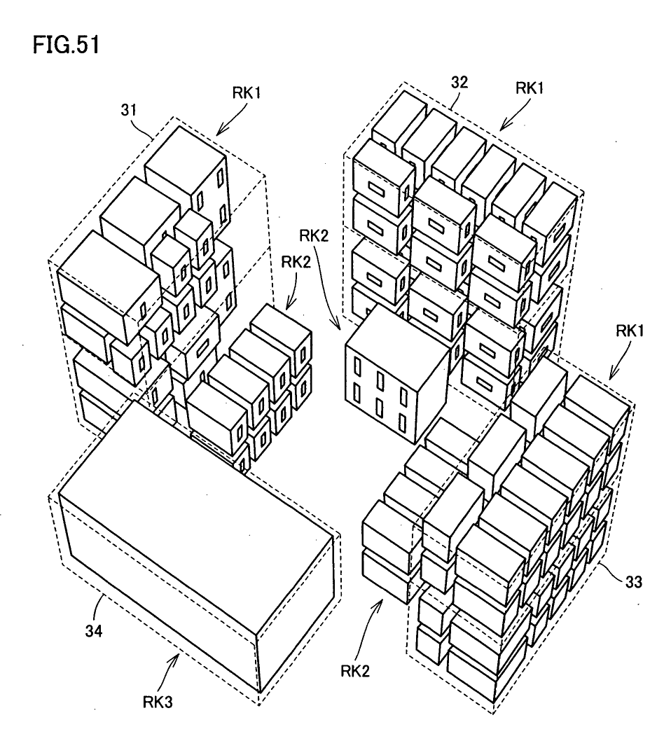

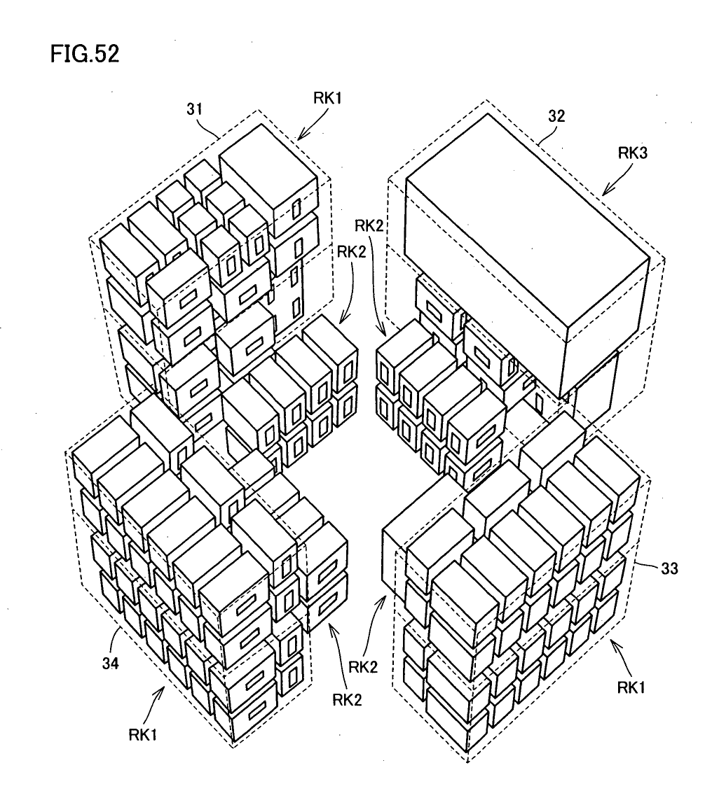

Referring to FIG. 51, in cargo compartment 31, cargo rack RK1 is arranged on the upper stage, and cargo rack RK2 is arranged on the lower stage. In cargo compartment 32, cargo rack RK1 is arranged on the upper stage and cargo rack RK2 is arranged on the lower stage. In cargo compartment 33, cargo rack RK1 is arranged on the upper stage and cargo rack RK2 is arranged on the lower stage. Further, in cargo compartment 34, pack rack RK3 is arranged on the lower stage. In front of cargo racks RK2 arranged on the lower stages of cargo compartments 31 and 33, eight cargo transfer bags 50 are arranged, and in front of cargo rack RK2 arranged on the lower stage of cargo compartment 32, one cargo transfer bag 90 (M01 bag) is arranged.

Referring to FIG. 52, in cargo compartment 31, cargo rack RK1 is arranged on the upper stage, and cargo rack RK2 is arranged on the lower stage. In cargo compartment 32, pack rack RK3 is arranged on the upper stage and cargo rack RK2 is arranged on the lower stage. In cargo compartment 33, cargo rack RK1 is arranged on the upper stage and cargo rack RK2 is arranged on the lower stage. Further, in cargo compartment 34, cargo rack RK1 is arranged on the upper stage and cargo rack RK2 is arranged on the lower stage. In front of cargo racks RK2 arranged on the lower stages of cargo compartments 31, 32 and 34, eight cargo transfer bags 50 are arranged, and in front of cargo rack RK2 arranged on the lower stage of cargo compartment 33, one cargo transfer bag 90 (M01 bag) is arranged.

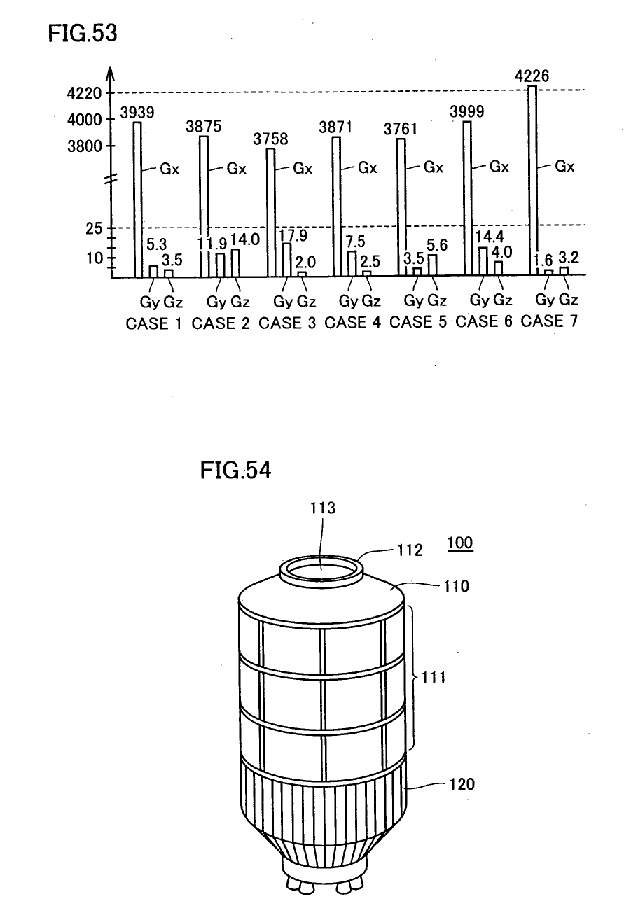

FIG. 53 represents centers of gravity of cargo transfer bags 40, 50, 60, 70, 80 and 90 in the arrangements shown in FIGS. 46 to 52. In FIG. 53, the abscissa represents cases, where cases 1 to 7 correspond to arrangements shown in FIGS. 46 to 52. The ordinate represents the center of gravity. Further, numerical values 25 and 4220 represent reference values of deviation between the center of gravity after cargo transfer bags 40, 50, 60, 70, 80 and 90 are loaded to transport 10A and the original center of gravity. Further, in FIG. 53, Gx represents the center of gravity along the longitudinal direction (direction of the arrow 13 shown in FIG. 28) of transport 10A, and Gy and Gz respectively represent center of gravity along the y-axis and center of gravity along the z-axis in the rectangular coordinates of y-axis and z-axis orthogonal to the direction of the arrow 13 shown in FIG. 28. In FIG. 53, the unit of numerical values is [mm].

It is noted that in all cases 1 to 7, the deviation in the center of gravity along the y-axis and center of gravity along the z-axis orthogonal to the longitudinal direction of transport 10A are within 25 [m].

In case 7 shown in FIG. 52, the center of gravity along the y-axis orthogonal to the longitudinal direction of transport 10A was 1.6 [m] and the center of gravity along the z-axis orthogonal to the longitudinal direction was 3.2 [m]. The center of gravity along the longitudinal direction of transport 10A, which is in most part determined by the total weight of cargo transfer bags loaded to cargo bay 11A, was 4226 [m]. These values well satisfy the condition that the deviation from the original center of gravity should be at most 25 [m].

Therefore, it is possible by the program in accordance with the fourth embodiment to determine the arrangement of cargo transfer bags 40, 50, 60, 70, 80 and 90 in cargo compartments 31, 32, 33 and 34 such that center of gravity of transport 10, which is deviated from the optimal center of gravity, comes closer to the optimal center of gravity, specifically to be within 25 [m] from the optimal center of gravity.

The functional block diagram representing the function of the program for determining the arrangement of cargo transfer bags 40, 50, 60, 70, 80 and 90 executed in accordance with the flow charts shown in FIGS. 31 to 37 and 41 to 45 is the same as the functional block diagram of FIG. 18.

In the fourth embodiment, cargo type determining means 81 selects cargo transfer bags from the input cargo transfer bags 40, 50, 60, 70, 80 and 90 starting from one having larger influence on the user's request that the deviation in the center of gravity when the cargo transfer bags 40, 50, 60, 70, 80 and 90 are arranged in cargo compartments 31 to 34.

Further, cargo requirement calculating means 82 calculates the requirement that deviation between the center of gravity when cargo transfer bags 40, 50, 60, 70, 80 and 90 are loaded to cargo compartments 31 to 34 from the optimal center of gravity should be within 25 [m].

Local cargo arrangement searching means 83 successively searches for a location where each of the cargo transfer bags 40, 50, 60, 70, 80 and 90 locally satisfies the requirement from requirement calculating means 82, in the order of cargo transfer bags 90, 80, 70, 60, 50 and 40 as selected by cargo type determining means 81. Here, local cargo arrangement searching means 83 specifically searches for a location where each of the cargo transfer bags 40, 50, 60, 70, 80 and 90 locally satisfies the requirement from cargo requirement calculating means 82 by local movement of the cargo transfer bags 40, 50, 60, 70, 80 and 90, or location switching or block switching between the cargo transfer bags of the same type, and moves or switches the cargo transfer bags 40, 50, 60, 70, 80 and 90 to the searched out locations.

The functional block diagram representing the function of the program for determining the arrangement of cargo transfer-bags 40, 50, 60, 70, 80 and 90 executed in accordance with the flow charts shown in FIGS. 31 to 37 and 41 to 45 may be functional block diagrams 80A, 80B or 80C shown in FIGS. 20 to 22, respectively.

The program in accordance with the fourth embodiment is stored in an ROM 93 of a personal computer 90 shown in FIG. 23, and executed by a CPU 91.

In the foregoing, determination of arrangement of cargo transfer bags 40, 50, 60, 70, 80 and 90 to satisfy the user's request by moving and/or switching six different types of cargo transfer bags 40, 50, 60, 70, 80 and 90 has been described. The program of the present invention has only to be a program that determines the arrangement of cargo transfer bags 40, 50, 60, 70, 80 and 90 generally by changing locations of cargo transfer bags 40, 50, 60, 70, 80 and 90, when arrangement of six different cargo transfer bags 40, 50, 60, 70, 80 and 90 is to be determined to satisfy a user's request.

Though a program determining arrangement of six different types of cargo transfer bags has been described, the cargo transfer bags are not limited to the six types, and the cargo transfer bags may be of one type or two or more different types. Even when the cargo transfer bags are of one same type, it is still necessary to arrange the plurality of cargo transfer bags in cargo compartments 31 to 34 while making smaller the deviation between the center of gravity with the plurality of cargo transfer bags loaded to transport 10 and the optimal center of gravity, as the plurality of cargo transfer bags are loaded to the cargo compartments. Therefore, the program in accordance with the fourth embodiment is applicable also when the arrangement of cargo transfer bags of one type is to be determined.

Further, it has been described that the size of cargo transfer bag 90 corresponds to six cargo transfer bags 50, the size of cargo transfer bag 80 corresponds to four cargo transfer bags 50, the size of cargo transfer bag 70 corresponds to three cargo transfer bags 50, the size of cargo transfer bag 60 corresponds to two cargo transfer bags 50, and the size of cargo transfer bag 50 corresponds to two cargo transfer bags 40. The present invention is not limited thereto, and the sizes of cargo transfer bags have only to satisfy the following relation: the size of cargo transfer bag 90 corresponds to h (h is a natural number not smaller than 6) cargo transfer bags 50, the size of cargo transfer bag 80 corresponds to i (i is a natural number satisfying 4≦i<h) cargo transfer bags 50, the size of cargo transfer bag 70 corresponds to j (j is a natural number satisfying 3≦j<i) cargo transfer bags 50, the size of cargo transfer bag 60 corresponds to k (k is a natural number satisfying 2≦k<j) cargo transfer bags 50, and the size of cargo transfer bag 50 corresponds to k cargo transfer bags 40.

Further, the center of gravity of spacecraft 20 with cargo transfer bags 40, 50, 60, 70, 80 and 90 loaded thereto constitutes the “center of gravity with cargo load” and “evaluation value.”

Further, the center of gravity of spacecraft 20 before cargo transfer bags 40, 50, 60, 70, 80 and 90 are loaded thereto constitutes the “initial evaluation value.”

According to the fourth embodiment, when the center of gravity of transport 10A before loading cargo transfer bags 40, 50, 60, 70, 80 and 90 is deviated from the optimal center of gravity, the program determines the arrangement of cargo transfer bags 40, 50, 60, 70, 80 and 90 such that the center of gravity of transport 10A comes within the range of 25 [m] from the optimal center of gravity by appropriately loading cargo transfer bags 40, 50, 60, 70, 80 and 90. Therefore, the arrangement of cargo transfer bags can be determined such that the center of gravity that is off from the optimal value comes closer to the optimal center of gravity.

Further, according to the fourth embodiment, even when cargo racks constituting cargo compartments 31 to 34 are of different types RK1 and RK2, it is possible to determine the arrangement of cargo transfer bags 40, 50, 60, 70, 80 and 90 such that the center of gravity of transport 10A with cargo transfer bags 40, 50, 60, 70, 80 and 90 loaded thereto comes within the range of 25 [m] from the optimal center of gravity.

Further, according to the fourth embodiment, even when the cargo rack constituting the cargo compartments 31 to 34 is partitioned into a plurality of areas, it is possible to determine the arrangement of cargo transfer bags 40, 50, 60, 70, 80 and 90 such that the center of gravity of transport 10A with cargo transfer bags 40, 50, 60, 70, 80 and 90 loaded thereto comes within the range of 25 [m] from the optimal center of gravity.

As described above, even in a case where various limitations exist, the program in accordance with the fourth embodiment is capable of determining the arrangement of cargo transfer bags 40, 50, 60, 70, 80 and 90 such that the center of gravity of transport 10A that is off from the optimal center of gravity comes within the range of 25 [m] from the optimal center of gravity by loading cargo transfer bags 40, 50, 60, 70, 80 and 90.

Further, according to the fourth embodiment, the program determines the arrangement of cargo transfer bags 40, 50, 60, 70, 80 and 90 such that the center of gravity of transport 10A with cargo transfer bags 40, 50, 60, 70, 80 and 90 loaded thereto comes within the range of 25 [m] from the optimal center of gravity, reflecting the weights of cargo bay 11A and thrusting portion 12A of transport 10A, weights of exposed pallets loaded to thrusting portion 12A, fuel and water as well as weights of cargo racks RK1, RK2/pack rack RK3 (see steps S31 to S34 of FIG. 31). Therefore, it is possible to determine the weights of cargo bay 11A and thrusting portion 12A, exposed pallets that can be loaded to thrusting portion 12A, fuel and water, and cargo racks RK1, RK2/pack rack RK3 such that the center of gravity of transport 10A with cargo transfer bags 40, 50, 60, 70, 80 and 90 loaded thereto comes within the range of 25 [m] from the optimal center of gravity.

In the foregoing, a program has been described that determines the arrangement of cargo transfer bags such that deviation in the center of gravity of the transport is made smaller when a plurality of different types of cargo transfer bags are loaded to the transport and conveyed to the cosmic space. The present invention, however, is also applicable when packs or pieces of furniture are loaded to a truck. Here, the arrangement of a plurality of packs to be loaded to the truck for moving is determined in accordance with the method described above. Using the weight or the like of the truck without any pack to be delivered or furniture to be moved loaded thereto, the initial center of gravity is calculated. Using the calculated initial value of the center of gravity, the arrangement of packs and the like are determined such that the center of gravity of the truck with the packs and the like loaded comes within a prescribed value range from the optimal center of gravity. The present invention is further applicable to scheduling of nurses and medical practitioners at medical institutes, as well as to arrangement of furniture at private household or to an arrangement of a plurality of circuits on a circuit board.

Further, the program of the fourth embodiment is also applicable to determination of arrangement of air cargo.

Further, the program of the fourth embodiment is also generally applicable when arrangement of a plurality of objects, of which evaluation value is deviated from a target value, is to be determined to set the evaluation value to the target value.

Although the present invention has been described and illustrated in detail, it is clearly understood that the same is by way of illustration and example only and is not to be taken by way of limitation, the spirit and scope of the present invention being limited only by the terms of the appended claims.

1. A program to cause a computer to execute a determination of an appropriate arrangement of a plurality of objects where the plurality of objects classified into a plurality of types are to be arranged in a prescribed area to set a evaluation value to a target value, comprising:
the first step of receiving said target value;
the second step of receiving said plurality of types and number of objects belonging to each of said plurality of types; and
the third step of determining, type by type, arrangement of the objects belonging to respective types such that said evaluation value comes closer to the target value, in an order starting from the type that has largest influence on bringing said evaluation value to said target value.

2. The program according to claim 1 further to cause a computer to execute
the fourth step of stopping determination of said appropriate arrangement when deviation between said appropriate arrangement and an optimal arrangement of said plurality of objects comes within a prescribed range.

3. The program according to claim 1, wherein
said program is to cause a computer to execute an arrangement of cargo for transporting the cargo to cosmic space;
each said object is a cargo transfer bag having a prescribed weight and a prescribed size for transporting commodities to the cosmic space;
said plurality of objects classified into a plurality of types are a plurality of cargo transfer bags having different weights and different sizes;
said prescribed area is a spacecraft to which said plurality of cargo transfer bags are loaded;
said evaluation value is center of gravity of said spacecraft with loaded cargo when said plurality of cargo transfer bags are loaded to said spacecraft;
said target value is an appropriate center of gravity with loaded cargo at which distance between said center of gravity with loaded cargo and an optimal center of gravity of said spacecraft is within a prescribed range; and
said type that has the largest influence on bringing said evaluation value to said target value is said cargo transfer bag having the largest size.

4. The program according to claim 3, wherein
a method of changing location of a cargo transfer bag of which arrangement is to be determined when total free area in said prescribed area is larger than a prescribed value is different from a method of changing location of a cargo transfer bag of which arrangement is to be determined when total free area in said prescribed area is not larger than the prescribed value.

5. The program according to claim 4, wherein
said plurality of cargo transfer bags are classified into bags of a first size, second size, third size and fourth size, from the larger ones; and
a method of changing location of a cargo transfer bag belonging to said first or second size is different from a method of changing location of a cargo transfer bag belonging to said third or fourth size.

6. The program according to claim 5, wherein
location of a cargo transfer bag belonging to said first size or said second size is changed by moving said cargo transfer bag to a neighboring free area; and
location of a cargo transfer bag belonging to said third or fourth size is change by switching with a cargo transfer bag belonging to the same size positioned at a random location.

7. The program according to claim 5, wherein
location of a cargo transfer bag belonging to said first size or said second size is changed by moving said cargo transfer bag to a neighboring free area;
location of a cargo transfer bag belonging to said third size is changed by switching with a cargo transfer bag of the same type located with a cargo transfer bag of said first and/or second size interposed; and
location of a cargo transfer bag belonging to said fourth size is changed by switching with a cargo transfer bag of the same type at a neighboring location.

8. The program according to claim 5, wherein
location of a cargo transfer bag belonging to said first size or said second size is changed by moving said cargo transfer bag to a neighboring free area and by switching with a cargo transfer bag of the same size positioned at a random location;
location of a cargo transfer bag belonging to said third size is changed by switching with a cargo transfer bag belonging to the same size positioned at a location with said cargo transfer bag of the first and/or second size interposed, and by switching with a cargo transfer bag of the same size positioned at a random location; and
location of a cargo transfer bag belonging to said fourth size is changed by switching with a cargo transfer bag of the same type at a neighboring location and with a cargo transfer bag of the same type at a random location.

9. The program according to claim 4, wherein
said plurality of cargo transfer bags are classified into bags of a first size, second size, third size and fourth size, from the larger ones;
location of a cargo transfer bag belonging to said first size or said second size is changed by switching with a cargo transfer bag belonging to the same size positioned at a random location; and
location of a cargo transfer bag belonging to said third or fourth size is change by switching with a cargo transfer bag belonging to the same size positioned at a random location.

10. The program according to claim 1, wherein
in said third step, the appropriate arrangement for objects belonging to each of said types is determined by changing location object by object and by changing location by a block unit, with each block including a prescribed number of objects of a prescribed type.

11. The program according to claim 10, wherein
said program is to cause a computer to execute an arrangement of cargo for transporting the cargo to cosmic space;
each said object is a cargo transfer bag having a prescribed weight and a prescribed size for transporting commodities to the cosmic space;
said plurality of objects classified into a plurality of types are a plurality of cargo transfer bags having different weights and different sizes;
said prescribed area is a spacecraft to which said plurality of cargo transfer bags are loaded;
said evaluation value is center of gravity of said spacecraft with loaded cargo when said plurality of cargo transfer bags are loaded to said spacecraft;
said target value is an appropriate center of gravity with loaded cargo at which deviation from an optimal center of gravity for said spacecraft to navigate along a desired orbit is within a prescribed range; and
said type that has the largest influence on bringing said evaluation value to said target value is said cargo transfer bag having the largest size.

12. The program according to claim 11, wherein
said spacecraft includes
a cargo bay for loading said plurality of cargo transfer bags, and
a thrust portion for thrusting said spacecraft;
said cargo bay includes a plurality of cargo compartments each being capable of loading said plurality of cargo transfer bags;
each of said plurality of cargo compartments is constituted by a cargo rack or a pack rack selected arbitrarily from a plurality of different types of cargo racks in which said plurality of cargo transfer bags are arranged and a pack rack on which a pack other than said plurality of cargo transfer bags is arranged;
said plurality of cargo transfer bags are arranged in at least one cargo rack arranged in at least one cargo compartment;
said program causes a computer to further execute the fifth step of calculating an initial center of gravity using weights of said thrusting portion, said cargo racks and said pack rack; and
said third step is executed after said fifth step.

13. The program according to claim 12, wherein
said cargo rack is partitioned into a plurality of cargo areas;
said third step is realized by at least one of
the first sub-step in which said cargo transfer bag moves to a free area so that said center of gravity with loaded cargo comes closer to said optimal center of gravity,
the second sub-step in which said cargo transfer bag switches location with a cargo transfer bag of the same type so that said center of gravity with loaded cargo comes closer to said optimal center of gravity, and
the third sub-step in which location of said cargo transfer bags is switched in said block unit so that said center of gravity with loaded cargo comes closer to said optimal center of gravity; and
said block unit represents a unit including a plurality of cargo transfer bags that can be arranged in plurality in each of said plurality of cargo areas, among said plurality of different types of said cargo transfer bags.

14. The program according to claim 13, wherein
said plurality of cargo transfer bags are classified into bags of a first size, second size, third size, fourth size, fifth size and sixth size, from the larger ones;
said cargo rack includes a first cargo rack capable of containing cargo transfer bags belonging to said second to sixth sizes, and a second cargo rack capable of containing cargo transfer bags belonging to said second to sixth sizes and allowing placement of cargo transfer bags belonging to said first to sixth sizes on a front side;
location of a cargo transfer bag belonging to said first size is changed among the front sides of a plurality of said second cargo racks; and
location of a cargo transfer bag belonging to any of said second to sixth sizes is changed at the front side of said second cargo rack, inside said first and second cargo racks, among the front sides of a plurality of said second cargo racks, between the front side of said second cargo rack and inside of said first and second cargo racks, among insides of a plurality of first cargo racks, among insides of a plurality of said second cargo racks, and between the inside of said first cargo rack and the inside of said second cargo rack.

15. The program according to claim 14, wherein
when each of said plurality of cargo compartments consists of said first cargo rack,
in said first sub-step, cargo transfer bags belonging to said first to sixth sizes are moved to said free area,
in said second sub-step, locations of cargo transfer bags belonging to said first to sixth sizes are switched, type by type, with cargo transfer bags of the same type, and
in said third sub-step, locations of cargo transfer bags belonging to said first to sixth sizes are switched with cargo transfer bags of the same type or different type.

16. The program according to claim 15, wherein
said second size corresponds to i (i is a natural number not smaller than 4) said fifth size,
said third size corresponds to j (j is a natural number satisfying 3≦j<i) said fifth size,
said fourth size corresponds to k (k is a natural number satisfying 2≦k<j) said fifth size,
said fifth size corresponds to said k said sixth size;
said third sub-step includes
step A of switching location of cargo transfer bags belonging to said fourth to sixth sizes with cargo transfer bags of the same type or different type by a first block unit of said fourth size, so that said center of gravity with loaded cargo comes closer to said optimal center of gravity,
step B of switching location of cargo transfer bags belonging to said third to sixth sizes with cargo transfer bags of the same type or different type by a second block unit of said third size, so that said center of gravity with loaded cargo comes closer to said optimal center of gravity, and
step C of switching location of cargo transfer bags belonging to said second to sixth sizes with cargo transfer bags of the same type or different type by a third block unit of said second size, so that said center of gravity with loaded cargo comes closer to said optimal center of gravity; and
at least one of said step A, step B and step C is executed.

17. The program according to claim 16, wherein
said step A is executed when said first block is filled with said cargo transfer bags;
said step B is executed when said second block is filled with said cargo transfer bags; and
said step C is executed when said third block is filled with said cargo transfer bags.

18. The program according to claim 14, wherein
when said plurality of cargo compartments include said first and second cargo racks,
in said first sub-step, cargo transfer bags belonging to said first to sixth sizes are moved to said free area,
in said second sub-step, locations of cargo transfer bags belonging to said first to sixth sizes are switched, type by type, with cargo transfer bags of the same type, and
in said third sub-step, locations of cargo transfer bags belonging to said first to sixth sizes are switched with cargo transfer bags of the same type or different type.

19. The program according to claim 18, wherein
said first size corresponds to h (h is a natural number not smaller than 6) said fifth size,
said second size corresponds to i (i is a natural number not smaller than 4) said fifth size,
said third size corresponds to j (j is a natural number satisfying 3≦j<i) said fifth size,
said fourth size corresponds to k (k is a natural number satisfying 2≦k<j) said fifth size,
said fifth size corresponds to said k said sixth size;
said third sub-step includes
step A of switching location of cargo transfer bags belonging to said fourth to sixth sizes with cargo transfer bags of the same type or different type by a first block unit of said fourth size, so that said center of gravity with loaded cargo comes closer to said optimal center of gravity,
step B of switching location of cargo transfer bags belonging to said third to sixth sizes with cargo transfer bags of the same type or different type by a second block unit of said third size, so that said center of gravity with loaded cargo comes closer to said optimal center of gravity,
step C of switching location of cargo transfer bags belonging to said second to sixth sizes with cargo transfer bags of the same type or different type by a third block unit of said second size, so that said center of gravity with loaded cargo comes closer to said optimal center of gravity, and
step D of switching location of cargo transfer bags belonging to said first to sixth sizes with cargo transfer bags of the same type or different type by a fourth block unit of said first size, so that said center of gravity with loaded cargo comes closer to said optimal center of gravity; and
at least one of said step A, step B, step C and step D is executed.

20. The program according to claim 19, wherein
said step A is executed when said first block is filled with said cargo transfer bags;
said step B is executed when said second block is filled with said cargo transfer bags;
said step C is executed when said third block is filled with said cargo transfer bags; and
said step D is executed when said fourth block is filled with said cargo transfer bags.
